(19) United States
(12) Patent Application Publication
(10) Pub. No.: US 2025/0315206 A1
(43) Pub. Date: Oct. 9, 2025

(54) Devices, Methods, and Graphical User Interfaces for Outputting Audio from Audio Streams

(71) Applicant: Apple Inc., Cupertino, CA (US)

(72) Inventors: Darius A. Satongar, Staffordshire (GB); Claire Puginier, Oakland, CA (US); James H. Foster, Oxford (GB); Jonathan A. Topf, London (GB); Sean B. Kelly, San Francisco, CA (US)

(21) Appl. No.: 19/095,408

(22) Filed: Mar. 31, 2025

Related U.S. Application Data
(60) Provisional application No. 63/575,558, filed on Apr. 5, 2024.
(60) Provisional application No. 63/662,690, filed on Jun. 21, 2024.

(51) Int. Cl. G06F 3/16

(52) U.S. Cl. CPC G06F 3/165

(57) ABSTRACT

An audio output device (e.g., earbuds or headphones) includes one or more audio output components. While outputting, via the one or more audio output components, first audio content corresponding to a first set of one or more audio streams, the device detects an occurrence of an event involving a proximate audio source. In response to detecting the occurrence of the event, the device outputs, via the one or more audio output components, second audio content corresponding to a second set of one or more audio streams, the second set of one or more audio streams including an audio stream from the proximate audio source.

### RELATED APPLICATIONS

This application claims priority to U.S. Provisional Patent Application No. 63/662,690, filed Jun. 21, 2024, and to U.S. Provisional Patent Application No. 63/575,558, filed Apr. 5, 2024, each of which is incorporated by reference in its entirety.

### TECHNICAL FIELD

This relates generally to displaying representations of and outputting audio from audio streams, including but not limited to outputting audio from various types of audio sources in accordance with user interface gestures.

### BACKGROUND

Audio output devices, including wearable audio output devices such as headphones, earbuds, and earphones, are widely used to provide audio outputs to a user. However, conventional methods for playing audio on audio output devices are limited due to conventional audio sources (e.g., local music files, radio, and streaming services) that require users to manually navigate and select the audio sources as well as manually and interfaces (e.g., that are cumbersome, unintuitive, and inefficient). In addition, these methods take longer than necessary, thereby wasting energy. This latter consideration is particularly important in battery-operated devices.

### SUMMARY

Accordingly, there is a need for electronic devices with faster, more efficient methods and interfaces for detecting events involving audio sources (e.g., proximate audio sources) and, in response, adjusting audio output for the audio sources. Such methods and interfaces optionally complement or replace conventional methods for detecting and/or responding to audio source events. Additionally, there is a need for electronic devices with faster, more efficient methods and interfaces for detecting inputs directed to representations of audio sources in a user interface and, in response, adjusting audio output for the audio sources. Such methods and interfaces optionally complement or replace conventional methods for detecting and/or responding to manipulation of audio source representations. Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at an audio output device (e.g., earbuds or headphones) that includes one or more audio output components. The method includes, while outputting, via the one or more audio output components, first audio content corresponding to a first set of one or more audio streams, detecting an occurrence of an event involving a proximate audio source. The method also includes, in response to detecting the occurrence of the event, outputting, via the one or more audio output components, second audio content corresponding to a second set of one or more audio streams, the second set of one or more audio streams including an audio stream from the proximate audio source.

In accordance with some embodiments, a method is performed at an electronic device that includes, or is in communication with, a display device (e.g., a display component of the electronic device or a display communicatively coupled to the electronic device) and an audio output device (e.g., a speaker component of the electronic device or an audio output device (such as a set of earbuds or headphones) communicatively coupled to the electronic device). The method includes causing concurrent display, at the display device, of a representation of a broadcast audio source and a region corresponding to the audio output device and detecting an input moving the representation of the broadcast audio source. The method further includes, in response to detecting the input, in accordance with a determination that the input corresponds to movement of the representation of the broadcast audio source into the region corresponding to the audio output device, initiating a process to output audio content from the broadcast audio source at the audio output device.

In accordance with some embodiments, an electronic device includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein.

In accordance with some embodiments, a computer readable storage medium has stored therein instructions that, when executed by an electronic device with a display, an audio output component, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, an audio output component, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, an audio output component, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, an audio output component, optionally one or more sensors to detect intensities of contacts with the touch-sensitive surface, and optionally one or more tactile output generators, includes means for performing or causing performance of the operations of any of the methods described herein.

Thus, electronic devices with displays, audio output components (e.g., speakers), optionally a touch-sensitive surface, optionally one or more sensors to detect intensities of contacts with the touch-sensitive surface, optionally one or more tactile output generators, optionally one or more device orientation sensors, and optionally an audio system, are provided with improved methods and interfaces for detecting and responding to audio source events and manipulation of audio source representations, thereby increasing the effectiveness, efficiency, and user satisfaction with such devices. Such methods and interfaces may complement or replace conventional methods for detecting and/or responding to audio source events and/or manipulation of audio source representations.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 3H illustrates physical features of an example wearable audio output device in accordance with some embodiments.

FIG. 3I is a block diagram of an example wearable audio output device in accordance with some embodiments.

FIG. 3J illustrates example audio control by a wearable audio output device in accordance with some embodiments.

FIG. 3K illustrates example audio control by another wearable audio output device in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5H illustrate example user interfaces and user interactions for outputting audio from audio sources in accordance with some embodiments.

FIGS. 6A-6G illustrate example user interfaces and user interactions for adjusting audio properties from audio sources in accordance with some embodiments.

FIGS. 7A-7I illustrate example user interfaces and user interactions for outputting audio from different audio sources in accordance with some embodiments.

FIGS. 8A-8K illustrate example user interfaces and user interactions for outputting and adjusting audio from audio sources in accordance with some embodiments.

FIGS. 9A-9E illustrate example user interfaces and user interactions for outputting audio from audio sources at various audio output devices in accordance with some embodiments.

FIGS. 10A-10C illustrate example user interfaces and user interactions for displaying audio interfaces in accordance with some embodiments.

FIGS. 11A-11F are flow diagrams of a process for outputting audio from audio sources in accordance with some embodiments.

FIGS. 12A-12E are flow diagrams of a process for manipulating audio source representations to adjust output audio in accordance with some embodiments.

### DESCRIPTION OF EMBODIMENTS

As noted above, electronic devices, including multifunctional devices, personal devices, and desktop computers, are widely used to provide information and other outputs to users. As also noted above, audio output devices such as wearable audio output devices are widely used to provide audio outputs to a user. However, such devices do not provide efficient and intuitive means of detecting and responding to events involving audio sources, or provide efficient and intuitive user interfaces for adjusting audio content corresponding to audio output sources. The methods, systems, user interfaces, and interactions described herein improve how user interactions and feedback are provided in multiple ways. For example, embodiments disclosed herein describe improved processes, user interfaces, and user feedback for interacting with broadcast audio sources. The methods, systems, user interfaces, and interactions described herein also provide improved feedback during a variety of user interactions with audio user interfaces that make manipulation of the user interfaces more efficient and intuitive for a user.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

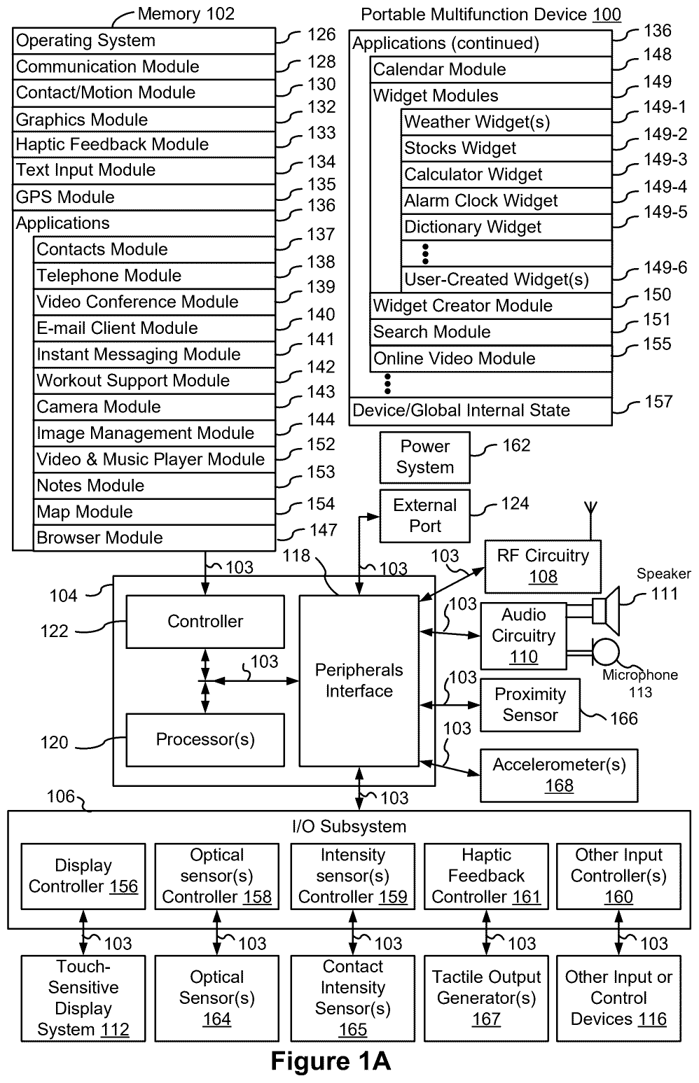

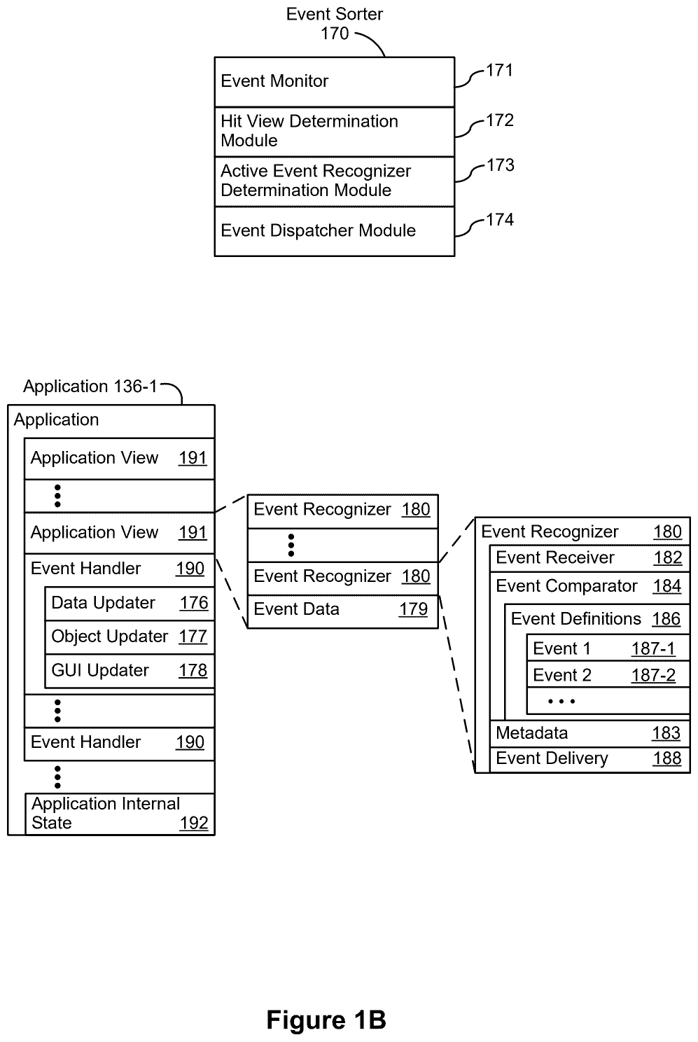

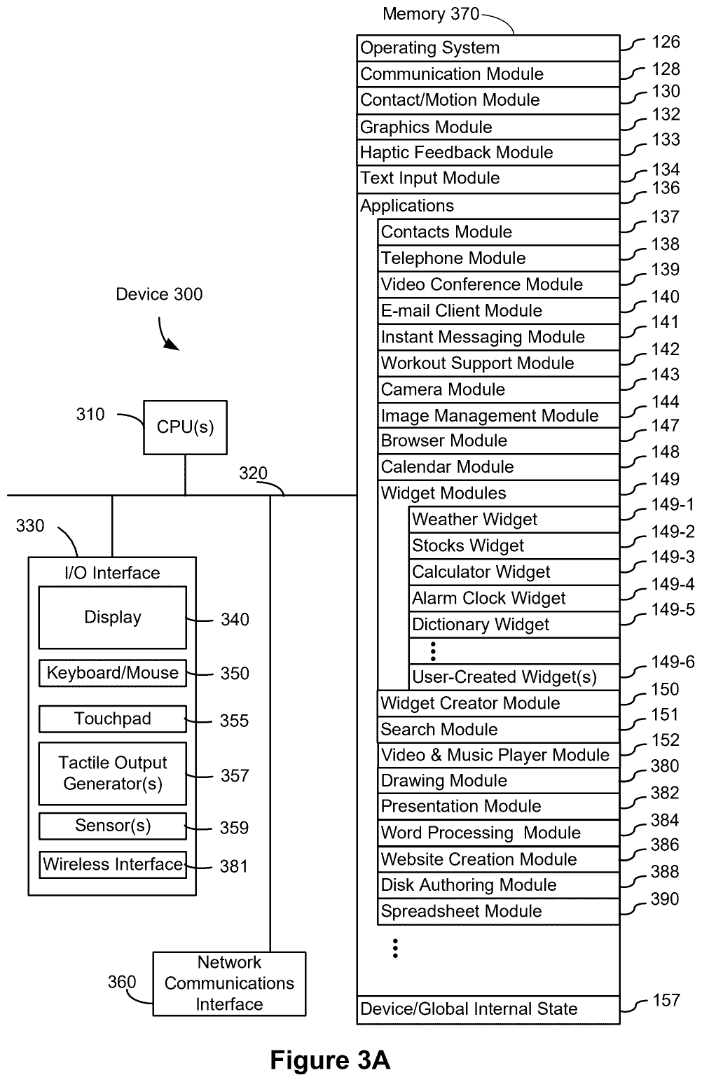

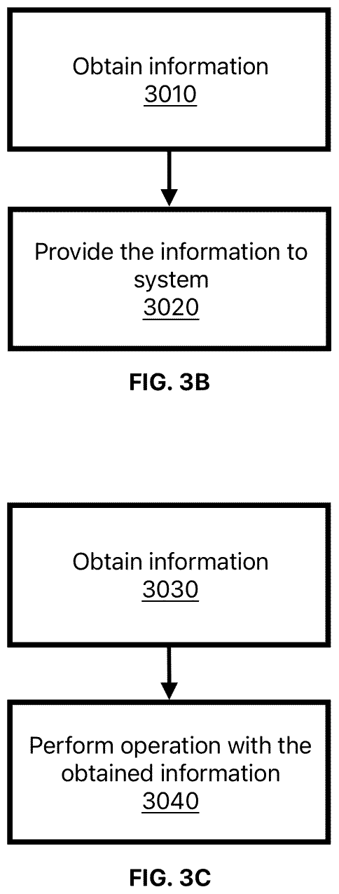

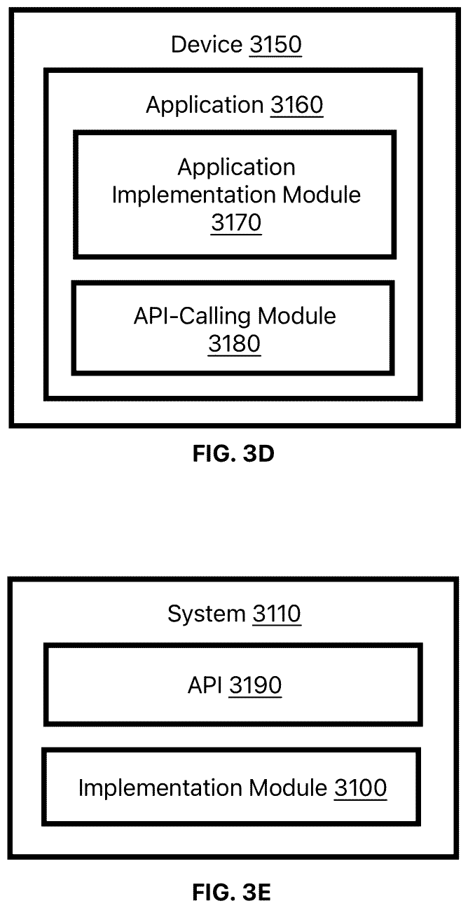

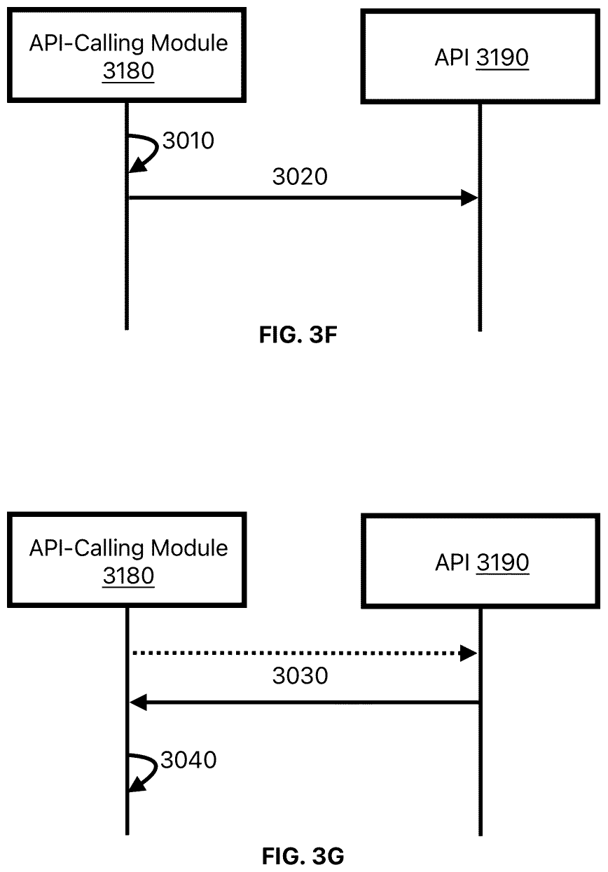

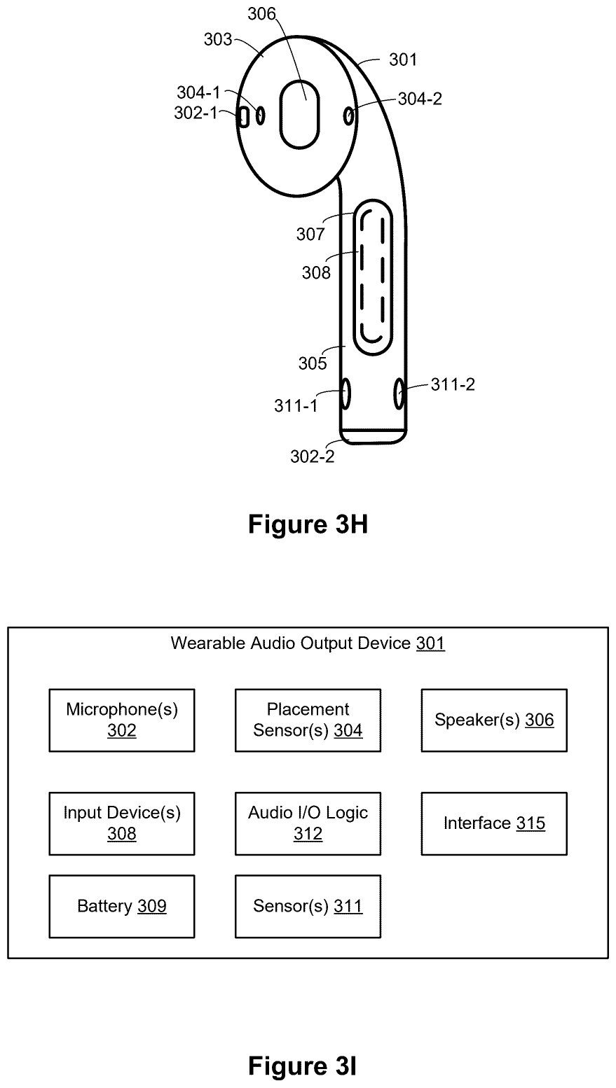

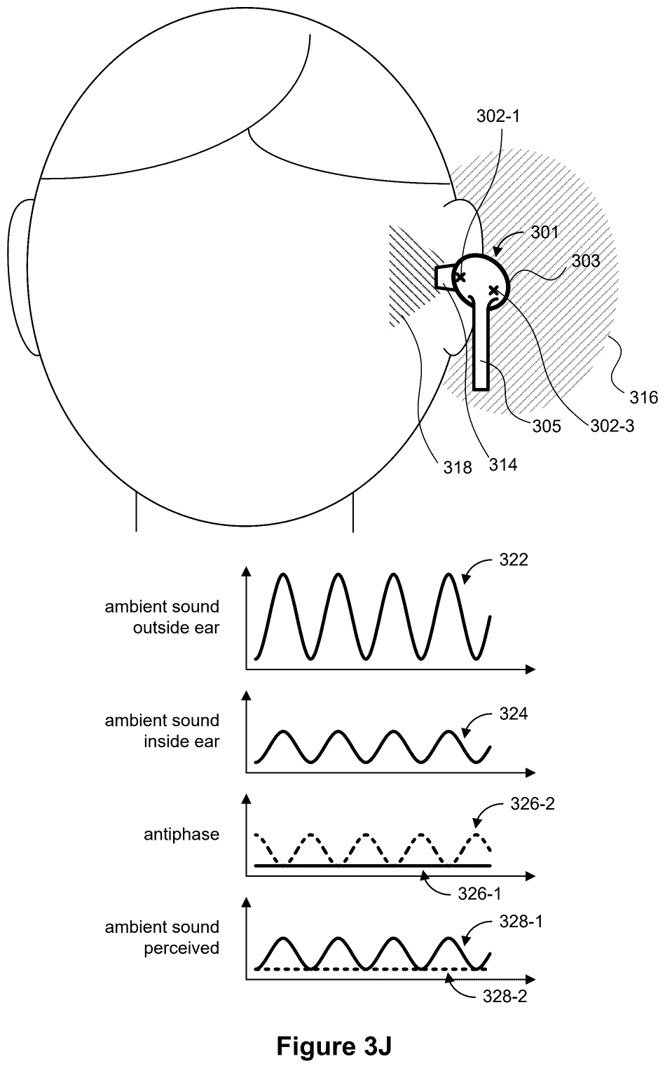

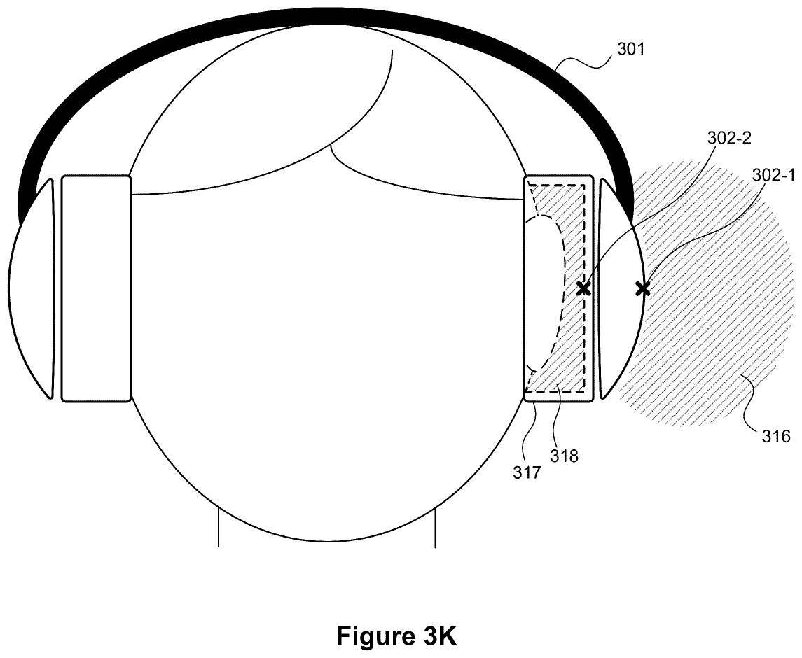

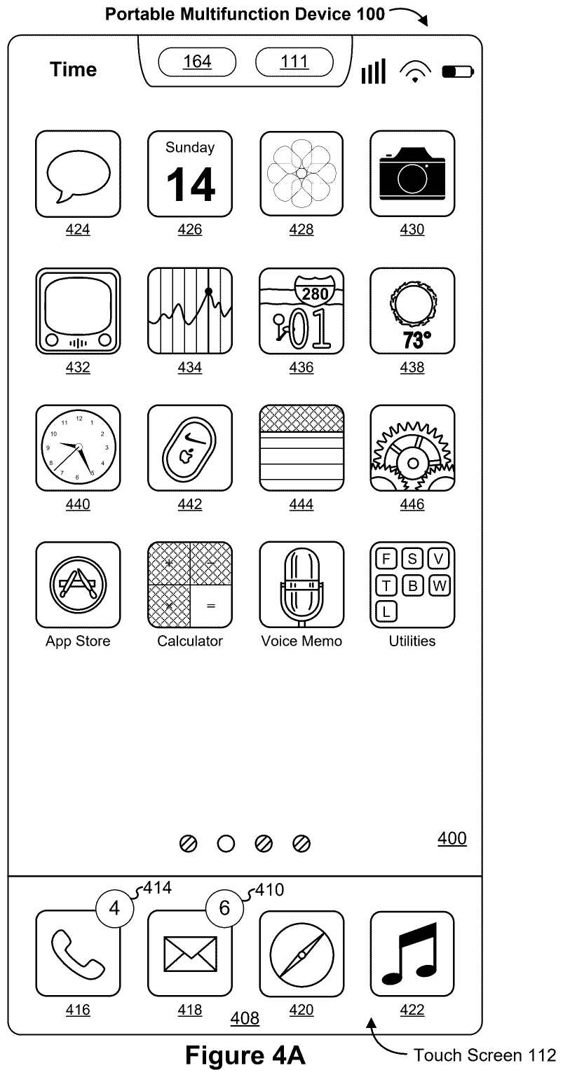

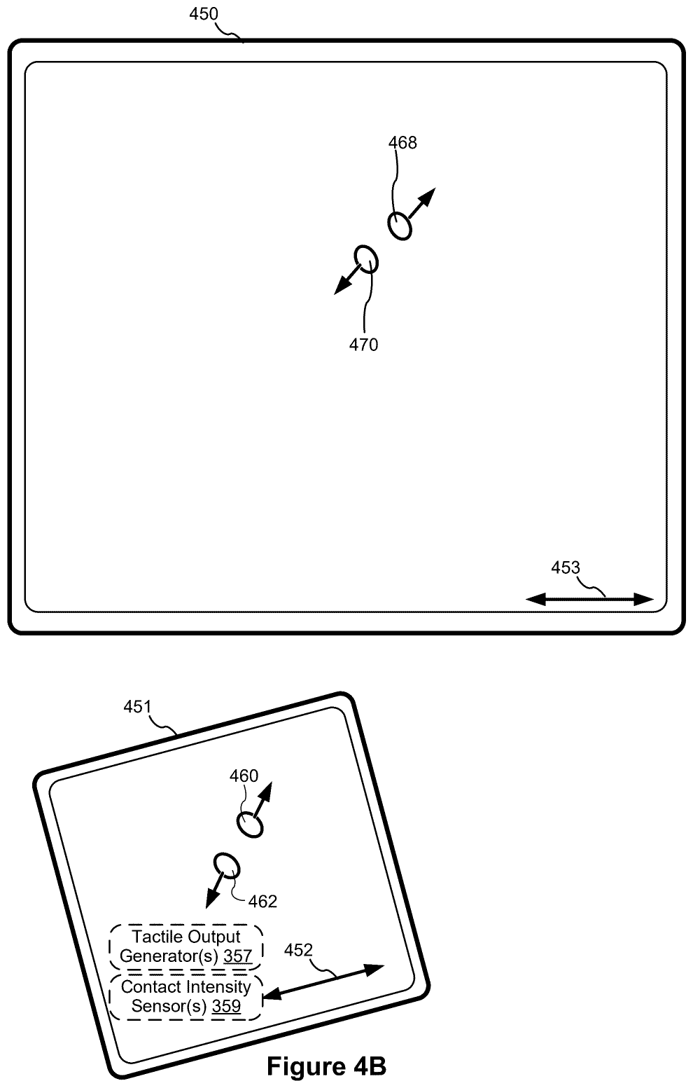

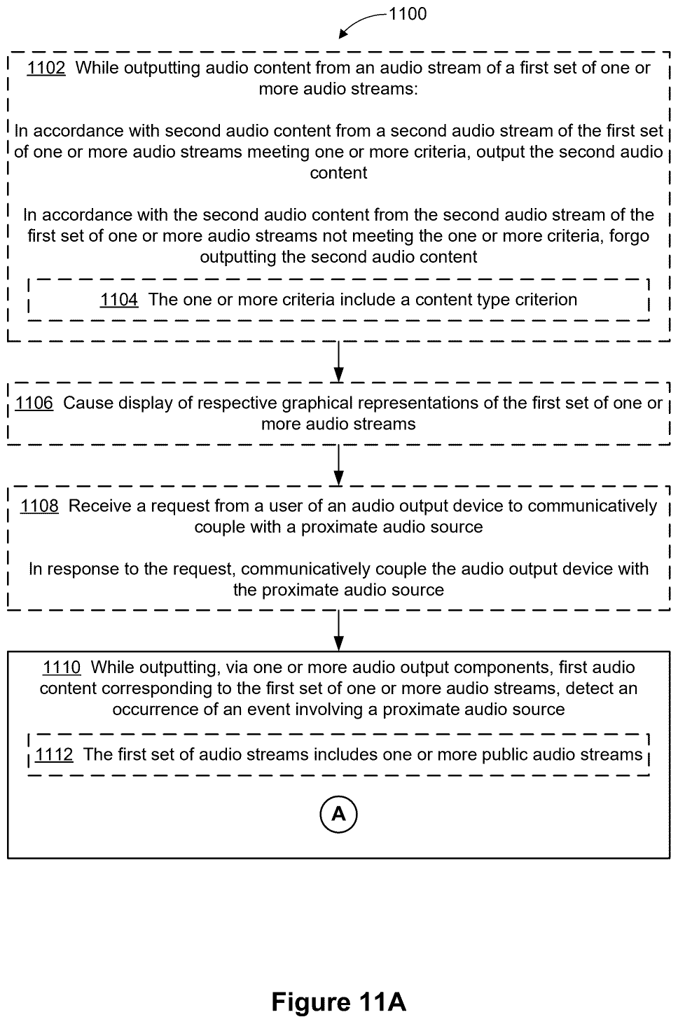

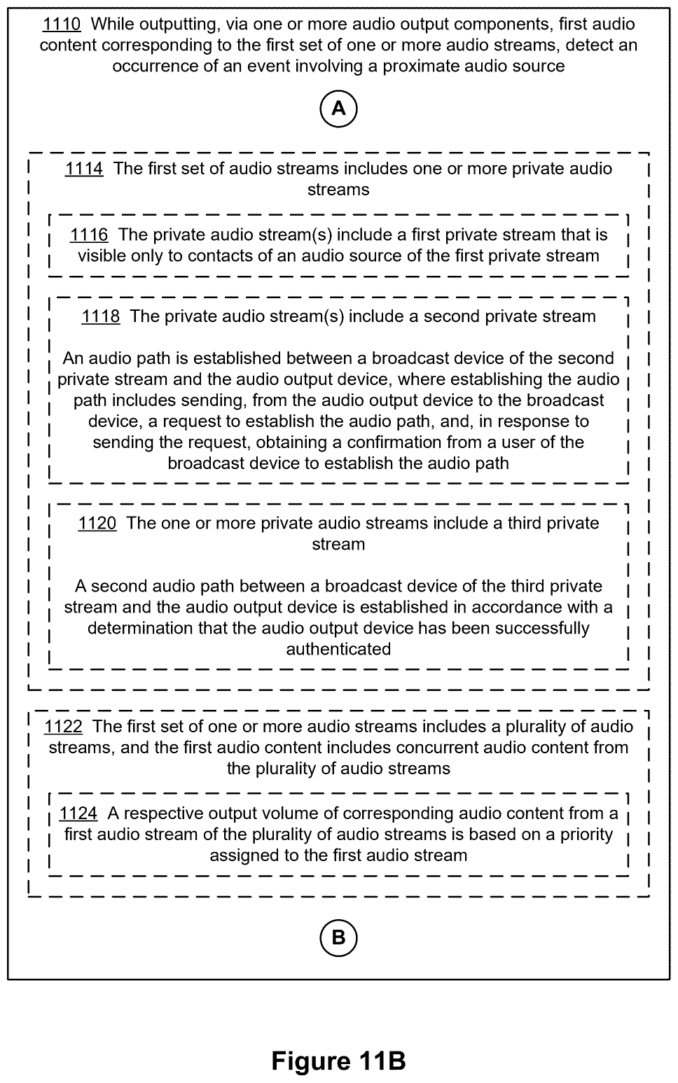

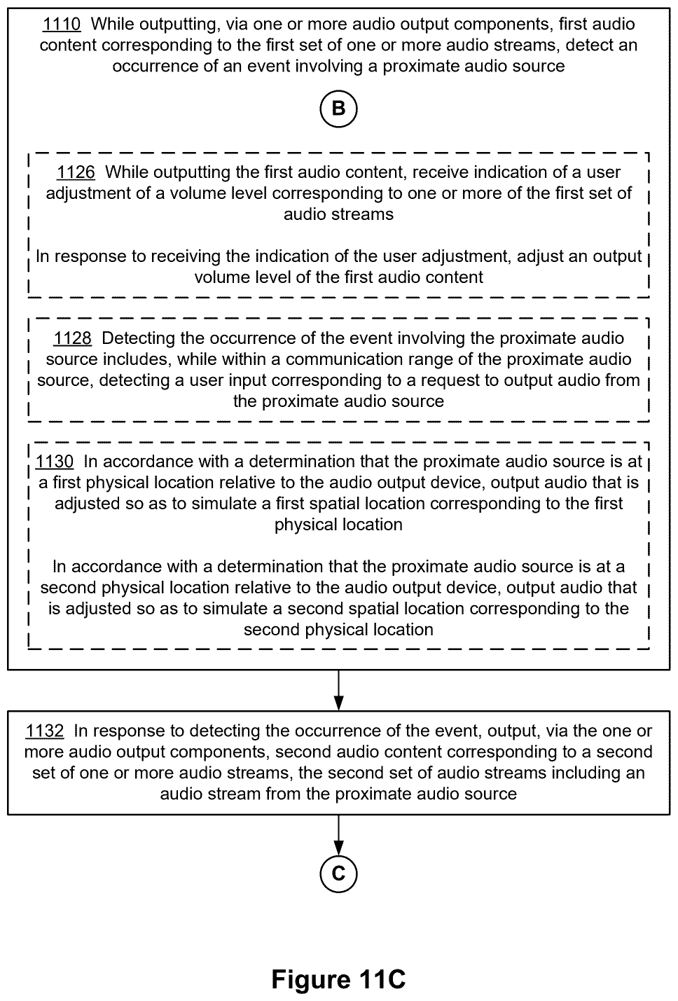

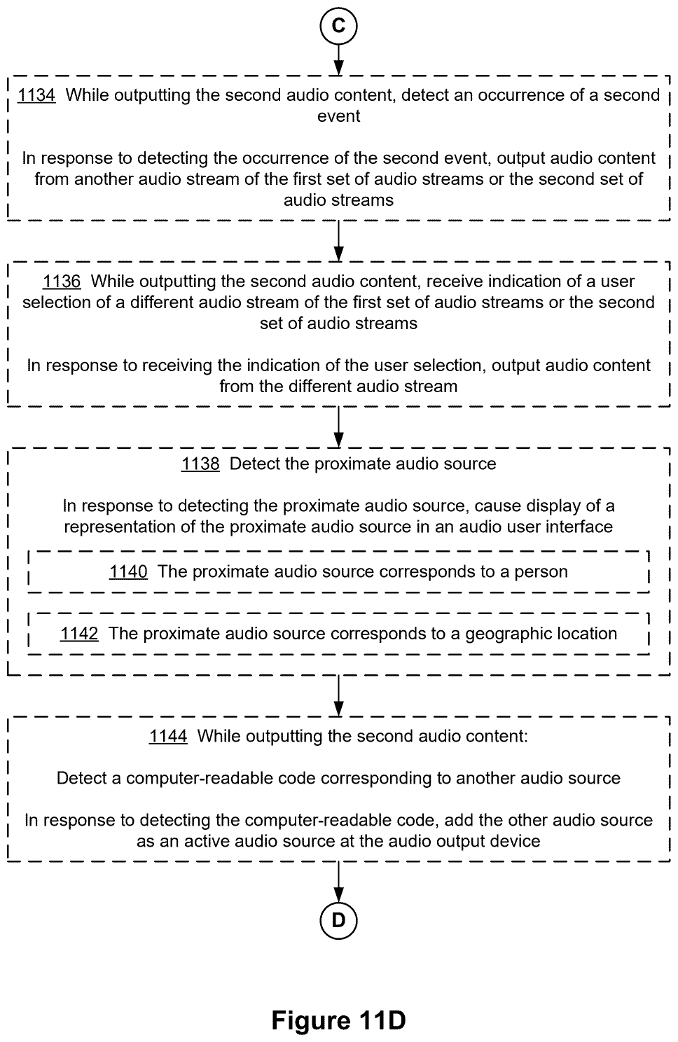

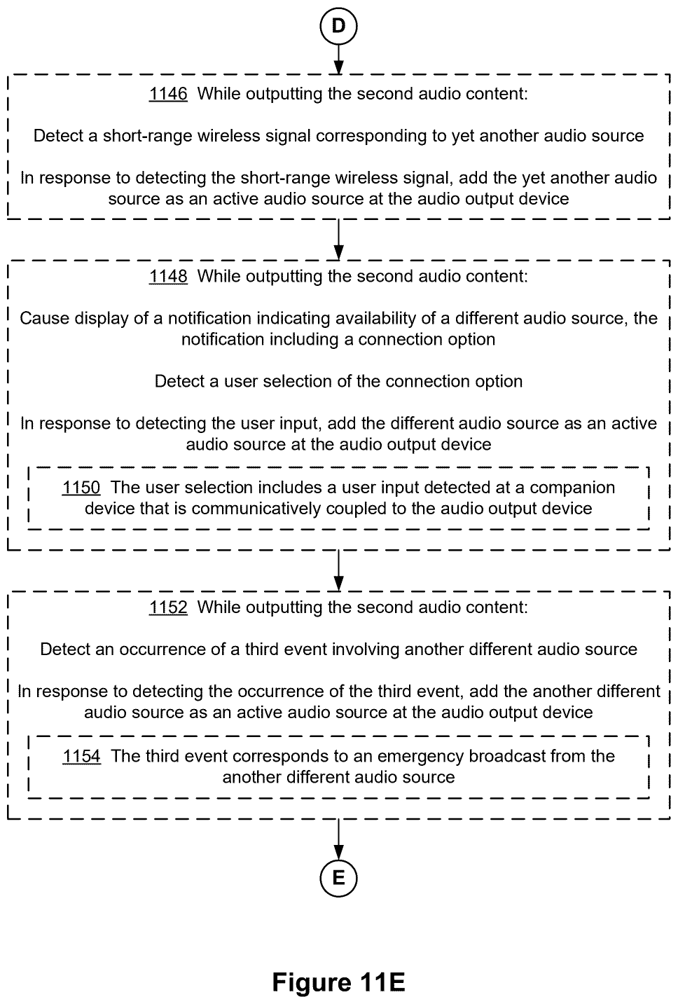

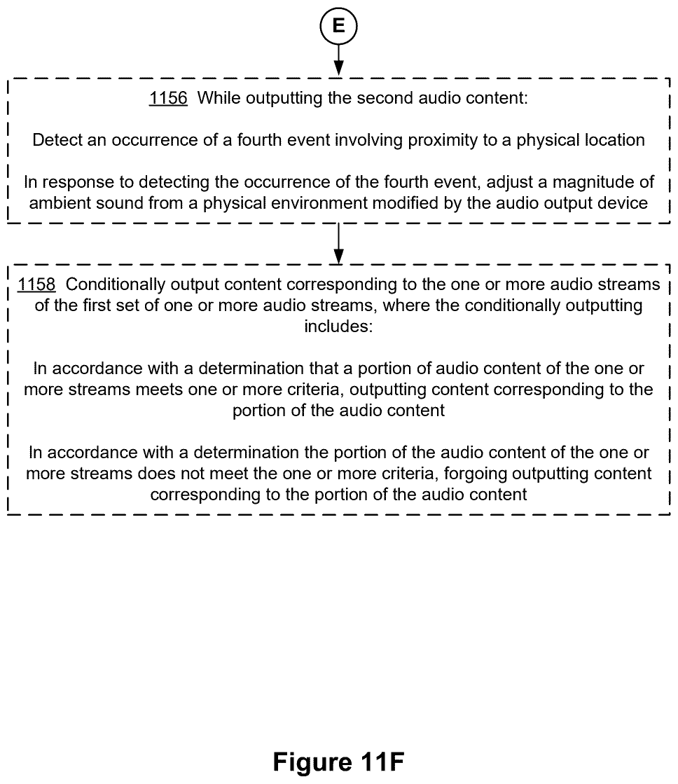

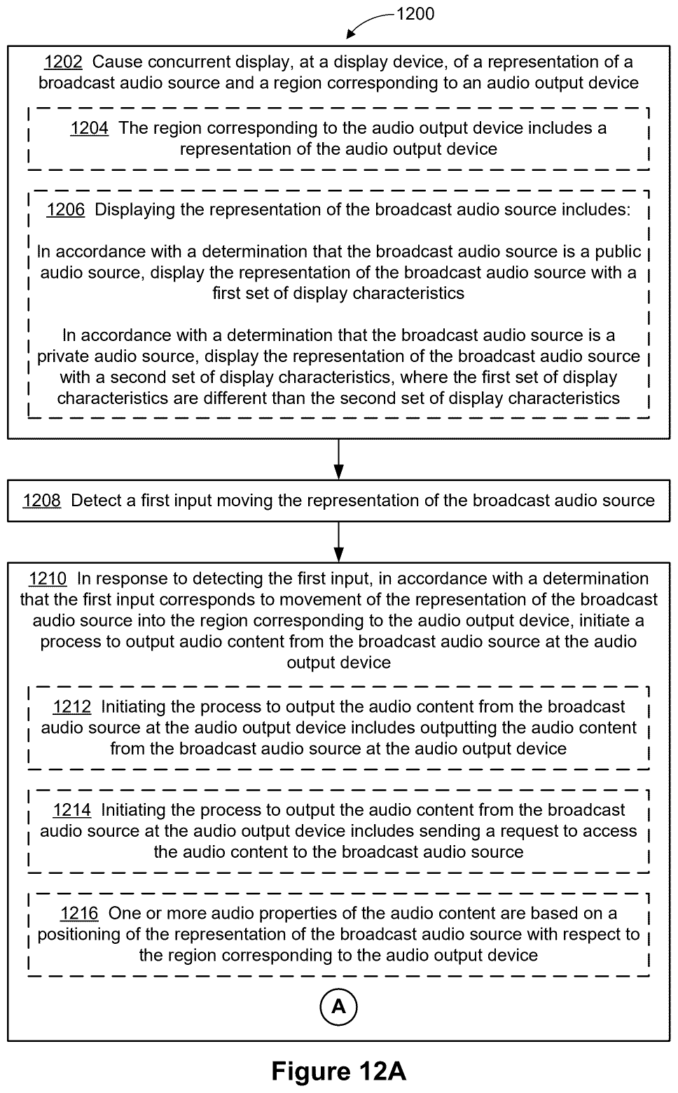

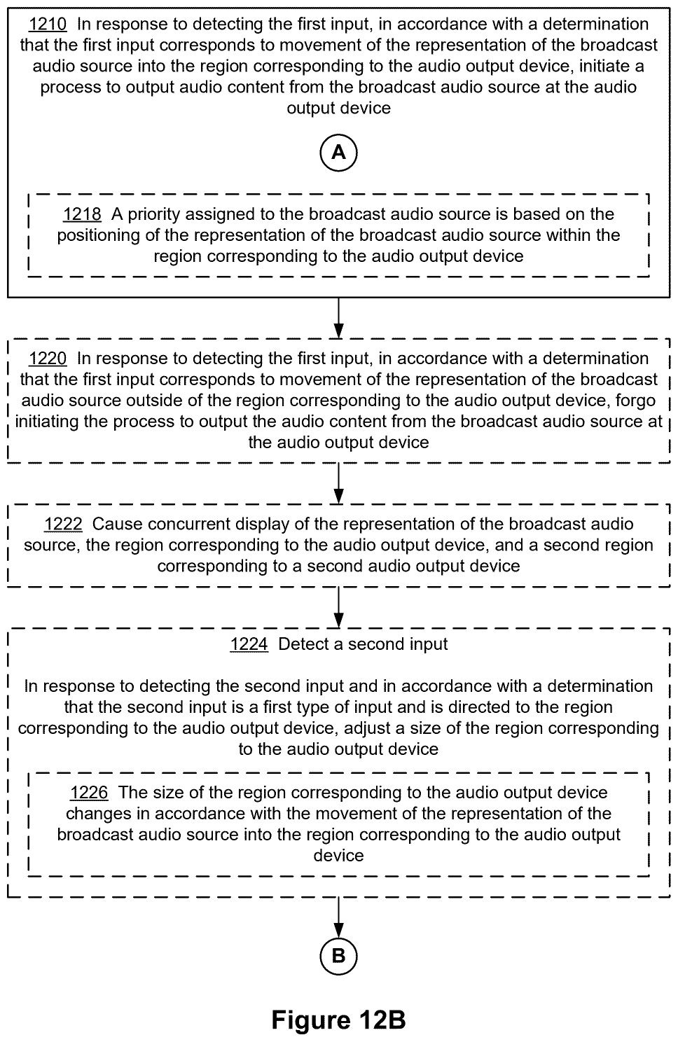

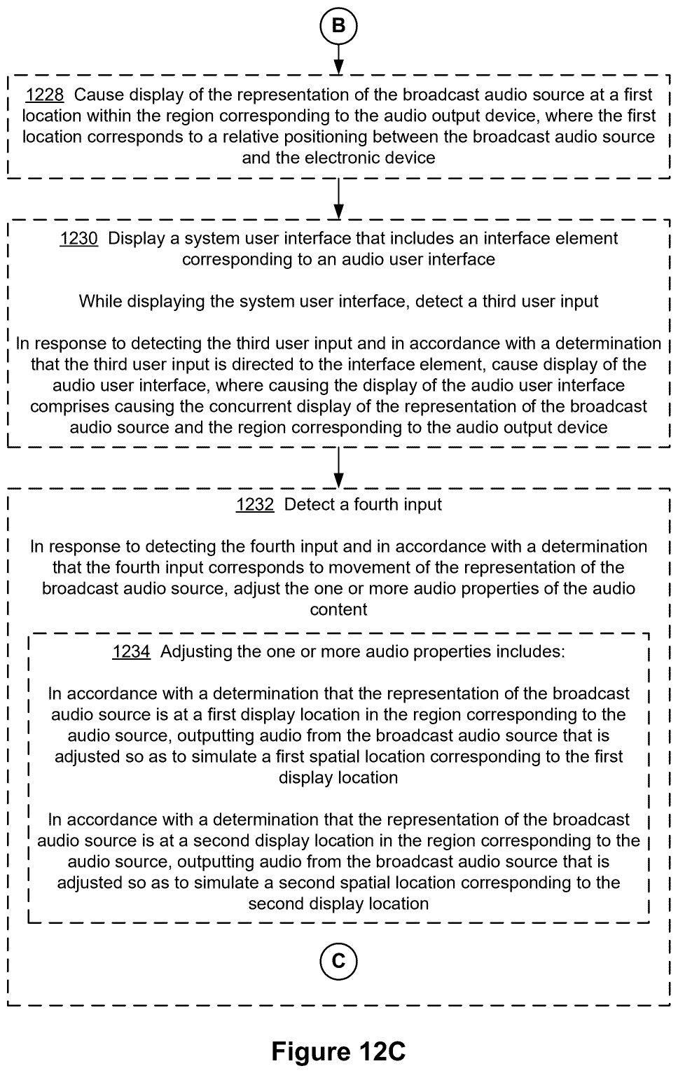

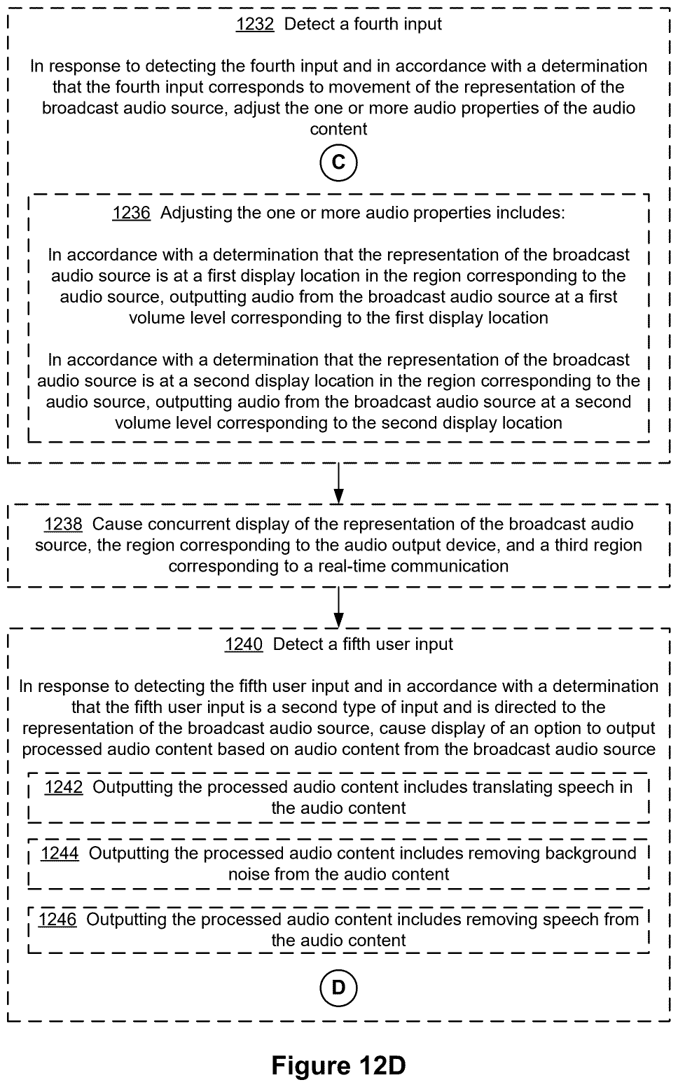

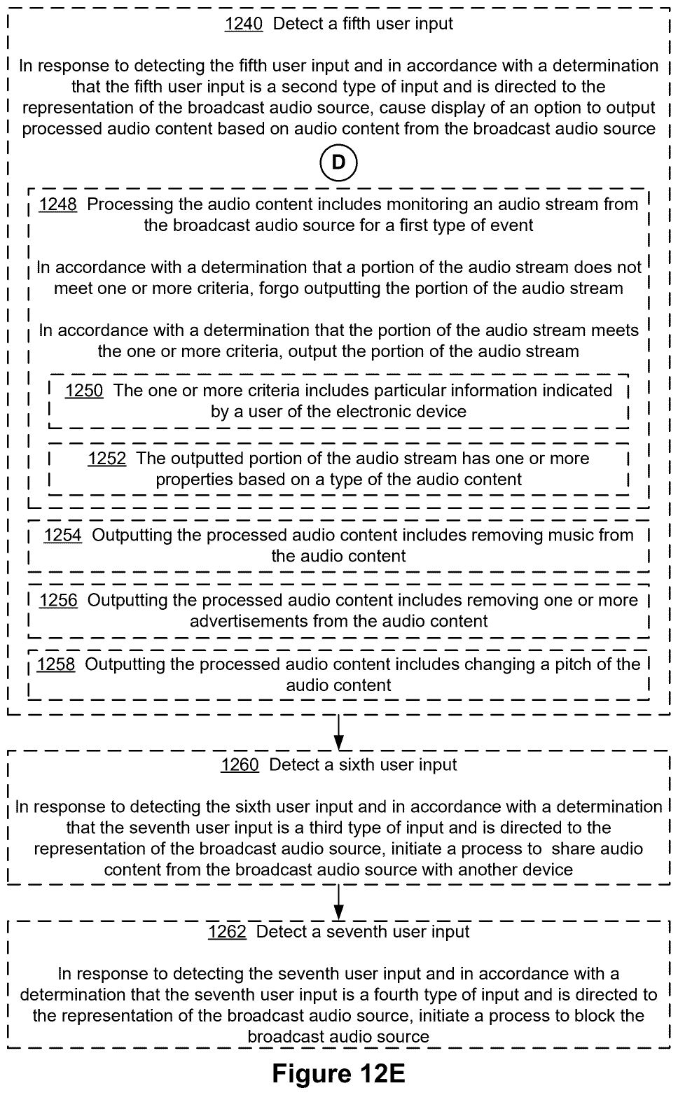

Below, FIGS. 1A-1B, 2, 3A, and 3H-3K provide a description of example devices. FIGS. 3B-3G describe the use of Application Programming Interfaces (APIs) to perform operations. FIGS. 4A-4B, 5A-5H, 6A-6G, 7A-71, 8A-8K, 9A-9E, and 10A-10C illustrate example user interactions and user interfaces for interacting with various audio sources. FIGS. 11A-11F are flow diagrams of a process for outputting audio from audio sources. FIGS. 12A-12E are flow diagrams of a process for manipulating audio source representations to adjust output audio. The user interfaces in FIGS. 4A-4B, 5A-5H, 6A-6G, 7A-71, 8A-8K, 9A-9E, and 10A-10C are used to illustrate the processes in FIGS. 11A-11F and 12A-12E.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random-access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

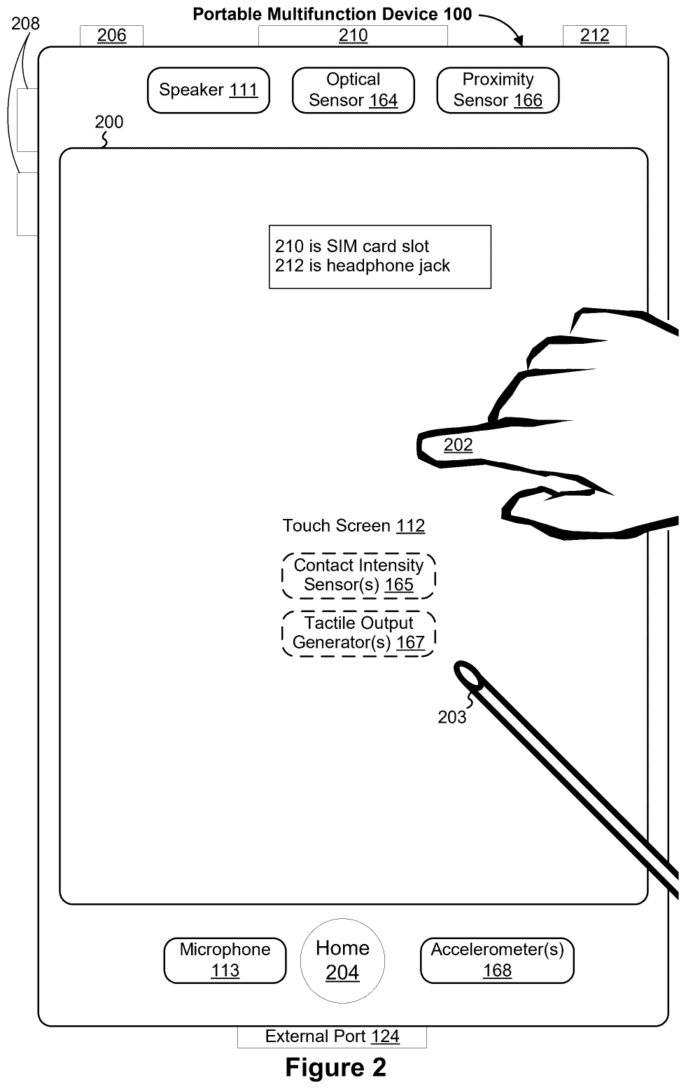

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture-which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher-level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event-to-event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A), optionally audio I/O logic, and/or wireless interface 381.

Memory 370 includes high-speed random-access memory, such as DRAM, SRAM, DDR RAM or other random-access solid-state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 1100 (FIGS. 11A-11F) and/or method 1200 (FIGS. 12A-12E) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 3H illustrates physical features of an example wearable audio output device 301 in accordance with some embodiments. In some embodiments, the wearable audio output device 301 is one or more in-ear earphone(s), earbud(s), over-ear headphone(s), or the like. In the example of FIG. 3H, wearable audio output device 301 is an earbud. In some embodiments, wearable audio output device 301 includes a head portion 303 and a stem portion 305. In some embodiments, head portion 303 is configured to be inserted into a user's ear. In some embodiments, stem portion 305 physically extends from head portion 303 (e.g., is an elongated portion extending from head portion 303). For example, stem portion 305 physically extends downward, in front of, and/or past a user's earlobe while head portion 303 is inserted into a user's ear.

In some embodiments, wearable audio output device 301 includes one or more audio speakers 306 (e.g., in head portion 303) for providing audio output (e.g., to a user's ear). In some embodiments, wearable audio output device 301 includes one or more placement sensors 304 (e.g., placement sensors 304-1 and 304-2 in head portion 303) to detect positioning or placement of wearable audio output device 301 relative to a user's ear, such as to detect placement of wearable audio output device 301 in a user's ear.

In some embodiments, wearable audio output device 301 includes one or more microphones 302 for receiving audio input. In some embodiments, one or more microphones 302 are included in head portion 303 (e.g., microphone 302-1). In some embodiments, one or more microphones 302 are included in stem portion 305 (e.g., microphone 302-2). In some embodiments, microphone(s) 302 detect speech from a user wearing wearable audio output device 301 and/or ambient noise around wearable audio output device 301. In some embodiments, multiple microphones of microphones 302 are positioned at different locations on wearable audio output device 301 to measure speech and/or ambient noise at different locations around wearable audio output device 301.

In some embodiments, wearable audio output device 301 includes one or more input devices 308 (e.g., in stem portion 305). In some embodiments, input device(s) 308 includes a pressure-sensitive (e.g., intensity-sensitive) input device. In some embodiments, the pressure-sensitive input device detects inputs from a user in response to the user squeezing the input device (e.g., by pinching stem portion 305 of wearable audio output device 301 between two fingers). In some embodiments, input device(s) 308 include a touch-sensitive surface (e.g., a capacitive sensor) for detecting touch inputs, accelerometer(s), and/or attitude sensor(s) (e.g., for determining an attitude of wearable audio output device 301 relative to a physical environment and/or changes in attitude of the device), and/or other input device by which a user can interact with and provide inputs to wearable audio output device 301. In some embodiments, input device(s) 308 include one or more capacitive sensors, one or more force sensors, one or more motion sensors, and/or one or more orientation sensors. FIG. 3H shows input device(s) 308 at a location in stem portion 305, however in some embodiments one or more of input device(s) 308 are located at other positions within wearable audio output device 301 (e.g., other positions within stem portion 305 and/or head portion 303). In some embodiments, wearable audio output device 301 includes a housing with one or more physically distinguished portions 307 at locations that correspond to input device(s) 308 (e.g., to assist a user in locating and/or interacting with input device(s) 308). In some embodiments, physically distinguished portion(s) 307 include indent(s), raised portion(s), and/or portions with different textures. In some embodiments, physically distinguished portion(s) 307 include a single distinguished portion that spans multiple input devices 308. For example, input devices 308 include a set of touch sensors configured to detect swipe gestures and a single distinguished portion (e.g., a depression or groove) spans the set of touch sensors. In some embodiments, physically distinguished portion(s) 307 include a respective distinguished portion for each input device of input device(s) 308.

In some embodiments, wearable audio output device 301 includes one or more sensors 311 (e.g., sensors 311-1 and 311-2 in stem portion 305). In some embodiments, the one or more sensors 311 include one or more movement sensors (e.g., accelerometers, IMUs, and/or other types of movement sensors). In some embodiments, the one or more sensors 311 include one or more image sensors or cameras. In some embodiments, the sensor(s) 311 include a sensor (e.g., the sensor 311-1) that faces forward while the wearable audio output device 301 is being worn by a user. In some embodiments, the sensor(s) 311 include a sensor (e.g., the sensor 311-2) that faces backwards while the wearable audio output device 301 is being worn by a user. In some embodiments, the sensor(s) 311 consist of one sensor (e.g., with a field of view that is substantially the same as the wearer of the wearable audio output device 301). In some embodiments, the sensor(s) 311 include three or more sensors (e.g., each with a different field of view). In some embodiments, one or more of the sensor(s) 311 are arranged at different positions than shown in FIG. 3H. For example, one of the sensor(s) 311 may be arranged on the head portion 303. As another example, one of the sensor(s) 311 may be arranged near the middle or top of the stem portion 305.

FIG. 3I is a block diagram of an example wearable audio output device 301 in accordance with some embodiments. In some embodiments, wearable audio output device 301 is one or more in-ear earphone(s), earbud(s), over-car headphone(s), or the like. In some examples, wearable audio output device 301 includes a pair of earphones or earbuds (e.g., one for each of a user's ears). In some examples, wearable audio output device 301 includes over-ear headphones (e.g., headphones with two over-ear earcups to be placed over a user's ears and optionally connected by a headband). In some embodiments, wearable audio output device 301 includes one or more audio speakers 306 for providing audio output (e.g., to a user's ear). In some embodiments, wearable audio output device 301 includes one or more placement sensors 304 to detect positioning or placement of wearable audio output device 301 relative to a user's ear, such as to detect placement of wearable audio output device 301 in a user's ear. In some embodiments, wearable audio output device 301 conditionally outputs audio based on whether wearable audio output device 301 is in or near a user's ear (e.g., wearable audio output device 301 forgoes outputting audio when not in a user's ear, to reduce power usage). In some embodiments where wearable audio output device 301 includes multiple (e.g., a pair) of wearable audio output components (e.g., earphones, earbuds, or earcups), each component includes one or more respective placement sensors, and wearable audio output device 301 conditionally outputs audio based on whether one or both components is in or near a user's ear, as described herein. In some embodiments, wearable audio output device 301 furthermore includes an internal rechargeable battery 309 for providing power to the various components of wearable audio output device 301.

In some embodiments, wearable audio output device 301 includes audio I/O logic 312, which determines the positioning or placement of wearable audio output device 301 relative to a user's ear based on information received from placement sensor(s) 304, and, in some embodiments, audio I/O logic 312 controls the resulting conditional outputting of audio. In some embodiments, wearable audio output device 301 includes an interface 315, e.g., a wireless interface, for communication with one or more multifunction devices, such as device 100 (e.g., as shown in FIG. 1A) or device 300 (e.g., as shown in FIG. 3A). In some embodiments, interface 315 includes a wired interface for connection with a multifunction device, such as device 100 (e.g., as shown in FIG. 1A) or device 300 (e.g., as shown in FIG. 3A) (e.g., via a headphone jack or other audio port). In some embodiments, a user can interact with and provide inputs (e.g., remotely) to wearable audio output device 301 via interface 315. In some embodiments, wearable audio output device 301 is in communication with multiple devices (e.g., multiple multifunction devices, and/or an audio output device case), and audio I/O logic 312 determines, which of the multifunction devices from which to accept instructions for outputting audio.

In some embodiments, wearable audio output device 301 includes one or more microphones 302 for receiving audio input. In some embodiments where wearable audio output device 301 includes multiple (e.g., a pair) of wearable audio output components (e.g., earphones or earbuds), each component includes one or more respective microphones. In some embodiments, audio I/O logic 312 detects or recognizes speech or ambient noise based on information received from microphone(s) 302.

In some embodiments, wearable audio output device 301 includes one or more input devices 308. In some embodiments where wearable audio output device 301 includes multiple (e.g., a pair) of wearable audio output components (e.g., earphones, earbuds, or earcups), each component includes one or more respective input devices. In some embodiments, input device(s) 308 include one or more volume control hardware elements (e.g., an up/down button for volume control, or an up button and a separate down button, as described herein with reference to FIG. 1A) for volume control (e.g., locally) of wearable audio output device 301. In some embodiments, inputs provided via input device(s) 308 are processed by audio I/O logic 312. In some embodiments, audio I/O logic 312 is in communication with a separate device (e.g., device 100, FIG. 1A, or device 300, FIG. 3A) that provides instructions or content for audio output, and that optionally receives and processes inputs (or information about inputs) provided via microphone(s) 302, placement sensor(s) 304, and/or input device(s) 308, or via one or more input devices of the separate device. In some embodiments, audio I/O logic 312 is located in device 100 (e.g., as part of peripherals interface 118, FIG. 1A) or device 300 (e.g., as part of I/O interface 330, FIG. 3A), instead of device 301, or alternatively is located in part in device 100 and in part in device 301, or in part in device 300 and in part in device 301.

FIG. 3J illustrates example audio control by a wearable audio output device 301 in accordance with some embodiments. While the following example is explained with respect to implementations that include a wearable audio output device having earbuds to which interchangeable eartips (sometimes called silicon eartips or silicon seals) are attached, the methods, devices and user interfaces described herein are equally applicable to implementations in which the wearable audio output devices do not have eartips, and instead each have a portion of the main body shaped for insertion in the user's ears. In some embodiments in which a wearable audio output device has earbuds to which interchangeable eartips may be attached are worn in a user's ears, the earbuds and eartips together act as physical barriers that block at least some ambient sound from the surrounding physical environment from reaching the user's ear. For example, in FIG. 3J, wearable audio output device 301 is worn by a user such that head portion 303 and eartip 314 are in the user's left ear. Eartip 314 extends at least partially into the user's ear canal. Preferably, when head portion 303 and eartip 314 are inserted into the user's ear, a seal is formed between eartip 314 and the user's ear so as to isolate the user's ear canal from the surrounding physical environment. However, in some circumstances, head portion 303 and eartip 314 together block some, but not necessarily all, of the ambient sound in the surrounding physical environment from reaching the user's ear. Accordingly, in some embodiments, a first microphone (or, in some embodiments, a first set of one or more microphones) 302-1 (and optionally a third microphone 302-3) is located on wearable audio output device 301 so as to detect ambient sound, represented by waveform 322, in region 316 of a physical environment surrounding (e.g., outside of) head portion 303. In some embodiments, a second microphone (or, in some embodiments, a second set of one or more microphones) 302-2 (e.g., of microphones 302, FIG. 3I) is located on wearable audio output device 301 so as to detect any ambient sound, represented by waveform 322, that is not completely blocked by head portion 303 and eartip 314 and that can be heard in region 318 inside the user's ear canal. Accordingly, in some circumstances in which wearable audio output device 301 is not producing a noise-cancelling (also called “antiphase”) audio signal to cancel (e.g., attenuate) ambient sound from the surrounding physical environment, as indicated by waveform 326-1, ambient sound waveform 322 is perceivable by the user, as indicated by waveform 328-1. In some circumstances in which wearable audio output device 301 is producing an antiphase audio signal to cancel ambient sound, as indicated by waveform 326-2, ambient sound waveform 322 is not perceivable by the user, as indicated by waveform 328-2.

In some embodiments, ambient sound waveform 322 is compared to attenuated ambient sound waveform 324 (e.g., by wearable audio output device 301 or a component of wearable audio output device 301, such as audio I/O logic 312, or by an electronic device that is in communication with wearable audio output device 301) to determine the passive attenuation provided by wearable audio output device 301. In some embodiments, the amount of passive attenuation provided by wearable audio output device 301 is taken into account when providing the antiphase audio signal to cancel ambient sound from the surrounding physical environment. For example, antiphase audio signal waveform 326-2 is configured to cancel attenuated ambient sound waveform 324 rather than unattenuated ambient sound waveform 322.

In some embodiments, wearable audio output device 301 is configured to operate in one of a plurality of available audio output modes, such as an active noise control audio output mode, an active pass-through audio output mode, and a bypass audio output mode (also sometimes called a noise control off audio output mode). In the active noise control mode (also called “ANC”), wearable audio output device 301 outputs one or more audio-cancelling audio components (e.g., one or more antiphase audio signals, also called “audio-cancelation audio components”) to at least partially cancel ambient sound from the surrounding physical environment that would otherwise be perceivable to the user. In the active pass-through audio output mode, wearable audio output device 301 outputs one or more pass-through audio components (e.g., plays at least a portion of the ambient sound from outside the user's ear, received by microphone 302-1, for example) so that the user can hear a greater amount of ambient sound from the surrounding physical environment than would otherwise be perceivable to the user (e.g., a greater amount of ambient sound than would be audible with the passive attenuation of wearable audio output device 301 placed in the user's ear). In the bypass mode, active noise management is turned off, such that wearable audio output device 301 outputs neither any audio-cancelling audio components nor any pass-through audio components (e.g., such that any amount of ambient sound that the user perceives is due to physical attenuation by wearable audio output device 301).

FIG. 3K illustrates physical features of an example wearable audio output device 301 in accordance with some embodiments. In the example of FIG. 3K, wearable audio output device 301 includes over-ear earcups worn over a user's ears, the earcups act as physical barriers that block at least some ambient sound from the surrounding physical environment from reaching the user's ear. For example, in FIG. 3K, wearable audio output device 301 is worn by a user such that earcup 317 is over the user's left ear. In some embodiments, a first microphone (or, in some embodiments, a first set of one or more microphones) 302-1 (e.g., of microphones 302, FIG. 3H) is located on wearable audio output device 301 so as to detect ambient sound in region 316 of a physical environment surrounding (e.g., outside of) earcup 317. In some embodiments, earcup 317 blocks some, but not necessarily all, of the ambient sound in the surrounding physical environment from reaching the user's ear. In some embodiments, a second microphone (or, in some embodiments, a second set of one or more microphones) 302-2 (e.g., of microphones 302, FIG. 3H) is located on wearable audio output device 301 so as to detect any ambient sound that is not completely blocked by earcup 317 and that can be heard in region 318 inside earcup 317. Accordingly, in some circumstances in which wearable audio output device 301 is not producing a noise-cancelling (also called “antiphase”) audio signal to cancel (e.g., attenuate) ambient sound from the surrounding physical environment, ambient sound waveform 324 (FIG. 3J) is perceivable by the user. In some circumstances in which wearable audio output device 301 is producing an antiphase audio signal to cancel ambient sound, ambient sound waveform 324 is not perceivable by the user.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:

Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 355, FIG. 3A) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

### User Interfaces and Associated Processes

Attention is now directed towards embodiments of user interfaces (“UI”) and associated processes that may be implemented on an electronic device, such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

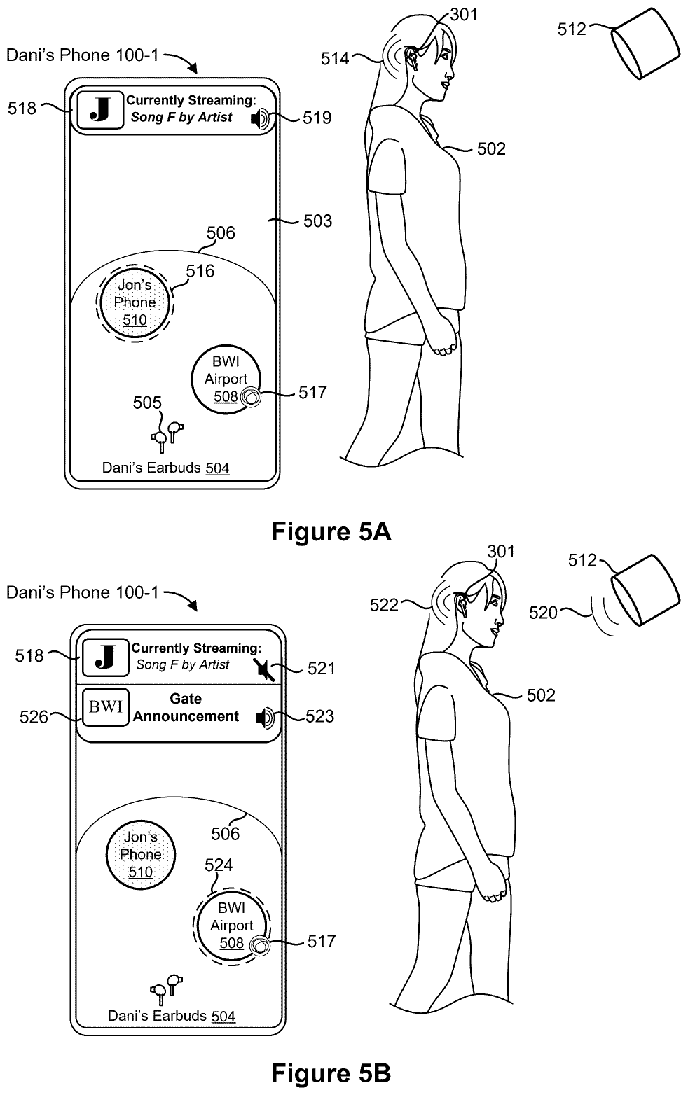

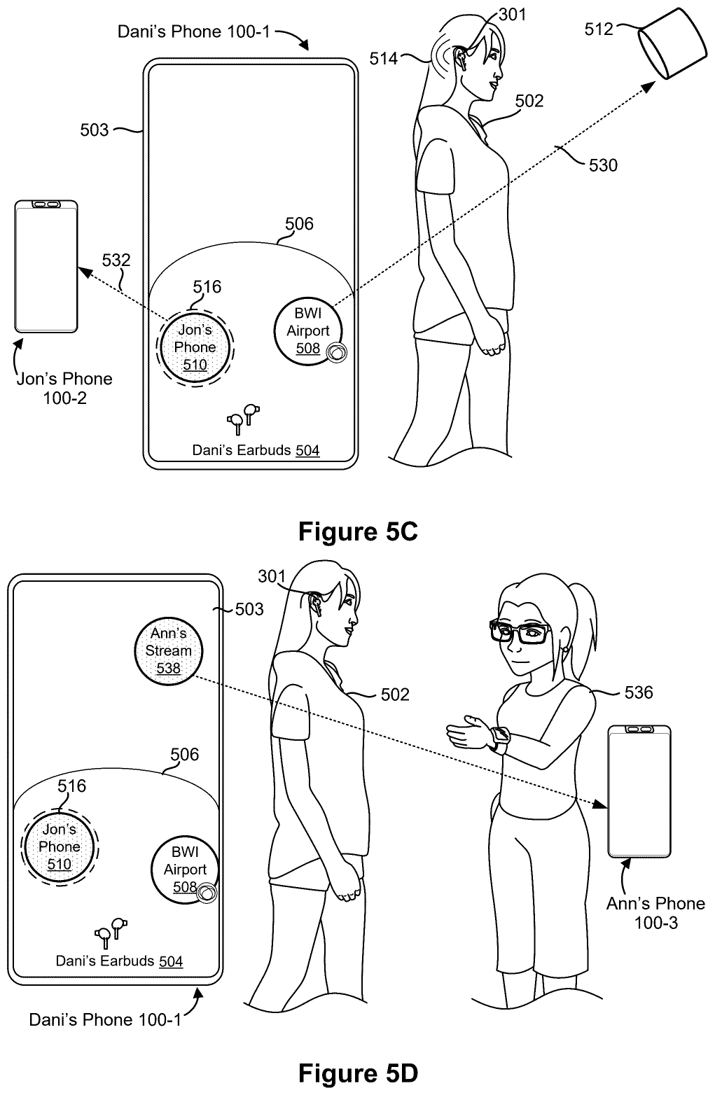

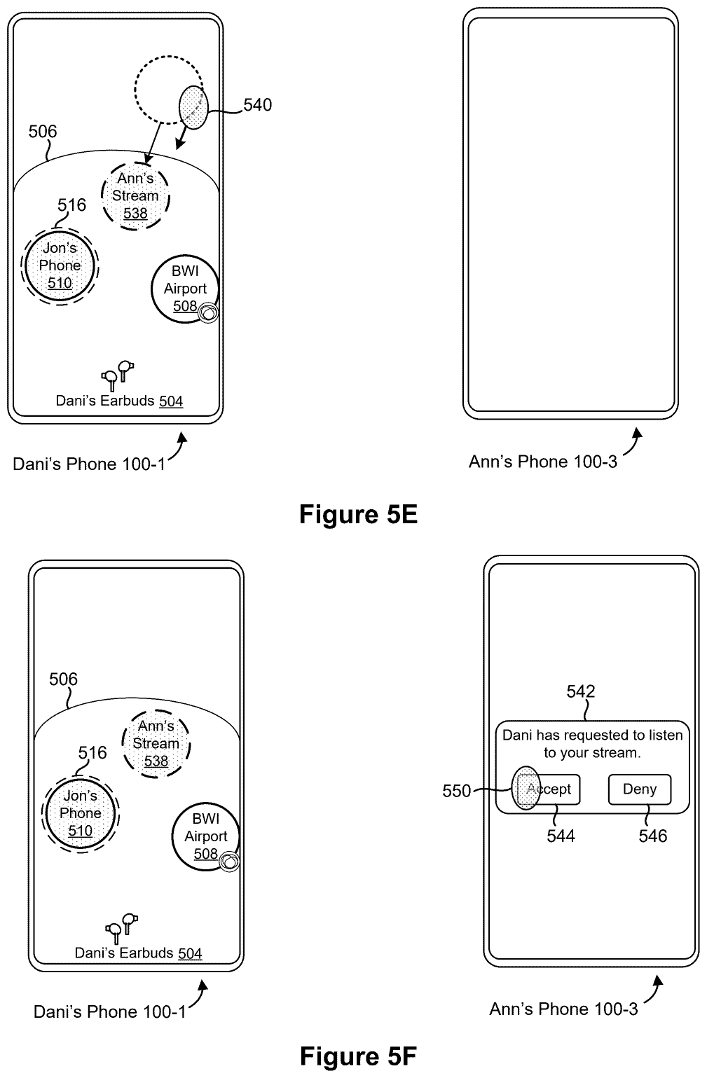

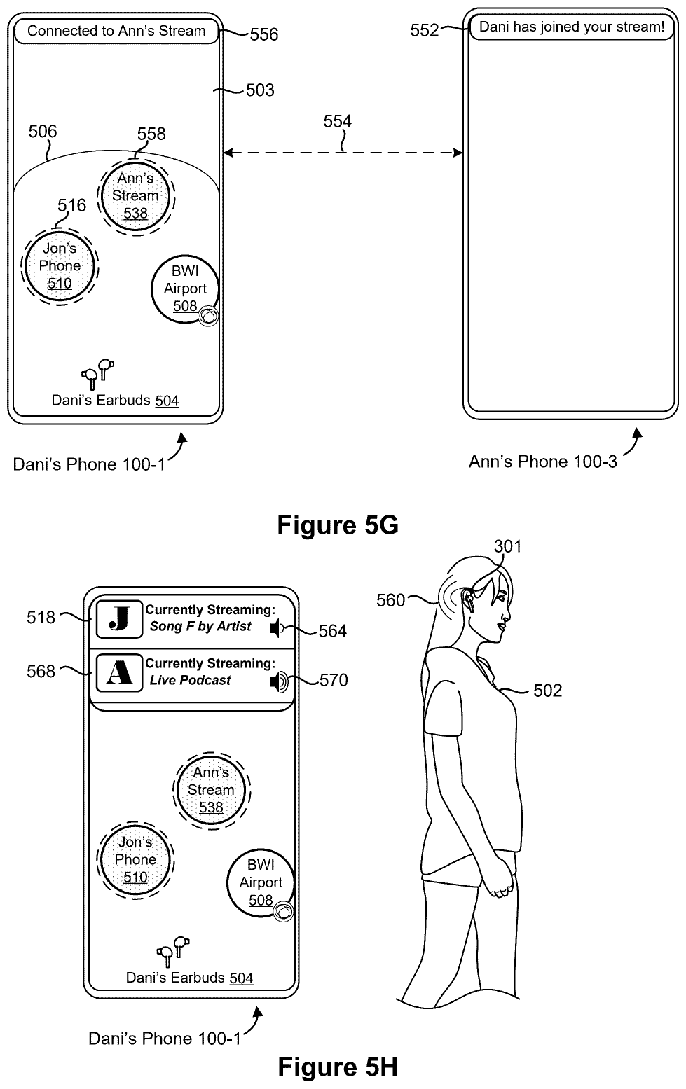

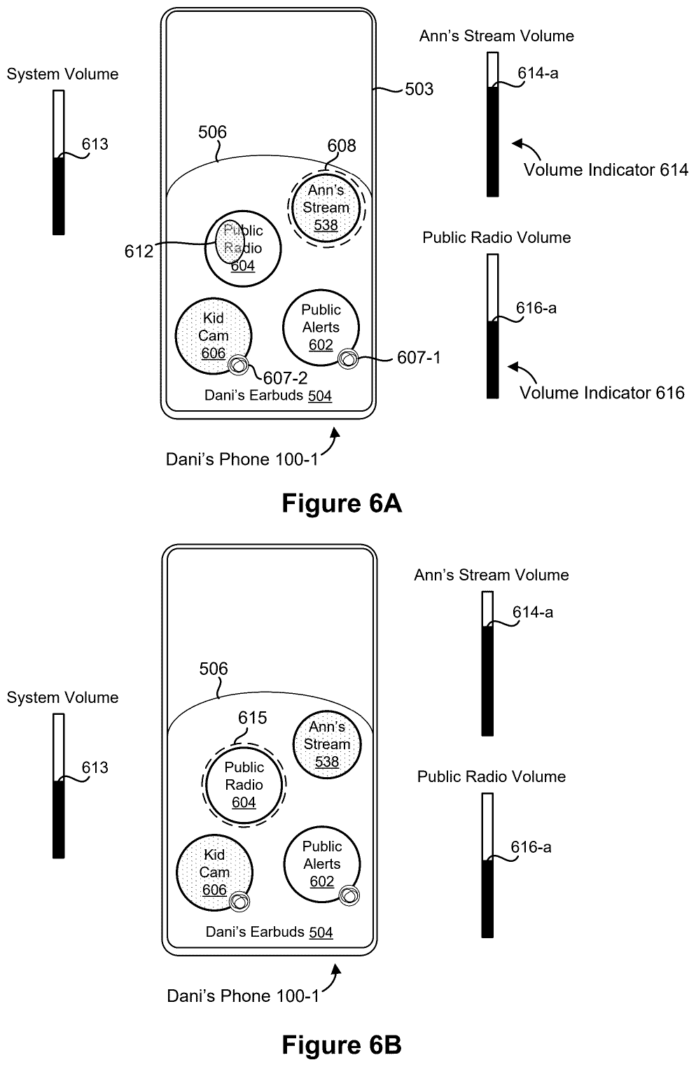

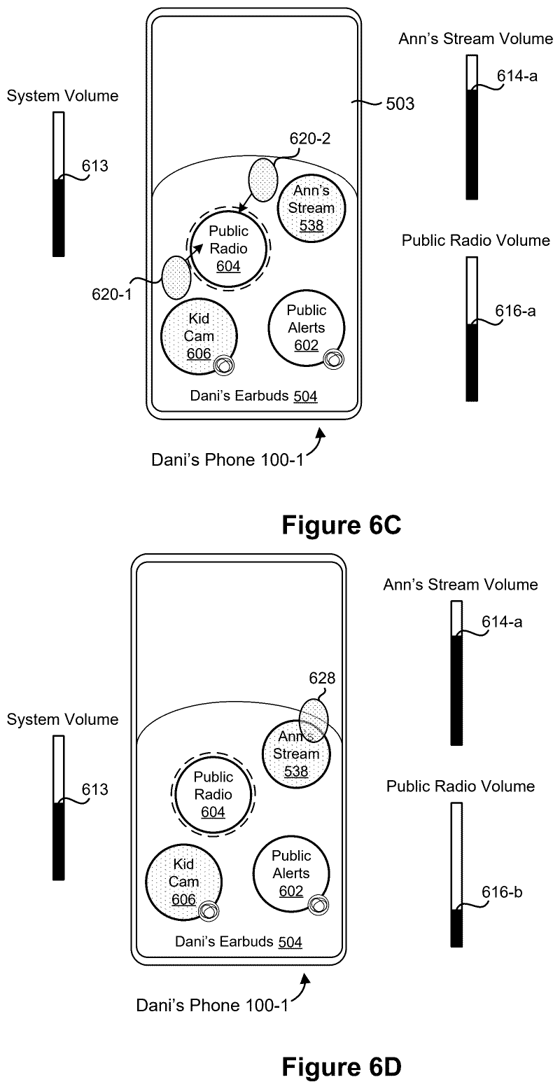

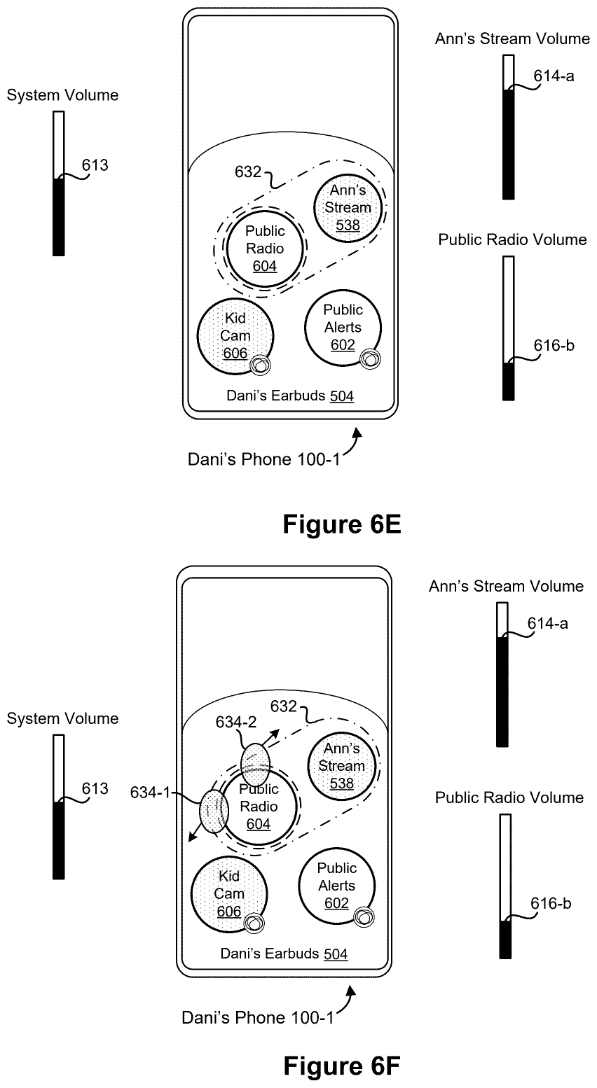

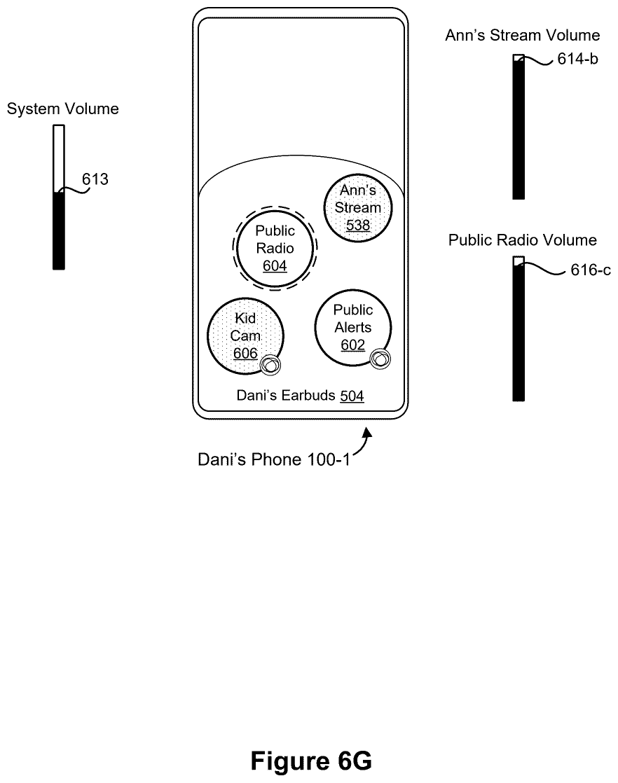

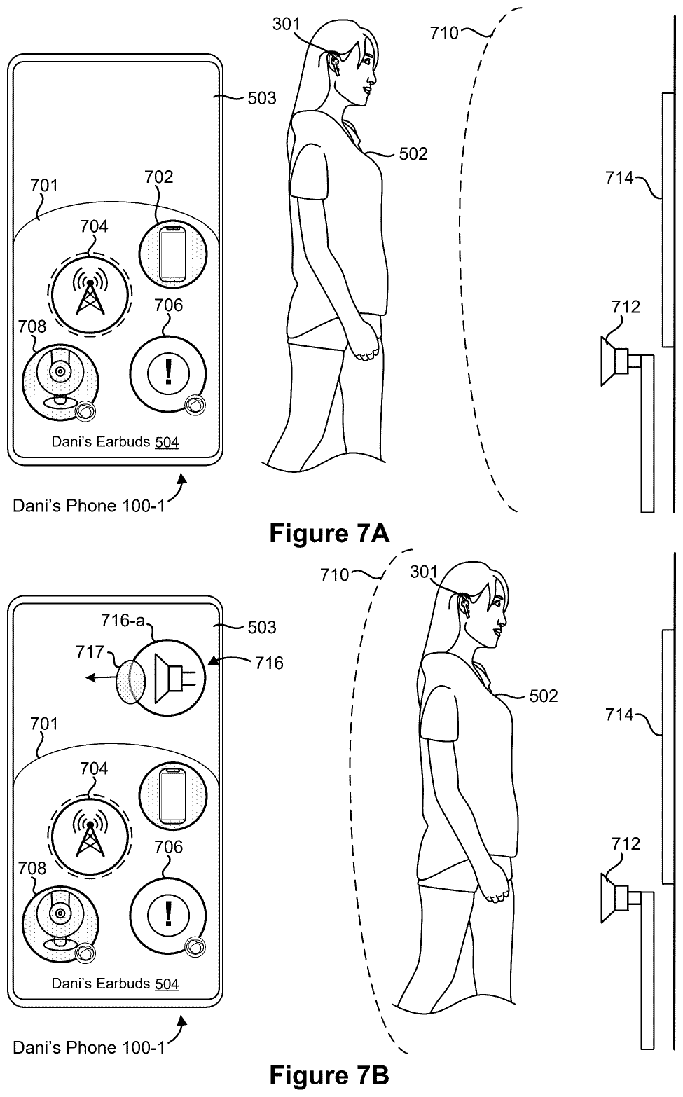

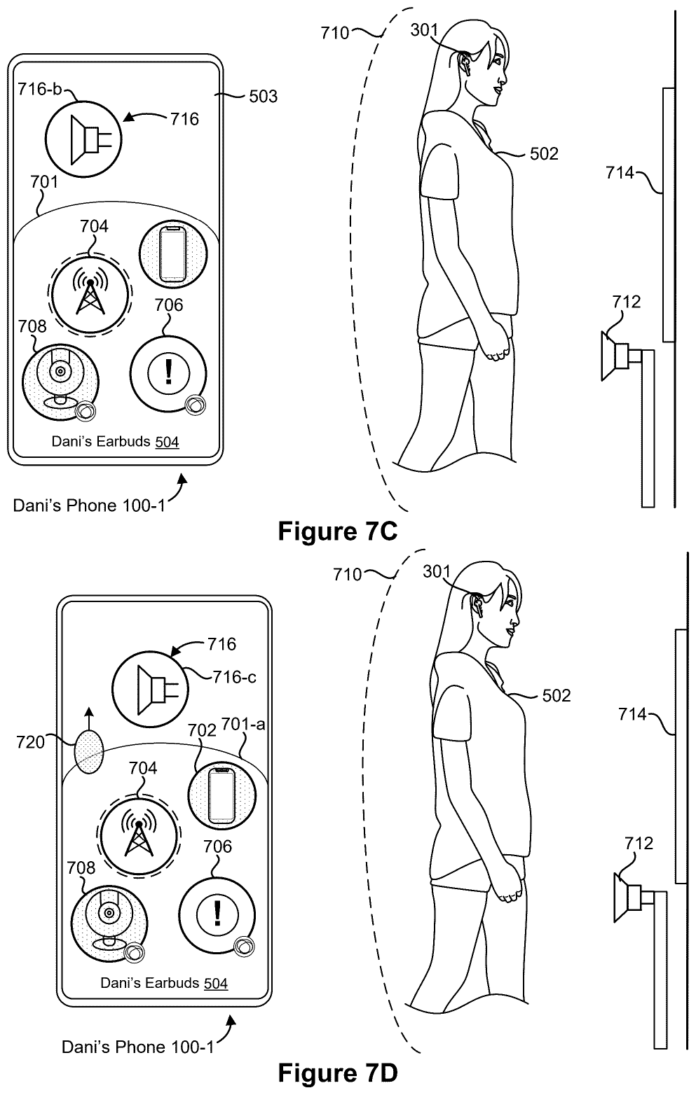

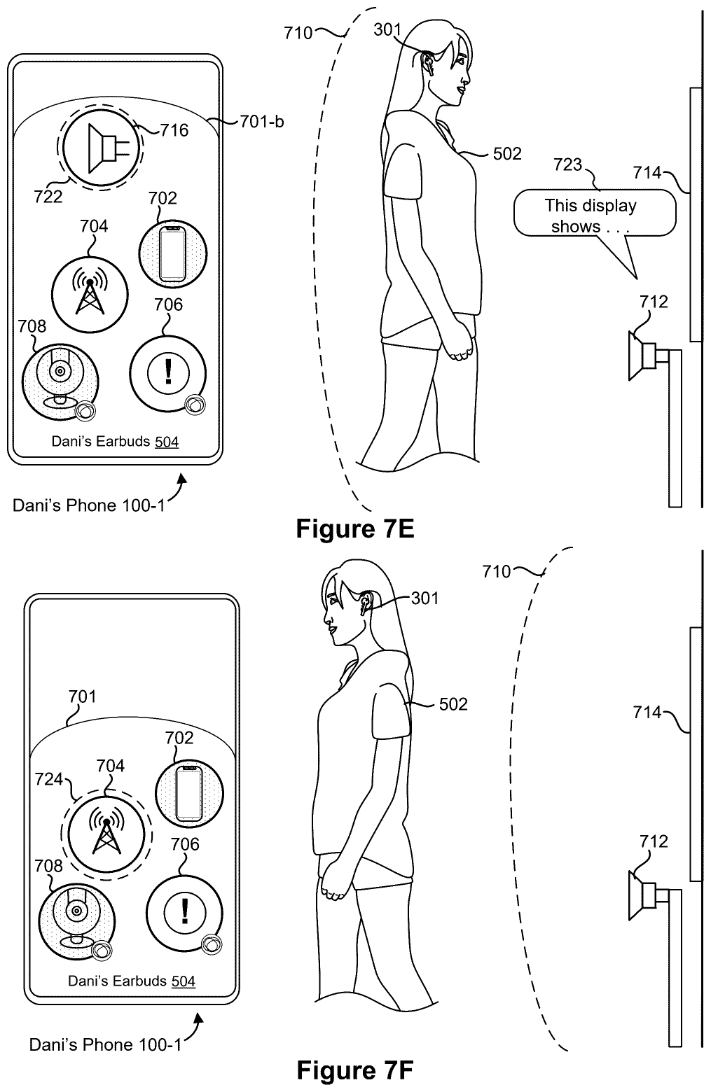

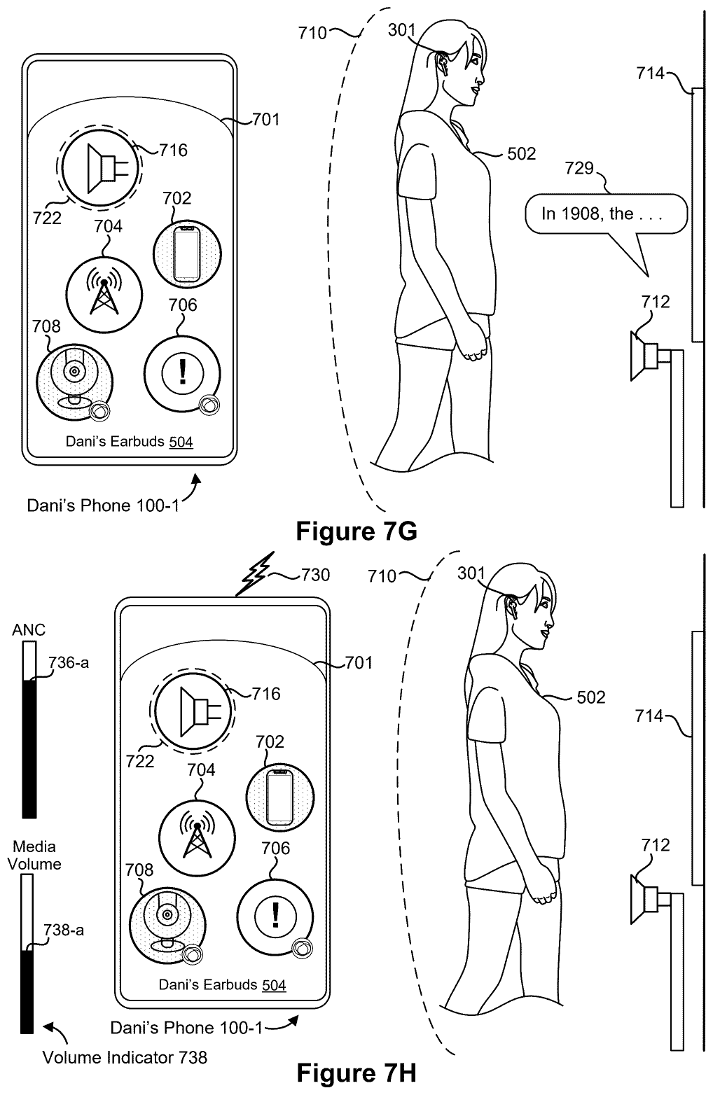

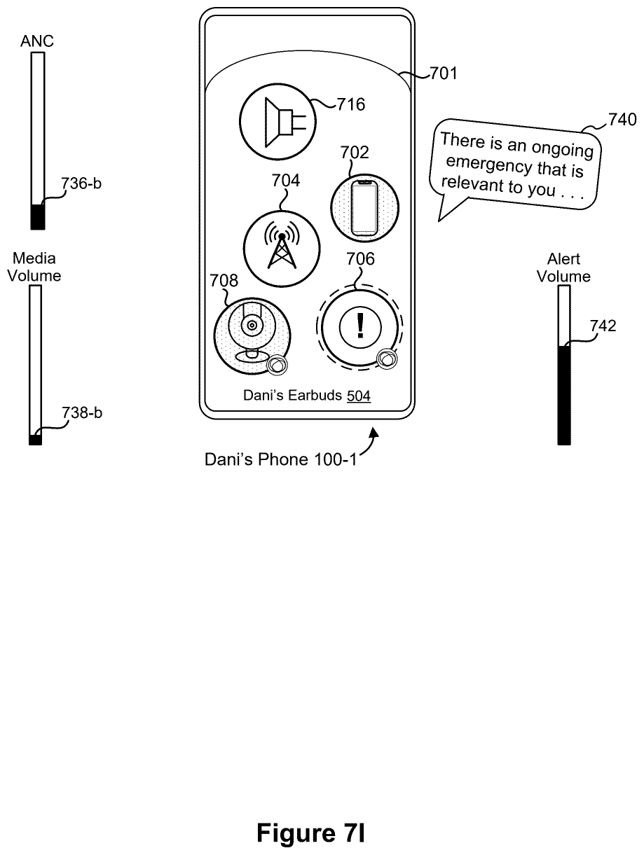

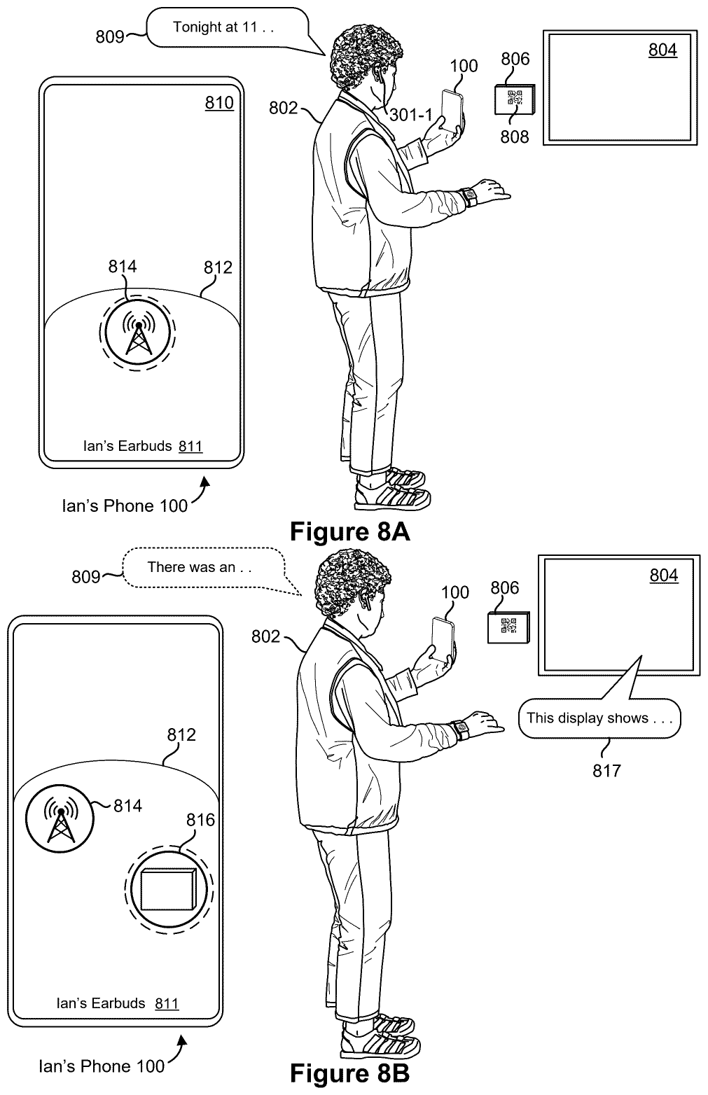

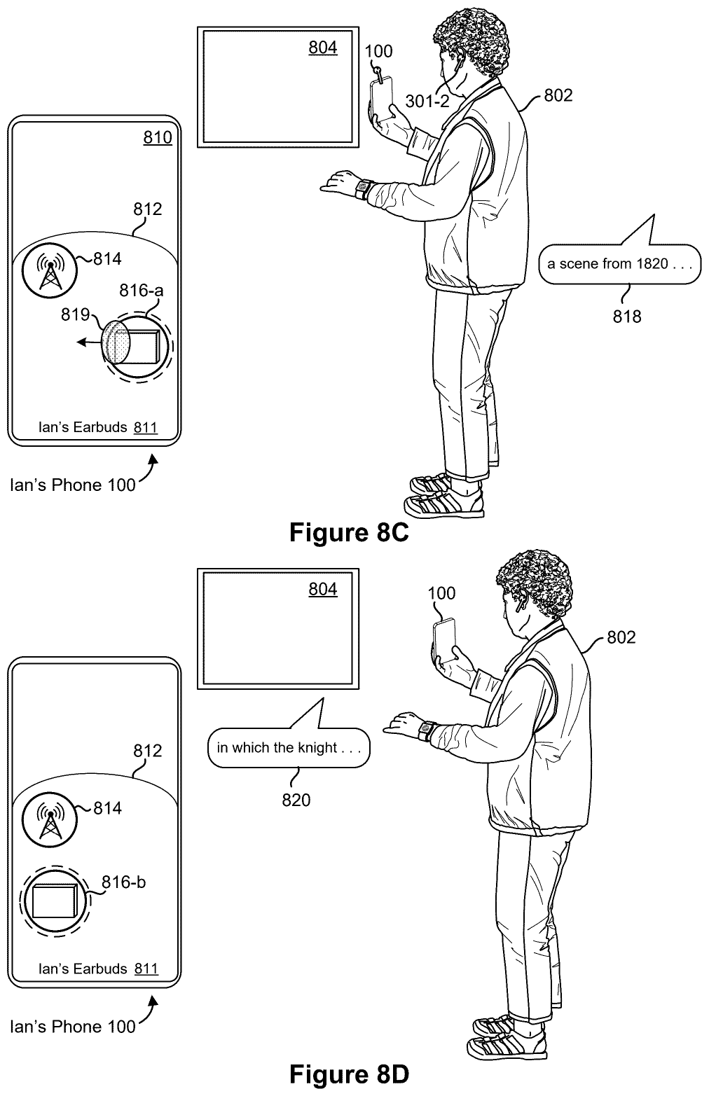

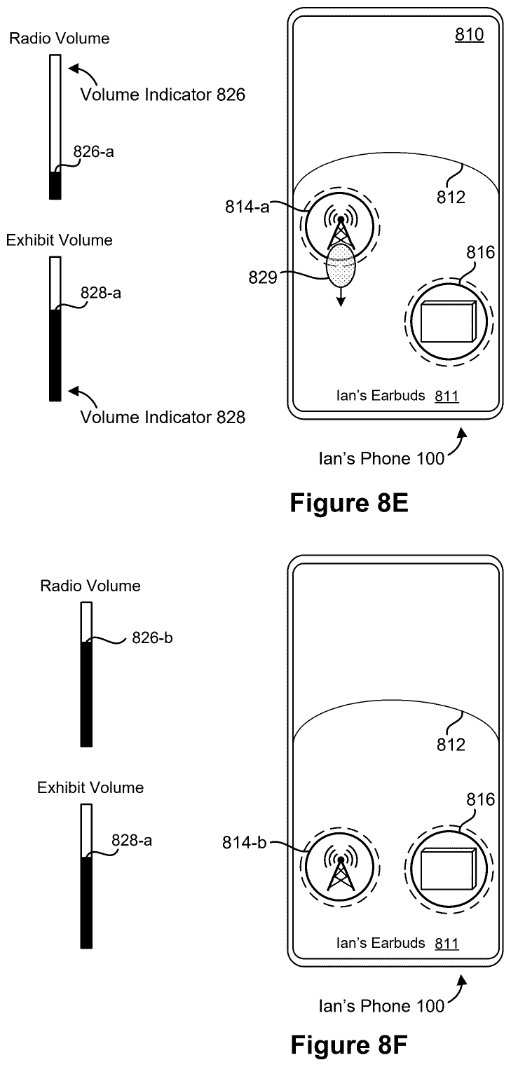

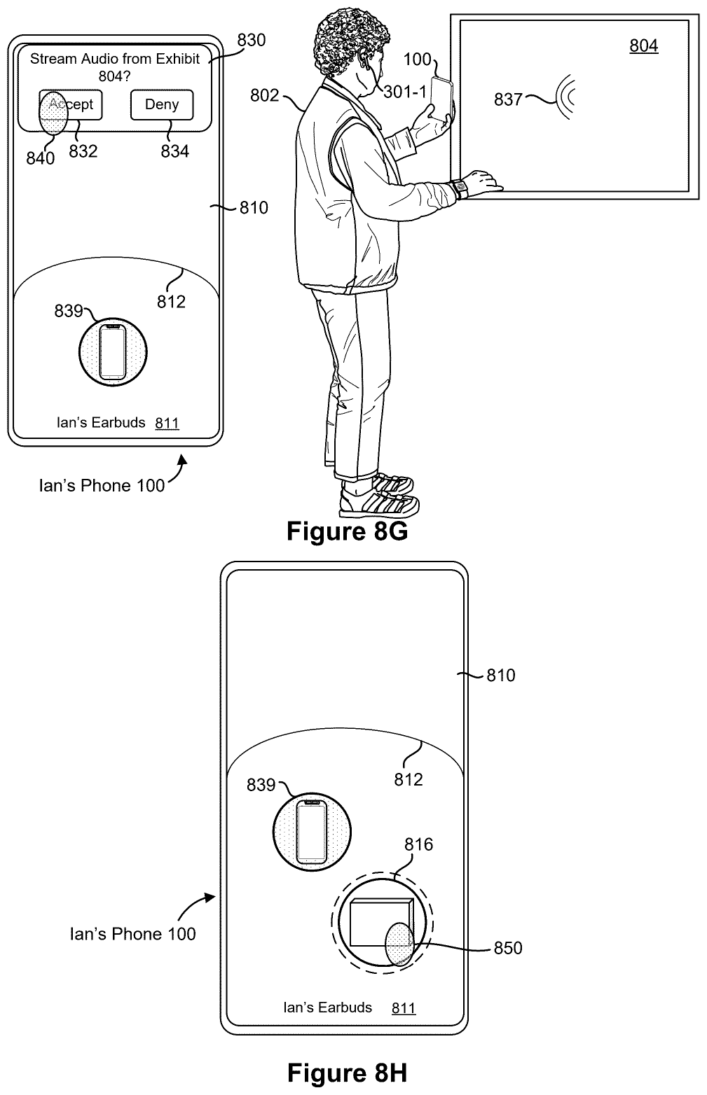

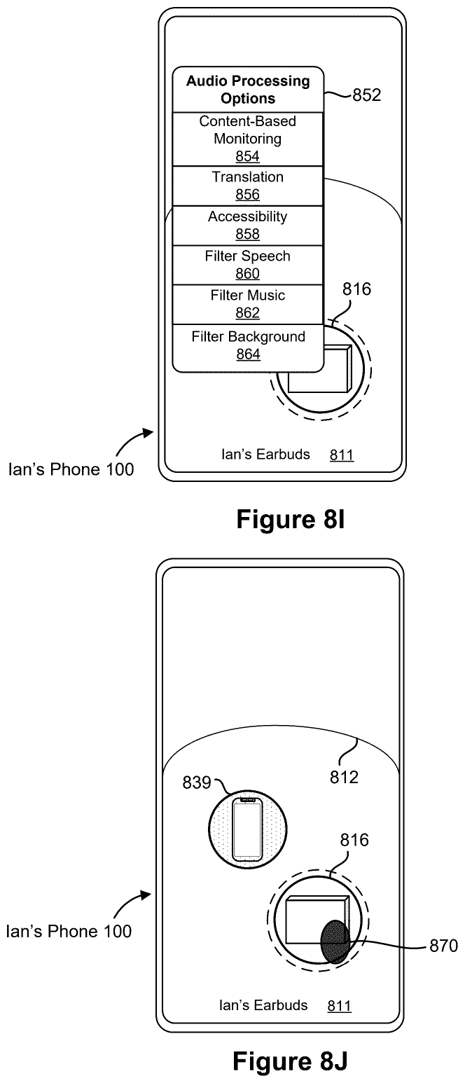

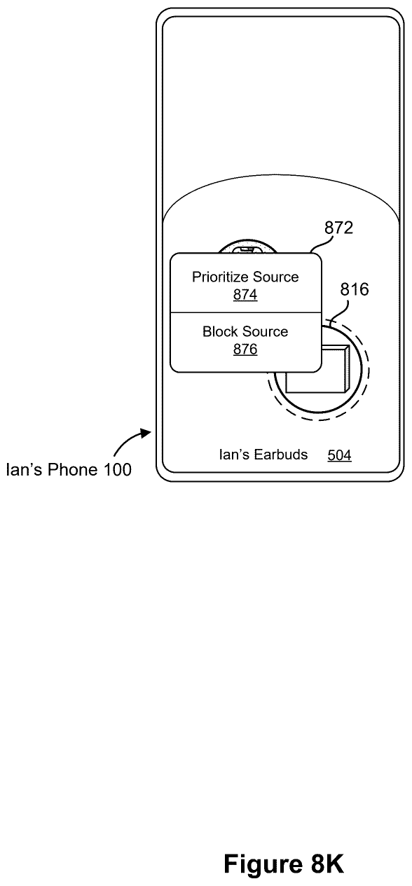

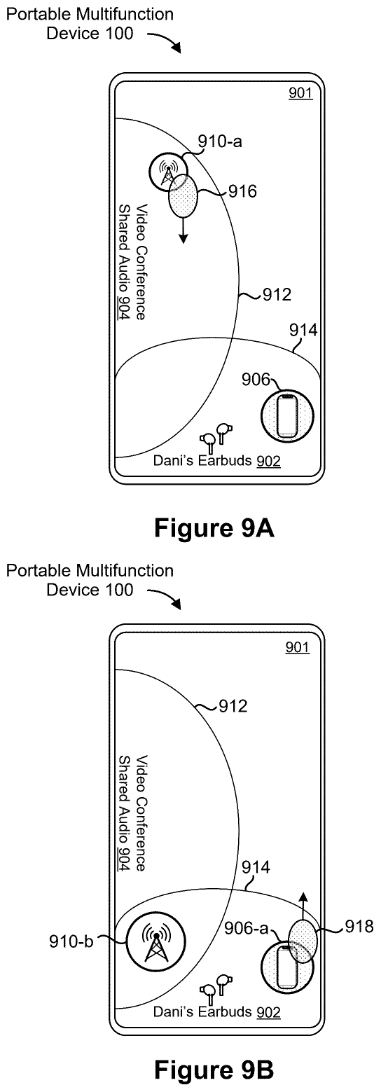

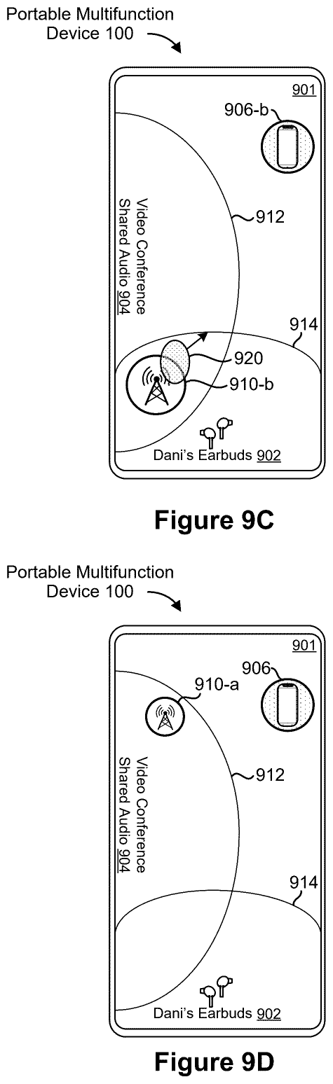

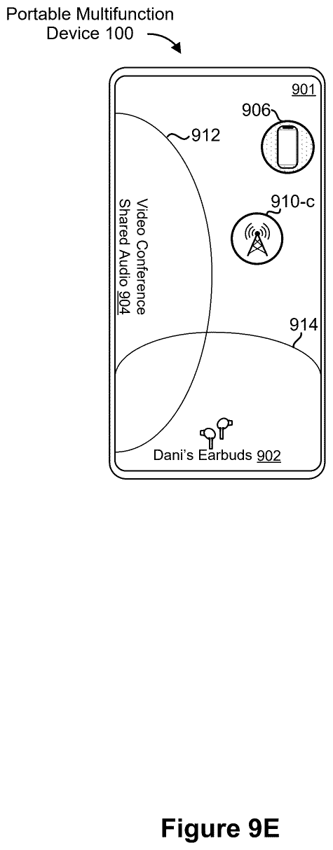

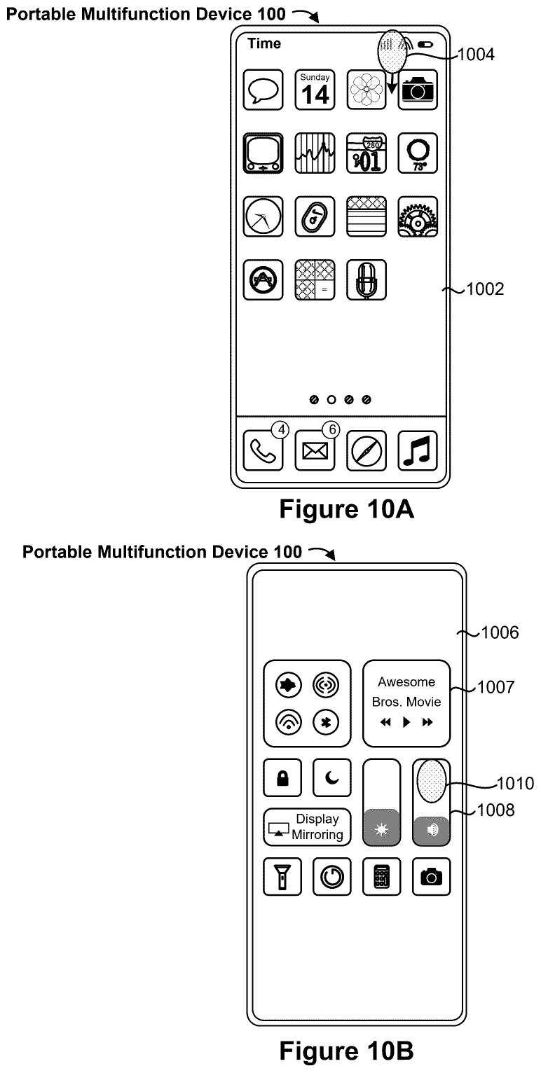

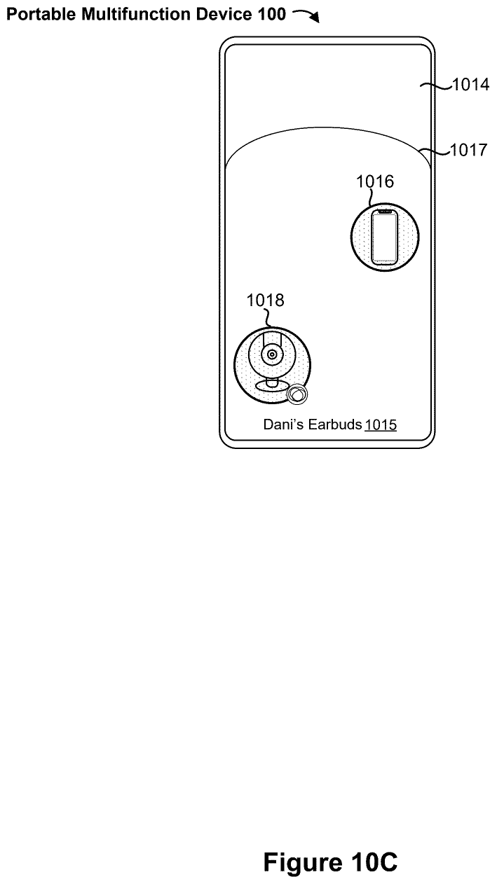

FIGS. 5A-5H illustrate example user interfaces and user interactions for outputting audio from audio sources. FIGS. 6A-6G illustrate example user interfaces and user interactions for adjusting audio properties from audio sources. FIGS. 7A-71 illustrate example user interfaces and user interactions for outputting audio from different audio sources. FIGS. 8A-8K illustrate example user interfaces and user interactions for outputting and adjusting audio from audio sources. FIGS. 9A-9E illustrate example user interfaces and user interactions for outputting audio from audio sources at various audio output devices. FIGS. 10A-10C illustrate example user interfaces and user interactions for displaying audio interfaces. The user interfaces in these figures are used to illustrate the processes described below, including the processes in FIGS. 11A-11F and 12A-12E. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector.

Although FIGS. 5A-5H, 6A-6G, 7A-71, 8A-8K, 9A-9E, and 10A-10C illustrate examples with phones (e.g., a phone 100-1), the user interfaces and user interactions illustrate in FIGS. 5A-5H, 6A-6G, 7A-71, 8A-8K, 9A-9E, and 10A-10C optionally involve other types of devices (e.g., other types of portable multifunction device 100, device 300, or other electronic device), such as a laptop, a tablet computer, an artificial reality headset, a smart watch, or other type of electronic device. Additionally, although FIGS. 5A-5H, 6A-6G, 7A-71, 8A-8K, 9A-9E, and 10A-10C illustrate examples with wearable audio output devices 301 (e.g., earbuds), the user interfaces and user interactions illustrate in FIGS. 5A-5H, 6A-6G, 7A-71, 8A-8K, 9A-9E, and 10A-10C optionally involve other types of audio devices, such as headphones, headsets, artificial reality headsets, smart speaker devices, or other types of audio output devices. In some embodiments, the audio content described in the figures below is output via speaker component(s) of the phone 100-1 (or other electronic device), e.g., in addition to, or alternatively to, outputting the audio content at a wearable audio output device.

FIGS. 5A-5H illustrate example user interfaces and user interactions for outputting audio from audio sources in accordance with some embodiments. FIG. 5A shows a user 502 wearing wearable audio output device 301 while in proximity to an audio source 512 (e.g., a broadcast audio source). In the example of FIG. 5A, the audio source 512 corresponds to an airport broadcast stream (e.g., providing information about flight arrivals and departures and other airport announcements). The user 502 in FIG. 5A is listening to audio content 514 corresponding to an audio stream from another user's device. In various embodiments, the user 502 is determined to be in proximity to the audio source 512 while the user is within a threshold distance corresponding to a visual range of the audio source 512, while the user is in communication range (e.g., using a particular type of wireless communication) with the audio source 512, while the user is in a same building and/or room as the audio source 512, and/or while the user is within a threshold distance corresponding to a hearing range of the audio source 512. In some embodiments, proximity for the audio source 512 is determined using a corresponding geofence for the audio source 512. In some embodiments, proximity for the audio source 512 is determined based on a detection range of one or more sensors (e.g., sensors of the audio source 512 and/or the device 100).

The phone 100-1 (e.g., a user device of the user 502) denoted as “Dani's Phone” in FIG. 5A is displaying a user interface 503 (e.g., an audio source interface) that includes a region 504 corresponding to the wearable audio output devices 301, the region 504 being denoted by line 506 and interface element 505. In accordance with some embodiments, the interface element 505 includes a graphical representation of the wearable audio output devices 301 and a corresponding label (e.g., labeled “Dani's Earbuds” to assist the user in identifying which audio output device corresponds to the region 504). The user interface 503 in FIG. 5A also includes a representation 510 for a first audio source, labeled “Jon's Phone,” and a representation 508 for a second audio source, labeled “BWI Airport.” In some embodiments, each audio source representation includes an icon (or other graphical representation) to indicate the corresponding audio source (and/or audio source type). In accordance with some embodiments, the representation 510 has a different appearance than the representation 508 to indicate different types of audio source. In some embodiments, one or more visual properties of each representation are used to indicate an audio source type of the corresponding audio source. In the example of FIG. 5A, the representation 510 includes a dotted background to indicate that the audio source, “Jon's Phone,” is a private audio source, and the representation 508 has a solid background to indicate that the audio source, “BWI Airport,” is a public audio source.

Public audio sources are sources that provide audio stream(s) that are intended for the general public. For example, public audio sources may not require authentication and/or broadcaster confirmation prior to transmitting the audio data to an audio output device, such as wearable audio output devices 301. Examples of public audio sources include public radio, public television, and public announcement sources. Private audio sources are sources that have restricted access and/or are visible to (e.g., in user interfaces for showing representations of audio sources, such as user interface 503, or accessible by) only select devices and/or users. For example, a private audio source may only be visible to devices of a particular set of users (e.g., known contacts of the broadcaster). As another example, an audio source for a private stream may require authentication of users and/or devices prior to transmitting the audio data (e.g., may require a user to log-in before an audio path is established between the audio source and the user device).

In FIG. 5A, the representation 510 includes dashed line 516 indicating that the corresponding audio source, “Jon's Phone,” is an active audio source (e.g., is currently outputting the audio content 514). The representation 508 in FIG. 5A includes an icon 517 indicating that audio content corresponding to the audio stream from the corresponding audio source, “BWI Airport,” is conditionally output based on one or more criteria. For example, the icon 517 may correspond to a request from the user 502 to only output audio that corresponds to a flight of interest to the user (e.g., arrival information, gate information, departure information, and/or other alerts or announcements that involve or impact the flight of interest). In some embodiments, the icon 517 indicates that a digital assistant (e.g., executing on the device 100) is monitoring the audio stream and editing, filtering, summarizing, and/or otherwise manipulating the audio stream. The user interface 503 further includes interface element 518 with information about the audio content 514 being output by the user's wearable audio output device 301. In the example of FIG. 5A, the interface element 518 indicates that a song, denoted “Song F,” is streaming from Jon's Phone. In some embodiments, the interface element 518 is overlaid over the user interface 503 (e.g., the interface element 518 is a pop-up notification). In some embodiments, the interface element 518 is a section of the user interface 503.

In accordance with some embodiments, the interface element 518 includes a volume element 519 indicating an output volume for the audio content 514. In some embodiments, the volume element 519 is a selectable icon. For example, in response to detecting a user input at the volume element 519, a volume adjustment user interface is displayed (e.g., with a volume slider). In some embodiments, in response to a first type of input, a volume adjust interface is displayed, and, in response to a second type of input, a mute state of the audio content 514 is toggled. In some embodiments, the interface element 518 is displayed without the volume element 519 (e.g., is displayed without an indication of the output volume level). In some embodiments, interface element 518 includes a volume slider for adjusting the output volume level of the audio content 514.

FIG. 5B shows the audio source 512 outputting audio content 520 (e.g., as a radio frequency signal carrying audio content 520, or as a streaming signal embedded in a WiFi, Bluetooth or other wireless networking signal) while the user 502 is in proximity with the audio source 512. In some embodiments, the audio content 520 corresponds to a portion of an audio stream output by the audio source 512. In the example of FIG. 5B, the audio content 520 corresponds to a gate announcement and meets the one or more criteria for selectively outputting content from the audio source 512 (e.g., is determined to be relevant to the user 502). In accordance with the audio content 520 meeting the one or more criteria, the audio source 512 transitions to an active audio source for the device 100 as indicated by dashed line 524 around the representation 508. In accordance with transitioning the audio source 512 to an active audio source, the audio source denoted as “Jon's Phone” is transitioned to being inactive, as indicated by the dashed line 516 (in FIG. 5A) not being displayed in FIG. 5B. FIG. 5B also shows interface element 518 with volume element 521 indicating that the audio stream is muted (e.g., temporarily muted while the audio content 520 is being output to the user 502), and interface element 526 with information about the audio content 520. In the example of FIG. 5B, the interface element 526 indicates that a gate announcement is streaming from the audio source 512. The interface element 526 includes a volume element 523 indicating an output volume for the audio content 520. In some embodiments, the audio source denoted as “Jon's Phone” remains active while the audio source 512 is active (e.g., content from multiple audio streams is output concurrently by the wearable audio output device 301). For example, a volume level of audio content from Jon's Phone is reduced (e.g., docked) while the audio content 520 is being output. In some embodiments, a size of each representation (e.g., the representations 508 and 510) is based on a relative output volume for corresponding audio content.

FIG. 5C shows an example in which the representations 508 and 510 are displayed at locations within the region 504 that correspond to relative positioning of the phone 100-1, the audio source 512, and the phone 100-2, denoted as “Jon's Phone.” The relative positioning of the phone 100-1 and the audio source 512 in FIG. 5C is indicated by dotted line 530, and the relative positioning of the phone 100-1 and the phone 100-2 in FIG. 5C is indicated by the dotted line 532. In some embodiments, the locations of the representations 508 and 510 within the user interface 503 are adjusted in accordance with movement of the phone 100-1, the phone 100-2, and/or the audio source 512. For example, as the user 502 moves relative to the audio source 512, the representation 508 moves within the region 504. In some embodiments, a size of each representation (e.g., the representations 508 and 510) is based on a relative distance between the phone 100-1 and the corresponding audio sources. In the example of FIG. 5C, the audio content 514 from the phone 100-2 is being output by the wearable audio output device 301, as indicated by the dashed line 516 around the representation 510.

FIG. 5D shows the user 502 meeting with a person 536. In the example of FIG. 5D, the person 536 has a phone 100-3, denoted as “Ann's Phone,” that is an audio source (e.g., is broadcasting audio content). The phone 100-1 in FIG. 5D detects an audio stream from the phone 100-3 and displays a corresponding representation 538 in the user interface 503. In the example of FIG. 5D, the phone 100-3 is a private audio source (e.g., the person 536 is required to approve requests to receive the audio stream from the phone 100-3). The representation 538 in FIG. 5D is positioned outside of the region 504, indicating that the audio source is available, but an audio path has not been established between the phone 100-3 and the phone 100-1 (e.g., additional action is required to output audio content from Ann's stream). In the example of FIG. 5D, the phone 100-2 is an active audio source, as indicated by the dashed line 516 around the representation 510.

In some embodiments, establishing (e.g., forming) an audio path between a first device and a second device comprises communicatively coupling the first and second devices. In some embodiments, establishing the audio path between the first device and the second device includes establishing one or more wireless connections and/or one or more wired connections between the first device and the second device using one or more communication protocols (e.g., a Wi-Fi protocol, a Bluetooth protocol, and/or other type of communication protocol). In some embodiments, establishing an audio path comprises forming a connection such that audio data from a first device is transmitted to a second device (e.g., to be output by an audio output component of the second device). In some embodiments, establishing the audio path includes storing connection information and the first and/or second device such that the audio path is automatically re-established if the connection is interrupted (e.g., due to interference or distance). In some embodiments, establishing the audio path includes pairing the first and second devices.

FIG. 5E shows an input 540 (e.g., a tap-and-drag input, a swipe input, or other type of input) detected at a location corresponding to the representation 538. In the example of FIG. 5E, the input 540 causes the representation 538 to move into the region 504. The representation 538 is displayed with a dashed border in FIG. 5E to indicate that an audio path has not yet been established (e.g., authentication and/or approval is still required before the audio path will be established).

FIG. 5F illustrates a transition from FIG. 5E (e.g., in response to detecting the input 540 move the representation 538 into the region 504). In FIG. 5F, a notification 542 is displayed on the phone 100-3 (e.g., displayed over a wake screen, a lock screen, or other type of screen). In some embodiments, the notification 542 is displayed as a pop-up on the wake screen if the phone 100-3 is locked or in a sleep state when the notification is received. In some embodiments, the notification 542 is displayed as a pop-up over whichever user interface is active on the phone 100-3 when the notification is received.

As used herein, a wake screen (also sometimes called a lock screen or a lock screen user interface) is a user interface that is displayed after the display of device 100 has entered a low power state during which the display is partially off, fully off, and/or is in a reduced power consumption mode (e.g., with a lower average brightness and/or a lower average refresh rate). In some embodiments, in the low power state, the display optionally displays an “always on” indicator of a time and/or date and the device displays the wake screen user interface when the device is prompted to come out of the low power state. In some embodiments, optionally in response to a user input and/or in response to a threshold amount of time elapsing, the device enters a locked state in which a password, passcode and/or biometric authentication is required to unlock the device, wherein the device has limited functionality in the locked state and must be unlocked before accessing respective applications and/or data stored on device 100. In some embodiments, the wake screen user interface is displayed regardless of whether the device is in the locked state or has already been unlocked (e.g., the wake screen user interface is displayed upon waking the device before the user accesses a home screen user interface and/or other application user interfaces). In some embodiments, one or more alerts (e.g., system alerts and/or notifications) are displayed on the wake screen user interface, optionally in response to a user input (e.g., a swipe gesture upward in the middle of the display or another gesture).

In some embodiments, the notification 542 is displayed over a home screen (e.g., overlaid over at least a portion of the home screen). As used herein, a home screen user interface includes icons for navigating to a plurality of applications that are executed by the device 100. In some embodiments, the device 100 detects and responds to interaction with the home screen user interface using one or more gestures, including touch inputs. For example, a tap input or other selection input on a respective application icon causes the respective application to launch, or otherwise open a user interface for the respective application, on the display area of device 100. In some embodiments, a plurality of views for the home screen user interface is available. For example, the device detects and responds to user inputs such as swipe gestures or other inputs (e.g., inputs directed to the currently displayed view of the home screen user interface) that correspond to requests to navigate between the plurality of views, wherein each view of the home screen user interface includes different application icons for different applications. In some embodiments, the application icons are different sizes, such as an application widget that displays information for the respective application, wherein the application widget is larger than the application icons.

The notification 542 in FIG. 5F includes an indication of who is requesting access (e.g., displaying “Dani” corresponding to the user 502). The notification 542 also includes a selectable accept element 544 and a selectable deny element 546. In some embodiments, activation of the deny element 546 (e.g., in response to detecting a user input at a location corresponding to the deny element 546) causes the request to establish an audio path to be rejected. In some embodiments, activation of the deny element 546 causes the representation 538 to cease to be displayed on the phone 100-1. FIG. 5F further shows user input 550 (e.g., a tap input, a long press input, or other type of input) detected at a location corresponding to the selectable accept element 544.

FIG. 5G illustrates a transition from FIG. 5F in response to the detection of user input 550. In FIG. 5G, an audio path has been established between the phone 100-3 and the phone 100-1, as indicated by dashed line 554. The user interface 503 in FIG. 5G shows the representation 538 with a solid border (as opposed to the dashed border shown in FIG. 5E) to indicate that the corresponding audio source from phone 100-3 is available as an audio source. FIG. 5G also shows a dashed line 558 around the representation 538 to indicate that it is an active audio source (e.g., currently outputting audio content at the wearable audio output device 301). In the example of FIG. 5G, the representation 510 also has a dashed line 516 indicating that it is also an active audio source. FIG. 5G further shows a notification 556 displayed at the phone 100-1 indicating that the audio path has been established, and a similar notification 552 displayed at the phone 100-3 indicating the same.

FIG. 5H illustrates the wearable audio output device 301 outputting audio content 560 corresponding to the audio stream, “Ann's Stream,” from the phone 100-3 and the audio stream, “Jon's Phone,” from the phone 100-2 (shown in FIG. 5C). In the example of FIG. 5H, the audio content from the phone 100-2 is the song, denoted as “Song F,” as indicated by interface element 518, and the audio content from the phone 100-3 is a live podcast, as indicated by interface element 568. The interface element 518 includes a volume element 564 indicating an output volume of the song from the phone 100-2. The interface element 568 includes a volume element 570 indicating an output volume of the podcast from the phone 100-3. In the example of FIG. 5H, the volume element 570 indicates that the podcast from the phone 100-3 is outputting at a higher volume than the song from the phone 100-2. As described above with respect to the volume element 519, in some embodiments, each of the volume elements 564 and 570 is a selectable icon.

FIGS. 6A-6G illustrate example user interfaces and user interactions for adjusting audio properties from audio sources in accordance with some embodiments. In FIG. 6A, the phone 100-1 displays the user interface 503 (e.g., an audio user interface) with the region 504 corresponding to wearable audio output device 301. The user interface 503 in FIG. 6A also includes an audio source representation 602 corresponding to a public alerts audio source (e.g., a public audio source as indicated by the solid background), an audio source representation 604 corresponding to a public radio audio source (e.g., another public audio source as indicated by the solid background), an audio source representation 606 corresponding to a private camera audio source (e.g., a private audio source as indicated by the dotted background), and the representation 538 corresponding to the podcast stream, “Ann's Stream,” from the phone 100-3 (e.g., another private audio source as indicated by the dotted background). The representations 602 and 606 include respective icons 607-1 and 607-2 indicating that the corresponding audio content is conditionally output (e.g., as described previously with respect to the icon 517). In the example of FIG. 6A, the representation 538 has a dashed line 608 around it indicating that it is an active audio source (e.g., audio content corresponding to the audio source is currently being output at the wearable audio output devices 301). FIG. 6A further shows a system volume indicator 613 indicating an output volume level for the phone 100-1, a volume indicator 614 indicating that the podcast stream from the phone 100-3 has a corresponding output volume level 614-a (e.g., output at the wearable audio output devices 301), and a volume indicator 616 indicating that the public radio stream has a corresponding output volume level 616-a. Thus, FIG. 6A illustrates an example in which different audio sources have different (e.g., independent) output volume levels (e.g., that can be adjusted by a user of the phone 100-1). FIG. 6A also shows a user input 612 (e.g., a tap input, a double tap input, or other type of input) detected at a location corresponding to the representation 604.

FIG. 6B illustrates a transition from FIG. 6A in response to detection of the user input 612. In FIG. 6B, the representation 604 has a dashed line 615 around it, indicating that the corresponding audio source is an active audio source (e.g., due to the user selection of the representation 604). The representation 538 in FIG. 6B no longer has the dashed line 608 (e.g., shown in FIG. 6A) around it, indicating that the phone 100-3 is not an active audio source. In some embodiments, selection of a first audio source representation causes the corresponding audio source to become active and other audio sources to become inactive. In some embodiments, selection of the first audio source representation adds the corresponding audio source to the set of active audio sources (e.g., without deactivating other audio sources). In some embodiments, a first type of selection (e.g., corresponding to a tap input, a double tap input, or other type of input) cause the corresponding audio source to become the only active audio source and a second type of selection (e.g., corresponding to a double tap input, a long press input, or other type of input different from the first type of selection input) causes the corresponding audio source to be added to the set of active audio sources. In the example of FIG. 6B, audio content corresponding to the public radio audio source is output with the output volume level 616-a.

FIG. 6C shows user inputs 620-1 and 620-2 detected at the phone 100-1 while the public radio stream is an active audio source. In some embodiments, the user inputs 620 (e.g., 620-1 and 620-2) correspond to a same gesture (e.g., a pinch in gesture). In some embodiments, the user inputs 620 are detected at a location corresponding to the representation 604. In some embodiments, the user inputs 620 correspond to a location-independent gesture (e.g., a gesture that corresponds to the same operation regardless of where it is detected on a touch-sensitive surface of the phone 100-1).

FIG. 6D illustrates a transition from FIG. 6C in response to detection of the user inputs 620. FIG. 6D shows the output volume corresponding to the public radio audio source decreasing from volume level 616-a (in FIG. 6C) to volume level 616-b in response to detection of the user inputs 620. In some embodiments, a pinch in gesture is mapped to a volume reduction operation and a pinch out gesture is mapped to a volume increasing operation. The volume indicator 614 for the phone 100-3 audio source in FIG. 6D indicates a corresponding output volume level 616-a, illustrating that the volume level for the phone 100-3 audio source is unchanged (e.g., due to the phone 100-3 audio source being inactive when the user inputs 620 were detected). FIG. 6E further shows a user input 628 (e.g., a tap input, a long press input, or other type of input) detected at a location corresponding to the representation 538.

FIG. 6E illustrates a transition from FIG. 6D in response to detection of the user input 628. FIG. 6E shows dashed-dotted line 632 around the representations 604 and 538, indicating selection of those representations in response to the user input 628. In some embodiments, the selection of the representations 604 and 538 does not affect which audio sources are active (e.g., the selection in FIG. 6E is different type of selection than a selection illustrated in FIGS. 6A-6B). In some embodiments, a first type of selection (e.g., corresponding to a tap input, a double tap input, or other type of input) cause the corresponding audio source to become an active audio source and a second type of selection (e.g., corresponding to a double tap input, a long press input, or other type of input) causes the corresponding audio source to be selected for a subsequent manipulation of one or more properties.

FIG. 6F shows user inputs 634-1 and 634-2 detected at the phone 100-1 while the public radio stream is an active audio source and the representations 604 and 538 are selected. In some embodiments, the user inputs 634 (e.g., 634-1 and 634-2) correspond to a same gesture (e.g., a pinch out gesture). In some embodiments, the user inputs 634 are detected at a location corresponding to the selected representations (e.g., within the dashed-dotted line 632). In some embodiments, the user inputs 634 correspond to a location-independent gesture (e.g., a gesture that corresponds to the same operation regardless of where it is detected on a touch-sensitive surface of the phone 100-1).

FIG. 6G illustrates a transition from FIG. 6F in response to detection of the user inputs 634. FIG. 6G shows the output volume corresponding to the public radio audio source increase from volume level 616-b (in FIG. 6F) to volume level 616-c, and the output volume corresponding to the phone 100-3 audio source increase from volume level 614-a (in FIG. 6F) to volume level 614-b in response to detection of the user inputs 634. In some embodiments, a pinch out gesture is mapped to a volume increasing operation and a pinch in gesture is mapped to a volume decreasing operation. The volume indicator 613 for the system volume of the phone 100-1 in FIG. 6G indicates a corresponding output volume level 613, illustrating that the system volume level for the phone 100-1 is unchanged (e.g., the user inputs 634 only affect the volume level of audio content for selected audio sources).

FIGS. 7A-71 illustrate example user interfaces and user interactions for outputting audio from different audio sources in accordance with some embodiments. FIG. 7A shows a user 502 wearing wearable audio output device 301 while beyond a threshold distance 710 of an audio source 712 (e.g., a broadcast audio source) corresponding to a display 714. In some embodiments, the threshold distance 710 corresponds to a geofence boundary assigned to the audio source 712. In some embodiments, the threshold distance 710 corresponds to a sensor detection range for the audio source 712 (e.g., a proximity sensor range, a wireless communication range, or other type of sensor range). In some embodiments, the threshold distance 710 corresponds to a visual range for the display 714 (e.g., a range corresponding to being able to read text at the display 714 in accordance with having 20/20 eyesight). As an example, the display 714 may be a display screen, an art piece (e.g., a painting, a scene, and/or a sculpture), a bulletin board, or other type of display. In some embodiments, the audio source 712 provide audio information about the display 714 (e.g., facts, details, historical information, and/or other types of audio information).

The phone 100-1 (e.g., a user device of the user 502) in FIG. 7A is displaying the user interface 503 that includes the region 504 corresponding to the wearable audio output devices 301, the region 504 being denoted by line 701 and the label “Dani's Earbuds.” The user interface 503 in FIG. 7A includes a representation 702 corresponding to a private audio source from a phone, a representation 704 corresponding to a public radio audio source, a representation 706 corresponding to an emergency alerts audio source, and a representation 708 corresponding to a private camera audio source. In FIG. 7A, the representation 704 has a dashed line around it, indicating that it is an active audio source.

FIG. 7B shows the user 502 within the threshold distance 710 of the audio source 712 (e.g., in accordance with the user 502 walking closer to the audio source 712). The user interface 503 in FIG. 7B shows a representation 716 corresponding to the audio source 712. The representation 716 in FIG. 7B is positioned at location 716-a outside of the region 504, indicating that the audio source 712 is available, but an audio path is not active (e.g., has not been established) between the audio source 712 and the phone 100-1 (e.g., additional action is required to output audio content the audio source 712). FIG. 7B further shows a user input 717 (e.g., a tap and drag input, a swipe input, or other type of input) detected at a location corresponding to the representation 716.

FIG. 7C illustrates a transition from FIG. 7B in response to detecting the input 717. In FIG. 7C, the representation 716 has moved on the user interface 503 from location 716-a (in FIG. 7B) to location 716-b in accordance with the input 717. The location 716-b is outside of the region 504 and therefore the audio source 712 remains an available audio source without an active audio path. FIGS. 7B and 7C illustrate an example in which movement of an audio source representation does not affect audio content being output by the wearable audio output devices 301.

FIG. 7D shows the user 502 within the threshold distance 710 of the audio source 712 and the user interface 503 including the representation 716 corresponding to the audio source 712 at a location 716-c outside of the region 504. FIG. 7D further shows the line 701 at a location 701-a indicating a boundary of the region 504 in the user interface 503. FIG. 7D also shows user input 720 (e.g., a tap and drag input, a swipe input, or other type of input) detected at a location corresponding to the line 701.

FIG. 7E illustrates a transition from FIG. 7C in response to detecting the input 720. In FIG. 7E the line 701 has moved from the position 701-a (in FIG. 7D) to a position 701-b in accordance with the input 720. With the line 701 in position 701-b the representation 716 for the audio source 712 is within the region 504. In accordance with some embodiments, the representation 716 being within the region 504 causes an audio path between the audio source 712 and the phone 100-1 (and/or the wearable audio output devices 301) to become active (e.g., causes the audio path to be established and audio content to be transmitted from the audio source 712 to the wearable audio output devices 301 via the audio path). In accordance with some embodiments, in response to the representation 716 entering the region 504, the audio source 712 becomes an active audio source. FIG. 7E further shows the public radio audio source corresponding to the representation 704 becoming inactive in accordance with the audio source 712 becoming active. In some embodiments, the public radio audio source corresponding to the representation 704 remains active when the audio source 712 becomes active such that audio content from the public radio audio source continues to be output at the wearable audio output device 301 (e.g., with reduced volume).

FIG. 7E shows audio content 723 being output (e.g., via the wearable audio output devices 301) in a spatialized manner such that it appears to be output at a location corresponding to the audio source 712. In some embodiments, audio content from the audio source 712 is spatialized based on a relative location of the audio source 712 and the wearable audio output devices 301. In some embodiments, audio content from the audio source 712 is spatialized based on a relative location of the display 714 and the wearable audio output devices 301. In some embodiments, audio content from the audio source 712 is spatialized based on a position and/or orientation of the user 502 as compared to a position and/or orientation of the audio source 712.

FIG. 7F shows the user 502 outside of the threshold distance 710 of the audio source 712 (e.g., in accordance with the user 502 walking away from the audio source 712). In accordance with the user 502 moving beyond the threshold distance 710, the user interface 503 in FIG. 7F shows the representation 716 corresponding to the audio source 712 ceasing to be displayed. In some embodiments, the audio path between the audio source 712 and the phone 100-1 (and/or the wearable audio output devices 301) is broken (e.g., disconnected, deactivated, or canceled) in accordance with the user 502 moving beyond the threshold distance 710. In some embodiments, the representation 716 ceasing to be displayed indicates that the audio source 712 is no longer communicatively coupled to the phone 100-1. In accordance with some embodiments, public radio audio source is active, as indicated by the dashed line 724 around the representation 704 in FIG. 7F, in accordance with the audio source 712 no longer being active. For example, the phone 100-1 determines that the public radio audio source was the last audio source to be active, prior to audio source 712 becoming active, and therefore reactivates it when the audio source 712 is no longer active. In some embodiments, no audio source is automatically activated in accordance with the audio source 712 being disconnected. For example, the user 502 needs to select an audio source to become active rather than an audio source becoming active automatically.

FIG. 7G shows the user 502 within the threshold distance 710 of the audio source 712 (e.g., in accordance with the user 502 walking back toward the audio source 712). The user interface 503 in FIG. 7G shows the representation 716 corresponding to the audio source 712 positioned within the region 504. The representation 716 has the dashed line 722 around it indicating that it is an active audio source in FIG. 7G and audio content 729 is output to the user 502. In some embodiments, the audio source 712 is automatically (e.g., without further user inputs) set as an active audio source in response to the user 502 moving within the threshold distance 710. For example, the audio source 712 is automatically set as an active audio source in FIG. 7G in accordance with a determination that the audio source 712 was previously set as an active audio source (e.g., as illustrated in FIGS. 7D-7E). In some embodiments, an audio source is automatically set as active in accordance with a determination that the audio source was active when the user was previously in proximity with the audio source (e.g., within the threshold distance 710).

FIG. 7H illustrates an alert 730 being received by the phone 100-1 while the user is within the threshold distance 710 and the audio source 712 is active. The alert 730 in FIG. 7H is a portion of audio content from the emergency alerts audio source corresponding to the representation 706. For example, the alert 730 may be an alert that is determined to be relevant to the user 502 (e.g., meets one or more filtering criteria set by the user 502). In some embodiments, audio content from the emergency alerts audio source is monitored by a digital assistant, content monitoring software, or another type of component to conditionally output audio content from the emergency alerts audio source. FIG. 7H further shows an active noise cancellation (ANC) mode being active with a cancelation level 736-a and a media volume indicator 738 with a volume level 738-a. In accordance with some embodiments, the volume indicator 738 indicates a volume level for audio content corresponding to all audio sources (e.g., a single volume level is used for all the audio sources). In some embodiments, the ANC mode is activated in response to a user input (e.g., detected at the phone 100-1 and/or the wearable audio output devices 301).

FIG. 7I illustrates a transition from FIG. 7H (e.g., in response to the phone 100-1 receiving the alert 730 and/or the alert 730 being determined to meet one or more filtering criteria set for the emergency alerts audio source). In FIG. 7I, the representation 706 has a dashed line around it to indicate that it is an active audio source and audio content 740 is output (e.g., via a speaker component of the phone 100-1 and/or via the wearable audio output devices 301). The audio content 740 in FIG. 7I corresponds to the alert 730 received in FIG. 7H. In some embodiments, the audio content 740 is the same as the alert 730 (e.g., the alert 730 is output to the user 502 as the audio content 740). In some embodiments, the audio content 740 generated based on the alert 730 (e.g., is a summarization, a translation, a personalization, and/or other type of modification of the alert 730). In accordance with some embodiments, the ANC mode cancelation level is reduced from the cancelation level 736-a (FIG. 7H) to a cancelation level 736-b. For example, the cancelation level may be reduced in accordance with a determination that the alert 730 indicates that ambient sound may be important to the user 502. As an example, for an alert that corresponds to an evacuation of an area in which the user is present, the alert may indicate that physical speakers in the area are providing detailed evacuation instructions and therefore the phone 100-1 reduces the ANC mode cancelation level so that the user may better hear the evacuation instructions. In accordance with some embodiments, the media volume is reduced from the volume level 738-a (in FIG. 7H) to a volume level 738-b. In some embodiments, media output volume is decreased in accordance with a determination that ambient sound may be important to the user 502 (e.g., media content is docked or reduced so that the user may better hear environmental audio related to the alert 730). In accordance with some embodiments, the audio content 740 is output at a volume level indicated by indicator 742 (e.g., a separate volume level from the media volume level 738-b). For example, the audio content 740 is output at a volume level used for alerts and other audio content the user 502 has indicated are high priority (e.g., the alert volume is assigned to audio content that is denoted as high priority by the user 502, the phone 100-1, and/or another entity).

FIGS. 8A-8K illustrate example user interfaces and user interactions for outputting and adjusting audio from audio sources in accordance with some embodiments. FIG. 8A shows a user 802 wearing wearable audio output devices (e.g., including a wearable audio output device 301-1) and holding a device 100 denoted as “Ian's Phone.” The wearable audio output devices 301 in FIG. 8A are outputting audio content 809 corresponding to a radio audio source, as indicated by a representation 814 with a dashed line around it on user interface 810 (e.g., an instance of the user interface 503). The device 100 displays the user interface 810 with the region 811 corresponding to wearable audio output devices 301, denoted as “Ian's Earbuds,” and having a corresponding boundary line 812. In accordance with some embodiments, the audio content 809 is output in a spatialized manner as discussed above with respect to the audio content 723.

FIG. 8A further shows the user 802 holding the device 100 up to an audio source 806 that includes a computer-readable code 808 (e.g., a quick-response (QR) code, a serial code, an App Clip code, or other type of computer-readable code). The audio source 806 corresponds to the display 804 (e.g., an instance of the display 714). In some embodiments, scanning the computer-readable code 808 enables communication between the audio source 806 and the device 100 (and/or the wearable audio output devices 301). For example, the computer-readable code 808 provides a set of instructions for establishing a wireless connection with the audio source 806.

FIG. 8B illustrates a transition from FIG. 8A (e.g., in response to scanning the computer-readable code 808, in response an audio path forming that was initiated by scanning the computer-readable code 808, or in response to a user confirmation input after scanning the computer-readable code 808). In FIG. 8B the wearable audio output devices 301 are outputting audio content 817 from the audio source 806. In accordance with some embodiments, the wearable audio output devices 301 cease to output content from the radio audio source in accordance with outputting the audio content 817 from the audio source 806. FIG. 8B illustrates audio content 809 corresponding to the radio audio source indicated by the representation 814, which, in some embodiments, continues to be output concurrently with the audio content 817. FIG. 8B shows a representation 816 for the audio source 806 with a dashed line around it to indicate that it is an active audio source. In some embodiments, the size of the region 811 changes based on the number of audio source representations included in the region 811. For example, FIGS. 8A and 8B illustrate the region 811 increasing in size in accordance with the display of the representation 816 in the region. Optionally, the audio content 817 is output in a spatialized manner (e.g., to simulate audio coming from the display 804) as discussed above with respect to the audio content 723. In accordance with some embodiments, the audio content 817 is spatialized based on a position of the representation 816 in the region 811. For example, the representation 816 is on a right side of the region 811 in FIG. 8B and the audio content 817 is spatialized to a right side of the user 802.

FIG. 8C illustrates a transition from FIG. 8B (e.g., due to the user 802 moving around the display 804). In the example of FIG. 8C, the user 802 is on the right side of the display 804 (as opposed to the left side in the example of FIG. 8B). FIG. 8C shows audio content 818 corresponding to the audio source 806 being output in a spatialized manner so as to seem to originate from a simulated audio source on the right side of the user 802. FIG. 8C further shows a user input 819 (e.g., a tap and drag input, a swipe input, or other type of input) detected at a location corresponding to the representation 816.

FIG. 8D illustrates a transition from FIG. 8C in response to detection of the user input 819. In FIG. 8D, the representation 816 has moved from a position 816-a (in FIG. 8C) to a position 816-b in accordance with the user input 819 (e.g., in accordance with a direction of movement of the user input 819). FIG. 8D further shows audio content 820 corresponding to the audio source 806 being output in a spatialized manner so as to seem to originate from a simulated audio source on the left side of the user 802 due to the change in location of the representation 816. Thus, FIGS. 8B-8D illustrate an example in which audio is spatialized based on a location of the corresponding representation 816 of the audio source 806 in the user interface 810 (e.g., as opposed to being spatialized based on a relative positioning of the user 802 and the display 804).

FIG. 8E illustrates the device 100 displaying the user interface 810 that includes the region 811 corresponding to the wearable audio output devices 301, the representation 814 for the public radio audio source, and the representation 816 for the audio source 806 (FIG. 8A). In the example of FIG. 8E, the representation 814 is displayed at a location 814-a and has a corresponding output volume level 826-a as indicated by volume indicator 826, whereas the representation 816 has a corresponding output volume level 828-a indicated by volume indicator 828. FIG. 8E further shows a user input 829 (e.g., a tap and drag input, a swipe input, or other type of input) detected at a location corresponding to the representation 814.

FIG. 8F illustrates a transition from FIG. 8E in response to detection of the user input 829. In FIG. 8F, the representation 814 has moved from the location 814-a (in FIG. 8E) to a location 814-b in accordance with user input 829 (e.g., based on movement of user input 829). FIG. 8F further shows an output volume level 826-b corresponding to the position of the representation 814. In the example of FIGS. 8E-8F, the output volume level for the public radio audio source is based on positioning of the representation 814. For example, as the representation 814 moves closer to the bottom of the region 811, the output volume increases, and as the representation 814 move further from the bottom of the region 811, the output volume decreases.

FIG. 8G shows the user 802 wearing wearable audio output devices (e.g., including a wearable audio output device 301-1) and holding the device 100 denoted as “Ian's Phone.” The device 100 displays the user interface 810 with the region 811 corresponding to wearable audio output devices 301, denoted as “Ian's Earbuds,” and having a corresponding boundary line 812. The device 100 further displays a representation 839 corresponding to a private audio source. FIG. 8G further shows the user 802 holding the device 100 up to the display 804. In accordance with some embodiments, the display 804 transmits a short-range wireless signal 837 (e.g., a near-field communication (NFC) signal, a radio frequency identification signal, or other type of wireless signal). The device 100 in FIG. 8G detects the wireless signal 837 and, in response, displays a notification 830 (e.g., a confirmation notification). In some embodiments, the device 100 detects the wireless signal 837 in accordance with a short-range communication mode of the device 100 being active. In some embodiments, the wireless signal 837 is configured to initiate communication between the display 804 (e.g., an audio source) and the device 100 (and/or the wearable audio output devices 301). For example, the wireless signal 837 provides a set of instructions for establishing a wireless connection (e.g., forming an audio path) with the display 804.

The notification 830 includes an indication of the audio source of display 804, a selectable accept element 832, and a selectable deny element 834. In some embodiments, activation of the deny element 834 (e.g., in response to detecting a user input at a location corresponding to the deny element 834) causes the request to establish an audio path to be rejected. In some embodiments, activation of the deny element 834 causes the notification 830 to cease to be displayed on the phone device 100. FIG. 8G further shows user input 840 (e.g., a tap input, a long press input, or other type of input) detected at a location corresponding to the selectable accept element 832.

FIG. 8H illustrates a transition from FIG. 8G in response to detection of the user input 840. In FIG. 8H, an audio path has been established between the phone device 100 and the display 804, as indicated by a representation 816 in the region 811. The user interface 810 in FIG. 8H shows the representation 816 with a dashed line around it to indicate that it is an active audio source (e.g., currently outputting audio content at the wearable audio output device 301). In some embodiments, the display 804 is automatically (e.g., without further user input) set as an active audio source in response to the user input 840. In some embodiments, the display 804 is added as an inactive audio source in response to the user input 840 (e.g., the user 802 may subsequently set the display 804 as an active audio source after it has been added). FIG. 8H further shows user input 850 (e.g., a tap input, a long press input, or other type of input) detected at a location corresponding to the representation 816.

FIG. 8I illustrates a transition from FIG. 8H in response to detection of the user input 850. In FIG. 8I, a menu 852 is displayed in response to the user input 850 (e.g., a first type of input). The menu 852 includes a set of selectable options for processing audio from an audio source (e.g., the display 804). In accordance with some embodiments, the set of selectable options includes a content-based monitoring element 854, a translation element 856, an accessibility element 858, a filter speech element 860, a filter music element 862, and a filter background element 864. In some embodiments, the content-based monitoring element 854, when activated, enables a user to set up content-based filtering, editing, and/or other modification. For example, the content-based monitoring optionally allows a user to initiate filtering for audio content from an audio source that is determined to be relevant to the user. As another example, the content-based monitoring optionally allows a user to initiate summarization of audio content. In some embodiments, the translation element 856, when activated, enables a user to initiate translation of audio content from an audio source (e.g., translating from one language to another, from one dialect to another, and/or other form of translation). In some embodiments, the accessibility element 858, when activated, enables a user to initiate accessibility modifications for the audio content. For example, the accessibility element 858 optionally allows a user to pitch shift the audio content (e.g., to a range that is easier for the user to hear), slow the audio content, and/or otherwise modify the audio content. In some embodiments, the filter speech element 860, when activated, enables a user to initiate speech filtering for the audio content (e.g., filtering out speech frequencies from the audio content). For example, the filter speech element 860 optionally allows a user to remove commentary and/or other speech from audio content composed of nature sounds. In some embodiments, the filter music element 862, when activated, enables a user to initiate music filtering for the audio content (e.g., filtering out background music from spoken audio content). In some embodiments, the filter background element 864, when activated, enables a user to initiate filtering background sounds from the audio content (e.g., filtering out background speech, background music, and/or other background noises from audio content). In some embodiments, two or more of the selectable options for processing audio from the audio source are activated concurrently. For example, for an audio source, the audio content is optionally translated and has background noises filtered out.

FIG. 8J illustrates the user interface 810 including the representation 839 and the representation 816 in the region 811 corresponding to the wearable audio output devices 301. The representation 816 is displayed with a dashed line around it to indicate that it is an active audio source (e.g., currently outputting audio content at the wearable audio output device 301). FIG. 8J further shows user input 870 (e.g., a deep press input, a long press input, or other type of input) detected at a location corresponding to the representation 816. In some embodiments, the user input 850 (in FIG. 8H) is a first type of input and the user input 870 is a second type of input, different than the first type.

FIG. 8K illustrates a transition from FIG. 8J in response to detection of the user input 870. In FIG. 8K, a menu 872 is displayed in response to the user input 870. The menu 872 includes a selective prioritization element 874 and a selectable block element 876. In some embodiments, the selective prioritization element 874, when activated, enables a user to set a priority for the audio source (e.g., the display 804). For example, the user 802 may set the audio source as a high priority source, a standard priority source, or a low priority source. In some embodiments, a high priority source outputs audio content at a higher volume than lower priority sources (e.g., the respective volumes of lower priority sources are docked while the high priority source outputs audio content). In some embodiments, while a high priority source outputs audio content, audio content from lower priority sources is muted. For example, a high priority source may be content-monitored so that only relevant audio events are output to the user, and such audio events, when output, cause other audio content from lower priority sources to be muted (e.g., so that the user may better hear the audio events). In some embodiments, the selective prioritization element 874, when activated, enables a user to block an audio source. In some embodiments, blocking an audio source includes breaking an audio path between the phone device 100 and the audio source. In some embodiments, blocking an audio source includes adding the audio source to a deny list (e.g., a set of devices restricted from communicatively coupling with the phone device 100). In some embodiments, the deny list is associated with a user account of the user (e.g., to restrict the audio source from all user devices of the user).

FIGS. 9A-9E illustrate example user interfaces and user interactions for outputting audio from audio sources at various audio output devices in accordance with some embodiments. In FIG. 9A, the device 100 displays a user interface 901 (e.g., an audio user interface) with a region 902 corresponding to a set of wearable audio output devices 301, denoted as “Dani's Earbuds” and bounded with boundary line 914. The user interface 901 in FIG. 9A also includes a region 904 corresponding to a video conference session, denoted as “Video Conference Shared Audio” and bounded with a boundary line 912. The user interface 901 further includes a representation 906, corresponding to a private audio source, in the region 902, and a representation 910, corresponding to a public radio audio source, in the region 904. In accordance with some embodiments, the representation 910 in the region 904 indicates that other participants in the video conference are listening to the public radio audio source (e.g., the public radio audio source is an active audio source for other participants in the video conference). In some embodiments, the public radio audio source not being within the region 902 in FIG. 9A indicates that it is an inactive audio source for the device 100. In some embodiments, the public radio audio source not being within the region 902 in FIG. 9A indicates that an audio path has not been formed between the device 100 and the public radio audio source. FIG. 9A further shows a user input 916 (e.g., a tap and drag input, a swipe input, or other type of input) detected at a location corresponding to the representation 910.

FIG. 9B illustrates a transition from FIG. 9A in response to detection of the user input 916. In FIG. 9B, the representation 910 has moved from a position 910-a (in FIG. 9A) to a position 910-b that is within the region 902 and the region 904 in accordance with the input 916. The representation 910 being within the region 902 and the region 904 indicates that the public radio audio source is active for the device 100 and for participants of the video conference. FIG. 9B further shows a user input 918 (e.g., a tap and drag input, a swipe input, or other type of input) detected at a location corresponding to the representation 906.

FIG. 9C illustrates a transition from FIG. 9B in response to detection of the user input 918. In FIG. 9C, the representation 906 has moved from a position 906-a (in FIG. 9B) to a position 906-b that is outside of the region 904 in accordance with the input 918. The representation 906 being outside of the region 902 indicates that the corresponding private audio source is inactive for the device 100 and for the participants of the video conference. FIG. 9C further shows a user input 920 (e.g., a tap and drag input, a swipe input, or other type of input) detected at a location corresponding to the representation 910.

FIG. 9D illustrates a transition from FIG. 9C in response to detection of the user input 920. In FIG. 9D, the representation 910 has moved from the position 910-b (in FIG. 9C) to the position 910-a that is outside of the region 902 in accordance with the input 920. The representation 910 in the region 904 indicates that other participants in the video conference are listening to the public radio audio source, and the public radio audio source not being within the region 902 indicates that it is an inactive audio source for the device 100. FIGS. 9C and 9D illustrate an example in which the user input 920 moves toward a portion of the user interface 901 that is outside of the regions 902 and 904. In this example, the representation 910 is not removed from the region 904 in accordance with the user input 920 (e.g., the device 100 is not authorized to deactivate the public radio audio source for the participants of the video conference).

FIG. 9E illustrates an alternative transition from FIG. 9C in response to detection of the user input 920. In FIG. 9E, the representation 910 has moved from the position 910-b (in FIG. 9C) to a position 910-c that is outside of the regions 902 and 904 in accordance with the input 920. The representation 910 being outside of the regions 902 and 904 indicates that the public radio audio source an inactive audio source for the device 100 and for the participants of the video conference. FIGS. 9C and 9E illustrate an example in which the user input 920 moves toward a portion of the user interface 901 that is outside of the regions 902 and 904. In this example, the representation 910 is removed from the region 904 in accordance with the user input 920 (e.g., the device 100 is authorized to deactivate the public radio audio source for the participants of the video conference).

FIGS. 10A-10C illustrate example user interfaces and user interactions for displaying audio interfaces in accordance with some embodiments.

FIG. 10A shows a home screen user interface 1002 (also referred to interchangeably as a “home screen”) of the portable multifunction device 100. FIG. 10A further shows an input 1004 (e.g., a swipe down gesture) detected at the portable multifunction device 100. In some embodiments, an input 1004 is received at the home screen user interface 1002 and corresponds to an operation to display a control center user interface (discussed below with respect to FIG. 10B). In some embodiments, the home screen 1002 includes one or more application icons for launching one or more respective applications. In some embodiments, the home screen 1002 is accessible while the device is in an authenticated state.

FIG. 10B illustrates a transition from FIG. 10A in response to detection of the input 1004 and shows the control center user interface 1006. In some embodiments, the control center user interface 1006 (also referred to interchangeably as a “control center”) includes a media control 1007 (e.g., a user interface element corresponding to a media application) that controls media playback and a volume control 1008 that controls output volumes for the device 100 and/or audio output devices communicatively coupled to the device 100. In FIG. 10B, an input 1010 is detected at a location corresponding to the volume control 1008.

FIG. 10C illustrates a transition from FIG. 10B in response to detection of the input 1010. In FIG. 10C, the device 100 displays the user interface 1014 (e.g., an audio user interface analogous to the user interface 503, FIG. 5A) with a region 1015 with a boundary line 1017 corresponding to a set of wearable audio output devices 301. The user interface 1014 in FIG. 10C also includes an audio source representation 1016 corresponding to a private phone audio source and an audio source representation 1018 corresponding to a private camera audio source. Thus, FIGS. 10A-10C illustrate an example of how a user may display an audio user interface. In some embodiments, other means are provided for displaying the audio user interface (e.g., in response to activation of an audio output device, in response to detection of an audio source, in response to receiving audio content from an audio source, and/or other means of causing display of the audio user interface).

FIGS. 11A-11F are flow diagrams illustrating a method 1100 for outputting audio from audio sources in accordance with some embodiments. Method 1100 is performed at an audio output device (e.g., the device 100, the device 300, the wearable audio output devices 301, or another type of audio output device) with one or more audio output components and optionally a display. For example, the method 1100 is performed at a set of earbuds, a headset, or headphones. In some embodiments, the display is a touch-screen display. In some embodiments, the audio output device includes a touch-sensitive surface (e.g., distinct from any display component). Some operations in method 1100 are, optionally, combined and/or the order of some operations is, optionally, changed.

As described below, method 1100 provides audio outputs in an intuitive and efficient manner by outputting audio content in response to detecting an occurrence of an event involving a proximate audio source. For example, audio content from a proximate audio source is automatically output by an audio output device in response to the event involving the proximate audio source (e.g., without requiring further user input). In this way, the audio output device is better suited to provide relevant audio content, without requiring additional input from the user. Providing an adaptive and more intuitive user experience while reducing the number of inputs needed to achieve such an experience enhances the operability of the device and makes the user-device interface more efficient (e.g., by helping the user to achieve an intended outcome and reducing user mistakes when operating/interacting with the device), which, additionally, reduces power usage and improves battery life of the device by enabling the user to use the device more quickly and efficiently.

In some embodiments, the audio output device is communicatively coupled to a first set of broadcast devices broadcasting a first set of one or more audio streams (e.g., while outputting first audio content). In some embodiments, the audio output device is communicatively coupled to a second set of broadcast devices broadcasting a second set of one or more audio streams (e.g., while outputting second audio content). Communicatively coupling the audio output device to a set of broadcast devices reduces the number of inputs needed to obtain audio content from the audio streams (e.g., allows audio output to be adjusted automatically).

In some embodiments, communicatively coupling a first device and a second device comprises establishing a wired or wireless connection between the first device and the second device. In some embodiments, the first device and the second device are communicatively coupled via a direct connection, while in other embodiments, the first device and the second device are communicatively coupled via one or more communication networks (e.g., a public broadcast network). For example, communicatively coupling the first and second devices may include forming a wireless peer-to-peer connection (e.g., a direct Wi-Fi connection). In some embodiments, communicatively coupling the first device and the second device comprises pairing the first device and the second device (e.g., exchanging information between the first device and the second device that enable the first device and the second device to communicate with each other). In some embodiments, communicatively coupling the first device and the second device comprises forming an audio path between the first device and the second device. In some embodiments, communicatively coupling the first device and the second device comprises establishing one or more wireless connections and/or one or more wired connections between the first device and the second device. In some embodiments, the first and second devices are communicatively coupled using one or more communication protocols (e.g., a Wi-Fi protocol, a Bluetooth protocol, and/or other type of communication protocol). In some embodiments, the first and second devices are communicatively coupled using respective radio components (e.g., RF circuitry 108, FIG. 1A).

In some embodiments, while outputting audio content from an audio stream of a first set of one or more audio streams (1102): the audio output device outputs second audio content in accordance with the second audio content from a second audio stream of the first set of one or more audio streams meeting one or more criteria; and the audio output device forgoes outputting the second audio content in accordance with the second audio content from the second audio stream of the first set of one or more audio streams not meeting the one or more criteria. For example, FIGS. 7H-71 illustrate the phone 100-1 outputting the audio content 740 that is determined to be relevant to the user (e.g., and not outputting content from the emergency alerts audio source (e.g., corresponding to representation 706, FIGS. 7H-71) that is determined not to be relevant to the user). In some embodiments, the second audio content is output automatically (e.g., without further user input) in accordance with a determination that the second audio content meets the one or more criteria. In some embodiments, outputting the second audio content comprises ceasing to output the audio content from a first audio stream. In some embodiments, outputting the second audio content comprises concurrently outputting the audio content from the audio stream and the second audio content. Selectively providing audio content based on one or more criteria enables audio content switching automatically when the one or more criteria have been met without requiring further user input. Additionally, requiring a user to manually switch between broadcast streams may cause the user to miss hearing a portion of the audio content due to the time needed to manually switch.

In some embodiments, the one or more criteria comprise a volume level criterion. For example, the second audio content is output in accordance with a determination that a volume level of the second audio content exceeds a volume threshold. In some embodiments, the second audio content ceases to be output in accordance with a determination that the second audio content has ceased to meet the one or more criteria. For example, the second audio content is only output while the second audio content meets the one or more criteria. In some embodiments, while outputting fourth audio content from a fourth audio stream of the second set of one or more audio streams: in accordance with a determination that fifth audio content from a fifth audio stream of the second set of one or more audio streams meets one or more second criteria, the audio output device outputs the fifth audio content; and, in accordance with a determination that fifth audio content from the fifth audio stream of the second set of one or more audio streams does not meet the one or more second criteria, the audio output device forgoes outputting the fifth audio content.

In some embodiments, the one or more criteria include (1104) content type criteria. For example, certain types of sounds (e.g., a baby cry, a siren, and/or an alarm) may met the content type criteria. For example, the private camera audio source corresponding to the representation 606 in FIG. 6A is conditionally output as indicated by icon 607-2. The conditional output is optionally based on a content type criterion (e.g., baby sounds in general or baby sounds indicating that the baby is unhappy, scared, or in trouble). In some embodiments, a user of the audio output device identifies one or more content types to be included in the content type criteria. For example, a first user may select baby crying as part of the content type criteria, but may exclude a police siren from the content type criteria. In this example, a second user may include the police siren in the content type criteria. In some embodiments, each audio stream in the first set of one or more audio streams is analyzed (e.g., by a digital assistant) to monitor for particular types of content (e.g., to assess whether the audio stream meets the content type criteria). Selectively providing audio content based on content type criteria enables audio content switching automatically (e.g., based on a desired content type of the user) without requiring further user input.

In some embodiments, the audio output device causes (1106) display of respective graphical representations of the first set of one or more audio streams. For example, FIG. 6A shows user interface 503 with the representations 538, 602, 604, and 606 corresponding to different audio sources. In some embodiments, the respective graphical representations of the first set of one or more audio streams are displayed while the first audio content is being output. In some embodiments, the respective graphical representations are caused to be displayed at the audio output device. For example, the respective graphical representations may comprise one or more icons indicating corresponding audio streams. In some embodiments, the respective graphical representations are caused to be displayed at a companion device (e.g., a phone, a watch, a tablet, a laptop, a personal computer, or other type of display device) that is communicatively coupled to the audio output device. In some embodiments, the method further comprises causing display of respective graphical representations of the second set of one or more audio streams. In some embodiments, the respective graphical representations of the second set of one or more audio streams are displayed while the second audio content is being output. For example, the respective graphical representations of the first set of one or more audio streams are replaced with the respective graphical representations of the second set of one or more audio streams in response to detecting the occurrence of the event. Displaying graphical representations of audio streams provides improved feedback about the state of the device and the communicatively couple audio sources.

In some embodiments, the audio output device receives (1108) a request from a user of an audio output device to communicatively couple with a proximate audio source, and, in response to the request, communicatively couples with the proximate audio source. For example, FIGS. 8G and 8H illustrate the user 802 selecting the accept element 832 and communicatively coupling the phone device 100 with the display 804 in response to the input. In some embodiments, the request from the user is a request to connect to the proximate audio source while the audio output device is in proximity with the proximate audio source. In some embodiments, the request from the user is an implicit request (e.g., the user enables a feature to connect to proximate audio sources that are determined to be relevant to the user). In some embodiments, the request from the user is an explicit request (e.g., the user request includes an identifier for the proximate audio source). For example, the request from the user was received while the audio output device was previously in proximity with the proximate audio source. In some embodiments, the request to connect to the proximate audio source comprises a request to pair with the proximate audio source. Communicatively coupling with proximate audio sources in response to user requests may reduce the number of inputs needed to perform the communicative coupling and may allow the communicative coupling to be performed without displaying additional controls.

While outputting, via one or more audio output components, the first audio content corresponding to the first set of one or more audio streams, the audio output device detects (1110) an occurrence of an event involving a proximate audio source. For example, FIG. 5B illustrates the audio source 512 transmitting audio content 520 as an example event. In some embodiments, the event involving the proximate audio source comprises the audio output device being within a threshold distance (e.g., within 100 feet, 50 feet, 20 feet, or 10 feet) of the proximate audio source. For example, the audio output device enters a geofenced area corresponding to the proximate audio source. In some embodiments, the event involving the proximate audio source comprises the audio output device detecting a presence of the proximate audio source (e.g., due to an incoming signal via a wireless and/or wired connection). In some embodiments, the event involving the proximate audio source comprises the proximate audio source broadcasting its presence and the audio output device detecting the broadcast. For example, the proximate audio source broadcasts its presence as part of a start-up procedure or in accordance with a determination that there is audio content to transmit. In some embodiments, the event involving the proximate audio source comprises the proximate audio source initiating transmission of the audio stream. In some embodiments, the event involving the proximate audio source comprises the proximate audio source transmitting a notification of upcoming content in the audio stream. In some embodiments, the event involving the proximate audio source is a time-based event (e.g., based on a particular time of day, a particular day of the week, a calendar event time, and/or other types of time-based events).

In some embodiments, the first set of audio streams includes (1112) one or more public audio streams (e.g., the audio stream from the audio source 512 in FIG. 5C). For example, the one or more public audio streams may be broadcast to multiple devices. As an example, the one or more public audio streams may not require authentication and/or broadcaster confirmation prior to transmitting the audio data. Examples of public audio streams include public radio, public television, and public announcement streams. In some embodiments, the one or more public audio streams comprise one or more broadcast audio streams (e.g., streams available for discovery by multiple devices). In some embodiments, the one or more public audio streams include an encoded wireless stream transmitted using a wireless networking protocol (e.g., any suitable wireless networking protocol described herein). In some embodiments, the one or more public audio streams are broadcast over one or more wireless networks, such as wide area networks (WANs), metropolitan area networks (MANs), and local area networks (LANs). Enabling the audio output device to communicatively couple and receive audio streams from public audio sources improves operation of the audio output device (e.g., providing new functionality) and thereby improve the user experience with the audio output device.

In some embodiments, the first set of audio streams includes (1114) one or more private audio streams (e.g., the audio stream from the phone 100-2 in FIG. 5E). In some embodiments, private streams comprise streams that have restricted access and/or are visible to (e.g., accessible by, discoverable by, or connectable to by) only some devices. For example, a private stream may only be visible to a particular set of users. As another example, an audio source for a private stream may require authentication of users and/or devices prior to transmitting the audio data (e.g., may require a user to log-in before an audio path is established between the audio source and the user device). In some embodiments, a private audio stream is transmitted by one or more sender devices (e.g., each device having a radio transmitter component). Enabling the audio output device to communicatively couple and receive audio streams from private audio sources improves operation of the audio output device (e.g., providing new functionality) while also providing security/privacy for the private stream.

In some embodiments, the private audio stream(s) (1116) include a first private stream that is visible only to contacts of an audio source of the first private stream. In some embodiments, the private audio stream from the phone of a particular individual is only visible to contacts of that individual. For example, a private stream broadcaster may broadcast an audio stream that is discoverable only by a preset set of devices and/or users (e.g., corresponding to one or more contact lists of the broadcaster). As another example, a private stream broadcaster may broadcast an audio stream that is connectable to by a preset set of devices and/or users (e.g., corresponding to one or more contact lists of the broadcaster). In some embodiments, a private audio stream has a corresponding allow list (e.g., a set of approved devices) and/or a corresponding deny list (e.g., a set of restricted devices). Restricting visibility of private streams to known contacts of the corresponding audio source provides improved security/privacy for the private stream.

In some embodiments, the private audio stream(s) include (1118) a second private stream; and an audio path is established between a broadcast device of the second private stream and the audio output device, where establishing the audio path includes sending, from the audio output device to the broadcast device, a request to establish the audio path, and, in response to sending the request, obtaining a confirmation from a user of the broadcast device to establish the audio path. For example, FIGS. 5D-5H illustrate a process of establishing an audio path between the phone 100-3 and the phone 100-1 that includes causing display of the notification 542 and subsequent acceptance via the user input 550 (FIG. 5F). In some embodiments, the broadcast device (and/or a device communicatively coupled to the broadcast device) presents a notification regarding the request to the user of the broadcast device and receives the confirmation from the user of the broadcast device in response to presenting the notification. For example, the notification may include a selectable button or other type of affordance that, when selected, confirms the request. In this example, the notification may include a second button or other type of affordance that, when selected rejects the request (e.g., selectable deny element 546, FIG. 5F). In some embodiments, the broadcast device (and/or a device communicatively coupled to the broadcast device) receives the request and confirms the request without presenting a notification (e.g., based on an allow list, information in the received request, and/or other information). Restricting access to private streams by requiring confirmation from a user of the broadcast device (e.g., audio source) improves security/privacy for the private stream.

In some embodiments, the one or more private audio streams include (1120) a third private stream; and a second audio path between a broadcast device of the third private stream and the audio output device is established in accordance with a determination that the audio output device has been successfully authenticated. For example, in some embodiments, an audio stream from a second electronic device (e.g., phone 100-2, FIG. 5C) is transmitted to a first electronic device (e.g., phone 100-1) in response to first electronic device being authenticated (e.g., authenticated by the second electronic device. For example, the audio output device may provide a key, a password, and/or other type of authentication information to the broadcast device. In some embodiments, a login user interface is presented at the audio output device (and/or a device communicatively coupled to the audio output device), and the audio path is established in response to detecting a successful login via the login user interface. For example, in response to detecting a failed login, the audio path is not established (e.g., an audio path connection is refused). Restricting access to private streams by requiring authentication of the audio output device improves security/privacy for the private stream.

In some embodiments, the first set of one or more audio streams includes (1122) a plurality of audio streams, and the first audio content includes concurrent audio content from the plurality of audio streams. For example, FIG. 5H illustrates concurrent audio output of audio content from phones 100-2 and 100-3. In some embodiments, the first set of one or more audio streams consists of one audio stream. In some embodiments, the second set of one or more audio streams comprises a second plurality of audio streams, and the second audio content comprises concurrent audio content from the second plurality of audio streams. In some embodiments, the plurality of audio streams concurrently send audio data to the audio output device. In some embodiments, the audio output device concurrently outputs audio corresponding to two or more audio streams. In some embodiments, the second set of one or more audio streams consists of one audio stream. Concurrently providing audio content from a plurality of audio streams reduces the number of inputs needed to output the audio content and may further improve functionality (e.g., ensuring that the user doesn't miss desired audio content output concurrently from two or more sources).

In some embodiments, a respective output volume of corresponding audio content from a first audio stream of the plurality of audio streams is (1124) based on a priority assigned to the first audio stream. For example, the alert volume shown in FIG. 7I is optionally higher than the media volume in accordance with the emergency alerts audio source having a higher priority. In some embodiments, a relative output volume of the corresponding audio content from the first audio stream as compared to separate audio content from a second audio stream of the plurality of audio streams is based on a relative priority of the first audio stream as compared to the second audio stream. In some embodiments, a priority for each audio stream is assigned by a user of the audio output device. In some embodiments, a priority for each audio stream is based on a type of audio content provided by the audio stream. For example, audio content having a safety type is prioritize over audio content having a music type. In some embodiments, a priority of an audio stream varies based on the type of audio provided by the audio stream (e.g., while providing music the audio stream has a lower priority than while providing news alerts). Assigning output volume levels based on priority may reduce the number of inputs needed to assign volume levels and causes the device to assign the output volume levels automatically and without manual assignments from a user.

In some embodiments, while outputting the first audio content, the audio output device receives (1126) indication of a user adjustment of a volume level corresponding to one or more of the first set of audio streams; and, in response to receiving the indication of the user adjustment, the audio output device adjusts an output volume level of the first audio content. For example, FIGS. 6C and 6D illustrate user inputs 620 being detected and an output volume of a public radio audio source being decreased in response to the inputs. In some embodiments, adjusting the output volume level of the first audio content comprises adjusting a volume level of a component of the first audio content. In some embodiments, the component of the first audio content corresponds to a subset of the first set of one or more audio streams. For example, the first set of one or more audio streams is a set of 3 audio streams and the subset of the first set of one or more audio streams is 1 or 2 audio streams. In some embodiments, adjusting the output volume level of the first audio content comprises adjusting a relative output volume of a tenth audio stream of the first set of one or more audio streams as compared to an eleventh audio stream of the first set of one or more audio streams. In some embodiments, while outputting the second audio content, receiving indication of a second user adjustment of a second volume level corresponding to one or more of second set of one or more audio streams; and, in response to receiving the indication of the second user adjustment, the audio output device adjusts a second output volume level of the second audio content. Enabling a user to adjust (e.g., independently) output volume levels for respective audio streams improves functionality of the audio output device (e.g., providing a better user experience).

In some embodiments, detecting the occurrence of the event involving the proximate audio source includes (1128), while within a communication range of the proximate audio source, detecting a user input corresponding to a request to output audio from the proximate audio source. For example, FIGS. 7D and 7E illustrate the user input 720 being detected while the user 502 is in proximity to the audio source 712 and the audio content 723 being output as a result. In some embodiments, detecting the occurrence of the event involving the proximate audio source includes, while within a communication range of the proximate audio source, causing an interface to be presented, the interface indicating an availability of the audio stream from the proximate audio source and/or a first type of user input that corresponds to outputting audio corresponding to the audio stream; and detecting a user input having the first type of input. In some embodiments, the user input is detected at the audio output device. In some embodiments, the user input comprises activation of a button, switch, or other type of affordance. In some embodiments, the user input comprises a first type of input (e.g., a tap input, a swipe input, and/or other type of input). In some embodiments, the event comprises detecting the user input while in proximity with the proximate audio source (e.g., while in communication range with the proximate audio source and/or while within a threshold distance of the proximate audio source). In some embodiments, the proximate audio source corresponds to an exhibit and being in proximity corresponds to being in visual range of the exhibit. Outputting audio content in accordance with a user input requesting the audio improves security (e.g., forming audio paths only when explicitly requested by the user) and may therefore provide a more intuitive user experience.

In some embodiments, in accordance with a determination that the proximate audio source is at a first physical location relative to the audio output device, the audio output device outputs (1130) audio that is adjusted so as to simulate a first spatial location corresponding to the first physical location; and, in accordance with a determination that the proximate audio source is at a second physical location relative to the audio output device, the audio output device outputs audio that is adjusted so as to simulate a second spatial location corresponding to the second physical location. For example, FIG. 7E illustrates an example in which the audio content 723 is output at a location spatialized to the audio source 712. In some embodiments, audio content from each audio stream of the first set of one or more audio streams is spatialized based on a relative location of the corresponding audio source and the audio output device. In some embodiments, audio content from an audio stream of the first set of one or more audio streams is spatialized based on a relative location of a feature corresponding to the audio stream and the audio output device. For example, the feature corresponding to the audio stream may be an exhibit, a landmark, a physical feature, a physical location, or other type of feature. In some embodiments, audio content from an audio stream of the first set of one or more audio streams is spatialized based on a position and/or orientation of the audio output device as compared to a position and/or orientation of an audio source for the audio stream. In some embodiments, outputting the second audio content comprises outputting audio that is spatialized based on relative locations of one or more audio sources corresponding to the second set of one or more audio streams. Outputting spatialized audio content provides improved feedback about the state of the audio output device and the orientation between the audio output device and the audio source (e.g., providing a more intuitive user experience).

In response to detecting the occurrence of the event, the audio output device outputs (1132), via the one or more audio output components, second audio content corresponding to a second set of one or more audio streams, the second set of audio streams including an audio stream from the proximate audio source. For example, FIG. 5B illustrates the audio content 522 being provided to the user 502 in response to the audio content 520 being received from the audio source 512. In some embodiments, the second audio content is output automatically (e.g., without further user input) in response to detecting the occurrence of the event. In some embodiments, outputting the first audio content comprises outputting audio from a subset of the first set of one or more audio streams. For example, in some circumstances a subset of the first audio streams are providing audio at a given time while one or more other audio streams in the first set of one or more audio streams are not providing audio. In some embodiments, outputting the first audio content comprises maintaining an active audio connection for multiple audio streams of the first set of audio streams (e.g., for each audio stream of the first set of audio streams). In some embodiments, audio content from the first set of audio streams is filtered (e.g., noise filters are applied, audio is monitored for particular types of audio content and other audio content is filtered out, and/or other filter functions are performed) and the filtered audio content is provided to the audio output device as the first audio content. In some embodiments, the second set of audio streams comprises the first set of one or more audio streams and the audio stream from the proximate audio source. For example, the audio stream from the proximate audio source is added to the first set of one or more audio streams. In some embodiments, the second set of audio streams includes one or more audio streams not included in the first set of one or more audio streams. For example, some or all of the first set of one or more audio streams are replaced with a different set of one or more audio streams in response to the occurrence of the event.

In some embodiments, while outputting the second audio content, the audio output device detects (1134) an occurrence of a second event; and, in response to detecting the occurrence of the second event, outputs audio content from another audio stream of the first set of audio streams or the second set of audio streams. For example, FIGS. 7F and 7G illustrate the user 502 moving to a location within the threshold distance 710 of audio source 712, and the audio content 729 from the audio source 712 being output as a result. In some embodiments, the audio content from the other audio stream is output automatically (e.g., without further user input) in response to detecting the occurrence of the second event. In some embodiments, the second event is a scheduled event. In some embodiments, second event is a calendar event. In some embodiments, the second event is a notification for an upcoming scheduled event. For example, the notification may be sent 30 minutes, 15 minutes, 5 minutes, or 1 minute before a scheduled event. As an example, the second event may be a notification that the fourth audio content comprises a particular content item (e.g., in which the user has previously indicated an interest). As another example, the second event may be a notification that an upcoming portion of the first audio content comprises a particular content item (e.g., in which the user has previously indicated they do not have an interest). In some embodiments, while outputting audio content from a sixth audio stream of the second set of one or more audio streams, the audio output device detects an occurrence of a third event; and, in response to detecting the occurrence of the third event, outputs sixth audio content from another audio stream of the second set of one or more audio streams. Switching audio output in response to detecting events involving audio sources causes the audio output device to automatically adjust the output of audio content (e.g., without requiring additional manual user inputs).

In some embodiments, while outputting the second audio content, the audio output device receives (1136) indication of a user selection of a different audio stream of the first set of audio streams or the second set of audio streams, and, in response to receiving the indication of the user selection, outputs audio content from the different audio stream. For example, FIGS. 6A and 6B illustrate the user input 612 being detected at a location corresponding to the representation 604 and the corresponding audio source becoming an active audio source as a result. In some embodiments, the user selection is detected at a companion device that is communicatively coupled to the audio output device. For example, the user selection comprises an input at a location that corresponds to a displayed representation of the different audio stream. As another example, the user selection comprises an input at a location that corresponds to a displayed representation of fifth audio content. In some embodiments, the user selection is received via a user interface of the audio output device. In some embodiments, while outputting audio content from an audio stream of the second set of one or more audio streams, the audio output device receives indication of a second user selection of a different audio stream of the second set of one or more audio streams; and, in response to receiving the indication of the second user selection, outputs audio content from the different audio stream of the second set of one or more audio streams. Outputting audio content in accordance with a user input requesting the audio improves security (e.g., forming audio paths only when explicitly requested by the user) and may therefore provide a more intuitive user experience.

In some embodiments, the audio output device detects (1138) the proximate audio source, and, in response to detecting the proximate audio source, causes display of a representation of the proximate audio source in an audio user interface. For example, FIGS. 7A and 7B illustrate the user 502 moving within the threshold distance 710 and the representation 716 being displayed on the user interface 503 as a result. In some embodiments, the representation of the proximate audio source is caused to be displayed automatically (e.g., without further user input) in response to detecting the proximate audio source. In some embodiments, the proximate audio source is detected via one or more sensors of the audio output device (e.g., an inductive sensor, a visual sensor, a radiation sensor, and/or other type of sensor). In some embodiments, the proximate audio source is detected in response to receiving a signal from the proximate audio source. For example, the signal may be received via one or more receivers (e.g., radio receivers, microwave receivers, NFC receivers, and/or other types of receivers). In some embodiments, the proximate audio source transmits its presence to nearby devices. For example, the proximate audio source broadcasts a signal indicating its presence via one or more networks (e.g., wireless and/or wired networks) and/or via one or more direct connections (e.g., peer-to-peer connections). Causing display of representations of proximate audio sources in response to detecting the proximate audio sources causes the audio output device to automatically display information about available audio sources (e.g., without requiring additional manual user inputs).

In some embodiments, the representation of the proximate audio source is displayed at the audio output device. In some embodiments, the representation of the proximate audio source is displayed at a companion device (e.g., a device with a display component) that is communicatively coupled with the audio output device. In some embodiments, the audio output device (and/or a companion device that is communicatively coupled with the audio output device) presents a notification in response to detecting the proximate audio source. For example, a visual, haptic, and/or audio notification is presented to a user of the audio output device.

In some embodiments, the audio user interface includes a listing of available audio sources. In some embodiments, the audio user interface includes a listing of previously-connected audio sources. In some embodiments, the audio user interface includes a visual representation of each audio source listed in the audio user interface. In some embodiments, the representation indicates whether the proximate audio source is a public or private audio source. In some embodiments, the representation indicates a type of content in the audio stream from the proximate audio source.

In some embodiments, the proximate audio source corresponds (1140) to a person. For example, the audio source for “Ann's Stream” in FIG. 5D corresponds to the person 536. In some embodiments, the person is a contact of a user of the audio output device. In some embodiments, the proximate audio source is a user device in the possession of the person. In some embodiments, the proximate audio source is a user device of the person. In some embodiments, the person is known to the user of the audio output device (e.g., the person is a friend of the user). In some embodiments, a location of the proximate audio source is dynamic (e.g., the location changes as the person moves around). Associating audio sources with corresponding persons (e.g., via labels or other designations) provides improved feedback about the audio source and may therefore provide a more intuitive user experience.

In some embodiments, the proximate audio source corresponds (1142) to a geographic location. For example, the audio source 512 in FIG. 5A may be assigned to a particular airport, or a particular part of the airport (e.g., a particular terminal, gate, or other portion of the airport). For example, the proximate audio source may be an audio source for a geographic feature (e.g., the proximate audio source broadcasts information about the geographic feature). In some embodiments, the proximate audio source corresponds to a physical feature and/or device. For example, the proximate audio source may broadcast information about the physical feature and/or device. As a specific example, the physical feature may be a departure gate at an airport and the proximate audio source may broadcast information about flights leaving from the departure gate. In some embodiments, the proximate audio source corresponds to a physical location. In some embodiments, the proximate audio source corresponds to a geofenced location. Associating audio sources with corresponding geographic locations (e.g., via labels or other designations) provides improved feedback about the audio source and may therefore provide a more intuitive user experience.

In some embodiments, while outputting the second audio content, the audio output device detects (1144) a computer-readable code (e.g., the computer-readable code 808 in FIG. 8A) corresponding to another audio source (e.g., the audio source 806), and, in response to detecting the computer-readable code, adds the other audio source as an active audio source at the audio output device (e.g., as indicated by the representation 816 in FIG. 8B). In some embodiments, the other audio source is added automatically (e.g., without further user input) in response to detecting the computer-readable code. For example, the computer-readable code may be a QR code or an app clip code. In some embodiments, adding the other audio source as an active audio source comprises displaying an indication of the other audio source (e.g., an icon and/or other visual representation) in an audio user interface. In some embodiments, adding the other audio source as an active audio source comprises outputting audio corresponding to an audio stream from the other audio source. For example, the audio stream from the other audio source may be added to the second set of one or more audio streams. In some embodiments, the computer-readable code is detected via an image sensor of the audio output device (and/or a companion device of the audio output device). In some embodiments, detecting the occurrence of an event involving the proximate audio source comprises detecting a computer-readable code for the proximate audio source. Adding audio sources in response to detecting computer-readable codes may reduce the number of inputs needed to add audio sources and enables audio sources to be added without displaying additional controls or interfaces.

In some embodiments, while outputting the second audio content, the audio output device detects (1146) a short-range wireless signal (e.g., the signal 837, FIG. 8G) corresponding to yet another audio source (e.g., a twelfth audio source), and, in response to detecting the short-range wireless signal, adds the yet another audio source as an active audio source at the audio output device. For example, the short-range wireless signal may be a near-field communication (NFC) signal. As another example, the short-range wireless signal may be a radio frequency identification (RFID) signal. In some embodiments, detecting the occurrence of an event involving the proximate audio source comprises detecting a short-range wireless signal from the proximate audio source. In some embodiments, the yet another audio source is added automatically (e.g., without further user input) in response to detecting the short-range wireless signal. In some embodiments, the short-range wireless signal is detected in accordance a determination that the audio output device has moved within a threshold distance (e.g., a detection distance and/or a communication distance for the short-range wireless signal) of the yet another audio source (e.g., due to movement of the audio output device and/or the yet another audio source). Adding audio sources in response to detecting short-range wireless signals may reduce the number of inputs needed to add audio sources and enables audio sources to be added without displaying additional controls or interfaces.

In some embodiments, while outputting the second audio content, the audio output device causes (1148) display of a notification (e.g., the notification 830 in FIG. 8G) indicating availability of a different audio source (e.g., an audio source of the display 804), the notification including a connection option (e.g., the accept element 832), detects a user selection of the connection option (e.g., the user input 840), and, in response to detecting the user input, adds the different audio source as an active audio source at the audio output device (e.g., as indicated by the representation 816 in FIG. 8H). In some embodiments, the notification is caused to be displayed in response to receiving a signal from the different audio source (e.g., a signal indicating presence and/or availability of a thirteenth audio source). In some embodiments, the notification is caused to be displayed automatically (e.g., without further user input) in response to receiving the signal from the different audio source. In some embodiments, the notification is displayed at the audio output device. In some embodiments, the notification is displayed at a companion device of the audio output device. In some embodiments, adding the different audio source as an active audio source comprises displaying an indication of the different audio source (e.g., an icon and/or other visual representation) in an audio user interface. In some embodiments, adding the different audio source as an active audio source comprises outputting audio corresponding to an audio stream from the different audio source. Providing interactive notifications about available audio sources provides improves feedback about audio sources and may reduce the number of inputs needed to add audio sources.

In some embodiments, the user selection of the connection option includes (1150) a user input detected at a companion device (e.g., the phone device 100 in FIG. 8G) that is communicatively coupled to the audio output device (e.g., the wearable audio output device 301-1 in FIG. 8G). In some embodiments, the user input comprises activation of a button, switch, or other type of affordance. In some embodiments, the user input comprises a first type of input (e.g., a tap input, a swipe input, and/or other type of input). In some embodiments, the user input is a touch input. In some embodiments, the companion device detects the user input and send an indication of the user input to the audio output device. In some embodiments, the companion device is an electronic accessory, an electronic accessory case, a phone, a watch, a tablet, a laptop, a personal computer, or other type of user input device. Providing interactive notifications about available audio sources at companion devices enables the user to add audio sources without having to switch between devices (e.g., thereby providing a more efficient and intuitive user experience).

In some embodiments, while outputting the second audio content, the audio output device detects (1152) an occurrence of a third event involving another different audio source, and, in response to detecting the occurrence of the third event, adds the other different audio source as an active audio source at the audio output device. For example, FIGS. 7H and 71 illustrate an alert 730 being detected at the phone 100-1 and audio content 740 being output as a result. In some embodiments, the other different audio source is added automatically (e.g., without further user input) in response to detecting the occurrence of the third event. In some embodiments, the third event corresponds to audio content of the other different audio source. In some embodiments, adding the other different audio source as an active audio source comprises displaying an indication of the other different audio source (e.g., an icon and/or other visual representation) in an audio user interface. In some embodiments, adding the other different audio source as an active audio source comprises outputting audio corresponding to an audio stream from the other different audio source. Adding audio sources in response to detected events causes the audio output device to automatically add audio sources without requiring additional manual user inputs.

In some embodiments, the third event corresponds (1154) to an emergency broadcast (e.g., the audio content 740 in FIG. 7I) from the other different audio source. In some embodiments, the third event comprises receiving an indication of the emergency broadcast. In some embodiments, the third event comprises receiving an indication that the emergency broadcast is about to start. In some embodiments, the other different audio source is configured to broadcast emergency broadcasts (e.g., from a government or other authority). Adding audio sources in response to emergency broadcasts causes the audio output device to automatically add audio sources without requiring additional manual user inputs (e.g., thereby improving user safety).

In some embodiments, while outputting the second audio content, the audio output device detects (1156) an occurrence of a fourth event involving proximity to a physical location, and, in response to detecting the occurrence of the fourth event, adjusts a magnitude of ambient sound from a physical environment modified by the audio output device. For example, FIGS. 7H and 71 illustrate an alert 730 being detected at the phone 100-1 and a cancelation level of the ANC mode being decreased as a result. In some embodiments, the magnitude of the ambient sound is adjusted automatically (e.g., without further user input) in response to detecting the occurrence of the fourth event. In some embodiments, adjusting the magnitude of ambient sound from the physical environment modified by the audio output device includes switching from an active noise cancellation (ANC) mode to an active transparency mode. In some embodiments, adjusting the magnitude of ambient sound includes changing a relative amount of ambient sound blocked by the ANC mode and/or changing the amount of ambient sound passed-through by the active transparency mode. In some embodiments, changing the magnitude of ambient sound from the physical environment includes disabling the ANC mode. In some embodiments, changing the degree of ANC comprises reducing the ANC from above a threshold percentage (e.g., 90%, 80%, 75%, or 50%) to below the threshold percentage. In some embodiments, changing the degree of active transparency comprises enabling an active transparency mode. In some embodiments, changing the degree of active transparency comprises increasing the active transparency from below a threshold percentage (e.g., 15%, 20%, 30%, or 50%) to above the threshold percentage. Adjusting ambient sound magnitude in response to detection of proximate events causes the audio output device to automatically adjust ambient sound magnitude without requiring additional manual user inputs (e.g., thereby improving user safety).

In some embodiments, the audio output device changes the one or more properties of the audio output device to modify the magnitude of ambient sound from the physical environment in accordance with a determination that the wearable audio output device is operating in a first state (e.g., with ANC enabled). In some embodiments, the audio output device forgoes changing the one or more properties of the audio output device in accordance with a determination that the audio output device is operating in a second state (e.g., with ANC disabled).

In some embodiments, the audio output device conditionally outputs (1158) content corresponding to the one or more audio streams of the first set of one or more audio streams, where the conditionally outputting includes: outputting content corresponding to a portion of the audio content in accordance with a determination that the portion of audio content of the one or more streams meets one or more criteria, and, in accordance with a determination the portion of the audio content of the one or more streams does not meet the one or more criteria, forgoing outputting content corresponding to the portion of the audio content. For example, only alerts from the emergency alerts audio source (e.g., in FIGS. 7H and 71) that meet one or more relevance criteria are output to the user (e.g., in accordance with the one or more relevance criteria). In some embodiments, the one or more audio streams are processed prior to outputting audio corresponding to the one or more audio streams. In some embodiments, the processing comprises removing a portion of audio content received from an audio stream of the first set of one or more audio streams. For example, advertisements, music, background noise, speech, and/or other types of audio may be filtered out. In some embodiments, the processing comprises filtering out audio content determined to be irrelevant and/or of little interest to the user. In some embodiments, the processing comprises filtering out or adjusting particular frequencies of the audio content. In some embodiments, one or more audio streams of the second set of one or more audio streams are processing prior to outputting the second audio content. In some embodiments, the processing is performed using a digital assistant. For example, a user may request that the digital assistant monitor audio content to identify content that is relevant to the user. As another example, the user may request that the digital assistant filter out background speech, background music, and/or other background sounds. Conditionally providing audio content based on one or more criteria provides new functionality, e.g., causing the device to automatically filter, edit, and/or otherwise modify audio content without requiring the user to manually perform the filtering, editing, and/or modification.

In some embodiments, the audio output device detects a user input; and, in response to detecting the user input and in accordance with a determination that the user input corresponds to a request to process audio content from an audio source, processes the audio content from the audio source. For example, FIG. 8I illustrates the menu 852 that includes a set of selectable options for processing audio from an audio source. In some embodiments, the audio output device automatically (e.g., without further user input) edits the audio content from the audio source in response to receiving the audio content. In some embodiments, the first set of one or more audio streams are processed (e.g., monitored, edited, summarized, translated, commentated, and/or otherwise processed) prior to outputting the first audio content (e.g., automatically edited in response to prior instructions from a user). In some embodiments, in response to detecting the user input and in accordance with a determination that the user input does not correspond to the request to process the audio content from the audio source, the electronic device forgoes processing the audio content from the audio source.

It should be understood that the particular order in which the operations in FIGS. 11A-11F have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 1200) are also applicable in an analogous manner to method 1100 described above with respect to FIGS. 11A-11F. For example, the audio sources, audio streams, and audio content described above with reference to method 1100 optionally have one or more of the characteristics of the audio sources, audio streams, and audio content described herein with reference to other methods described herein (e.g., method 1200). For brevity, these details are not repeated here.

FIGS. 12A-12E are flow diagrams illustrating method 1200 of manipulating audio source representations to adjust output audio in accordance with some embodiments. Method 1200 is performed at an electronic device (e.g., the device 100, the device 300, or another type of electronic device). In some embodiments, the electronic device includes a display component and an audio output component. In some embodiments, the display is a touch-screen display with a touch-sensitive surface on or integrated with the display. In some embodiments, the display is separate from a touch-sensitive surface. In some embodiments, the electronic device that includes, or is in communication with, a display device (e.g., a display component of the electronic device or a display communicatively coupled to the electronic device) and an audio output device (e.g., a speaker component of the electronic device or an audio output device (such as a set of earbuds or headphones) communicatively coupled to the electronic device). Some operations in method 1200 are, optionally, combined and/or the order of some operations is, optionally, changed.

As described below, method 1200 provides an improved interface for initiating a process to output audio content from a broadcast audio source at an audio output device. Concurrently displaying audio sources (e.g., representations of audio sources) and regions (e.g., of a displayed user interface) corresponding to audio output devices help users visualize and distinguish between different devices, which makes the user-device interface more efficient (e.g., reduces user mistakes when operating/interacting with the devices). Making the user-device interface more efficient reduces power usage and improves battery life of the devices by enabling the user to use the devices more quickly and efficiently.

The electronic device causes (1202) concurrent display, at a display device, of a representation of a broadcast audio source (e.g., the representation 508 in FIG. 5A) and a region corresponding to an audio output device (e.g., the region 504 in FIG. 5A).

In some embodiments, the region corresponding to the audio output device includes (1204) a representation of the audio output device (e.g., the earbuds icon shown in FIG. 5B). For example, the representation of the output device may include an icon for the audio output device. In some embodiments, the representation of the output device comprises a symbol for the audio output device (e.g., a graphical representation of the audio output device). In some embodiments, the representation of the audio output device includes a description for the audio output device (e.g., a name, a label, a device type, and/or other descriptive information). For example, the representation of the audio output device may include one or more attributes to assist a user with distinguishing the audio output device from other audio output devices. Including a representation of the audio output device provides improved feedback about the state of the electronic device and the audio output device (e.g., thereby reducing user errors and improving security/privacy by reducing user operations that were intended for other audio output devices).

In some embodiments, displaying the representation of the broadcast audio source includes (1206): displaying the representation of the broadcast audio source with a first set of display characteristics (e.g., the solid background for the representation 508 in FIG. 5A) in accordance with a determination that the broadcast audio source is a public audio source, and, in accordance with a determination that the broadcast audio source is a private audio source, displaying the representation of the broadcast audio source with a second set of display characteristics (e.g., the dotted background for the representation 510 in FIG. 5A), where the first set of display characteristics are different than the second set of display characteristics. For example, a color of the representation of the broadcast audio source indicates whether the broadcast audio source is public or private. In some embodiments, a representation for a private audio source include a visual element (e.g., an icon and/or symbol) indicating that the private audio source is private. In some embodiments, the broadcast audio source has an assigned source type of a plurality of source types. In some embodiments, display characteristics of the representation of the broadcast audio source are based on the assigned source type. In some embodiments, the plurality of source types includes three or more source types. For example, the plurality of source types may include one or more of a first public source type (e.g., a public government source), a second public source type (e.g., a public non-governmental source), a first private source type (e.g., requiring authentication), a second private source type (e.g., requiring broadcaster confirmation), and an unavailable source type. In some embodiments, each source type of the plurality of source types corresponds to different set of display characteristics. Displaying different types of audio sources with different display characteristics provides improved feedback about the state of the electronic device and the audio sources (e.g., thereby reducing user errors).

The electronic device detects (1208) a first input (e.g., the user input 540 in FIG. 5E) moving the representation of the broadcast audio source (e.g., the representation 538). In some embodiments, prior to detecting the input, the representation of the broadcast audio source is displayed in a second region (e.g., of a displayed user interface) that is distinct from the region (e.g., of the displayed user interface) corresponding to the audio output device. In some embodiments, the representation of the broadcast audio source includes a visual representation of the broadcast audio source (e.g., an icon, a symbol, and/or other type of visual representation). In some embodiments, the representation of the broadcast audio source includes one or more text identifiers for the broadcast audio source. In some embodiments, the representation of the broadcast audio source indicates a source type of the broadcast audio source (e.g., a public source, a private source, a Wi-Fi source, a Bluetooth source, and/or other type of audio source).

In response to detecting the first input, in accordance with a determination that the first input corresponds to movement of the representation of the broadcast audio source into the region corresponding to the audio output device, the electronic initiates (1210) a process (e.g., causes the notification 542 to be displayed in FIG. 5F) to output audio content from the broadcast audio source at the audio output device. In some embodiments, initiating the process to output audio content includes communicatively coupling (e.g., establishing an audio path between) the broadcast audio source and the audio output device. In some embodiments, the input is a touch and/or force input. In some embodiments, the display device includes a touch-sensitive surface, and the input is detected via the touch-sensitive surface. In some embodiments, the input comprises a drag-and-drop gesture.

In some embodiments, initiating the process to output the audio content from the broadcast audio source at the audio output device includes (1212) outputting the audio content from the broadcast audio source at the audio output device. For example, in response to the representation 910 being moved into the region 902 in FIG. 9B, audio content from the corresponding audio source is output by the device 100. For example, the audio content may be output without requiring a user or device authentication. In some embodiments, initiating the process to output the audio content from the broadcast audio source at the audio output device comprises outputting the audio content from the broadcast audio source in accordance with a determination that the broadcast audio source is a public audio source.

In some embodiments, initiating the process to output the audio content from the broadcast audio source at the audio output device includes (1214) sending a request (e.g., the notification 542) to access the audio content to the broadcast audio source. In some embodiments, initiating the process to output the audio content from the broadcast audio source at the audio output device comprises sending a request to access the audio content to a device that corresponds to the broadcast audio source (e.g., a companion device for the broadcast audio source). For example, the request to access the audio content may be sent to an authentication server or device that is communicatively coupled to the broadcast audio source. In some embodiments, the request to access includes authentication information (e.g., a key, a username, a password, and/or other type of authentication information). In some embodiments, initiating the process to output the audio content from the broadcast audio source at the audio output device comprises sending the request to access the audio content to the broadcast audio source in accordance with a determination that the broadcast audio source is a private audio source. In some embodiments, the request is sent from the electronic device. Sending a request to access the audio content to the broadcast audio source improves security/privacy by broadcaster confirmation for sharing/outputting the audio content.

In some embodiments, one or more audio properties of the audio content are (1216) based on a positioning of the representation of the broadcast audio source with respect to the region corresponding to the audio output device. For example, FIGS. 8C and 8D illustrate a spatialization of audio output being based on positioning of the representation 816 in the region 811. In some embodiments, the one or more audio properties include a volume level, a spatialization, a pitch, a tone, and/or other type of audio property. For example, a volume of the audio content may be based on a distance between the representation of the broadcast audio source and a middle of the region corresponding to the audio output device. In some embodiments, a priority of the audio content is based on the positioning of the representation of the broadcast audio source. For example, a representation closer to a center of the region may be given higher priority than a representation that is further from the center of the region. In some embodiments, in accordance with a determination that a first representation for a first broadcast audio source is positioned closer to a center of the region corresponding to the audio output device than a second representation for a second broadcast audio source, the first broadcast audio source is assigned a higher priority than the second broadcast audio source. Adjusting audio properties of audio content based on the corresponding representation positioning can reduce the number of inputs needed to adjust the audio properties and enables the adjustment to be performed without displaying additional controls.

In some embodiments, a priority assigned to the broadcast audio source is (1218) based on the positioning of the representation of the broadcast audio source within the region corresponding to the audio output device. For example, the positioning of the representations 702, 704, 706, 708, and 716 in FIG. 7E correspond to a prioritization of the corresponding audio sources (e.g., the audio source for the representation 708 is assigned a highest priority and the audio source 712 is assigned the lowest priority). In some embodiments, a first audio source is assigned higher priority than a second audio source in accordance with a determination that the first audio source is closer to a center of the region (or, more generally, to a predefined portion of the region) than the second audio source. In some embodiments, audio content from an audio source with higher assigned priority is permitted to interrupt the playback of audio content from a second audio source with a lower assigned priority. In some embodiments, first audio content having a first assigned priority ceases to be output while second audio content having a second assigned priority, higher than the first assigned priority, is output. For example, lower priority audio content is paused or muted in response to a request to output higher priority audio content. In some embodiments, the region corresponding to the audio output device includes different portions corresponding to different priority levels, and audio sources are assigned to particular priority levels in accordance with their representations being positioned within the corresponding portions. Assigning priority to audio content based on the corresponding representation positioning can reduce the number of inputs needed to assign priority and enables the assignment to be performed without displaying additional controls.

In some embodiments, in response to detecting the first input, in accordance with a determination that the first input corresponds to movement of the representation of the broadcast audio source outside of the region corresponding to the audio output device, the electronic device forgoes (1220) initiating the process to output the audio content from the broadcast audio source at the audio output device. For example, FIGS. 7B and 7C illustrate the representation 716 moving in accordance with the user input 717, but no audio content from the audio source 712 being output as a result. In some embodiments, in accordance with a determination that the input corresponds to movement of the representation of the broadcast audio source from inside the region corresponding to the audio output device to outside of the region corresponding to the audio output device, the audio output device ceases to output audio content from the broadcast audio source (e.g., the electronic device ceases to output the audio content). For example, if the public audio source corresponding to representation 704 in FIG. 7A were to be moved outside region 504 by a user input, audio content from the public audio source corresponding to representation 704 would cease to be output by the audio output device (e.g., device 301, or phone 100-1). Conditionally initiating the process to output audio content based on whether an input results in the corresponding representation being within the region corresponding to the audio output device provides a more intuitive user experience (e.g., reducing erroneous outputs due to inadvertent inputs).

In some embodiments, the electronic device causes (1222) concurrent display of the representation of the broadcast audio source (e.g., the representation 910 in FIG. 9A), the region corresponding to the audio output device (e.g., the region 902), and a second region corresponding to a second audio output device (e.g., the region 904). In some embodiments, in response to detecting the input, in accordance with a determination that the input corresponds to movement of the representation of the broadcast audio source into the second region corresponding to the second audio output device, the electronic device initiates a process to output audio content from the broadcast audio source at the second audio output device. In some embodiments, at least a portion of the region corresponding to the audio output device overlaps with the second region corresponding to the second audio output device. In some embodiments, in response to detecting the input, in accordance with a determination that the input corresponds to movement of the representation of the broadcast audio source into the overlap of the region corresponding to the first audio output device and the second region corresponding to the second audio output device, the electronic device initiates a process to output the audio content from the broadcast audio source at the audio output device and the second audio output device. In some embodiments, initiating the process to output the audio content from the broadcast audio source at the audio output device comprises forgoing initiating a process to output the audio content at the second audio output device. In some embodiments, in response to detecting the input, in accordance with a determination that the input corresponds to movement of the representation of the broadcast audio source into the second the region corresponding to the second audio output device, the electronic device initiates a process to output the audio content from the broadcast audio source at the second audio output device (e.g., without outputting the audio content at the audio output device). In some embodiments, the region and the second region are visually distinguished from one another (e.g., have different visual attributes in a displayed user interface). For example, the region corresponding to the audio output device may have a first color and the second region may have a second color, different than the first color. Causing concurrent display of multiple regions corresponding to different audio output devices provides improved feedback about the state of electronic device and the audio output devices and enables audio stream operations to be performed without requiring navigation of different user interfaces (e.g., thereby reducing the number of inputs needed to perform the audio stream operations).

In some embodiments, the electronic device detects (1224) a second input, and, in response to detecting the second input and in accordance with a determination that the second input is a first type of input and is directed to the region corresponding to the audio output device, adjusts a size of the region corresponding to the audio output device. For example, FIGS. 7D and 7E illustrate the region 504 increasing in size in accordance with the user input 720. In some embodiments, the region corresponding to the audio output device includes a representation of the audio output device, and the first type of input corresponds to movement of the representation of the audio output device. For example, the region corresponding to the audio output device comprises a displayed bubble around a representation of the audio output device and moving the representation of the audio output device toward an edge of the display causes the size of the region to decrease (e.g., less of the bubble is displayed). In this example, moving the representation of the audio output device away from an edge of the display causes the size of the region to increase (e.g., more of the bubble is displayed). In some embodiments, a position of the region corresponding to the audio output device is adjustable on the display (e.g., adjusted by moving a representation of the audio output device). For example, the position of the region corresponding to the audio output device may be moved by selecting and dragging the region. For example, the first type of input may be a tap input, a swipe input, a deep press input, a long press input, or other type of input. In some embodiments, the first type of input comprises activation of a button, switch, or other type of affordance. In some embodiments, in response to detecting the second input and in accordance with a determination that the second input is not a first type of input and/or is not directed to the region corresponding to the audio output device, the electronic device forgoes adjusting the size of the region corresponding to the audio output device. Adjusting the size of the region based on particular types of inputs enables the adjustment to be performed without displaying additional controls.

In some embodiments, the size of the region corresponding to the audio output device changes (1226) in accordance with the movement of the representation of the broadcast audio source into the region corresponding to the audio output device. For example, FIGS. 5D and 5E illustrate the size of the region 504 increasing in accordance with the representation 538 being moved into the region 504. For example, the region expands as the representation of the broadcast audio source is added to the region (e.g., to have space for additional representations to be added). As another example, the region contracts in accordance with the representation of the broadcast audio source being added to the region (e.g., the region expands as the representation is selected and then contracts as, or after, the representation is added to the region). Adjusting the size of the region based on movement of representations enables the size adjustment to be performed without displaying additional controls and reduces the number of inputs needed to adjust the size and move the representations.

In some embodiments, the electronic device causes (1228) display of the representation of the broadcast audio source at a first location within the region corresponding to the audio output device, where the first location corresponds to a relative positioning between the broadcast audio source and the electronic device. For example, FIG. 5C illustrates the representations 508 and 510 being displayed at locations corresponding to the relative positioning of the phone 100-2 and the audio source 512. In some embodiments, the representation of the broadcast audio source is assigned to the first location in accordance with the determination that the input corresponds to movement of the representation of the broadcast audio source into the region corresponding to the audio output device. In some embodiments, the representation of the broadcast audio source is assigned to the first location in accordance with initiating the process to output the audio content. In some embodiments, the position of the representation of the broadcast audio source is dynamically updated based on the relative positioning between the broadcast audio source and the electronic device. In some embodiments, the relative positioning is determined based on sensor data of the electronic device (e.g., based on information from one or more location-based sensors). In some embodiments, the relative positioning is determined based on signals received from the broadcast audio source at the electronic device. Displaying the representations at locations corresponding to relative positioning of the electronic device and the audio sources provides improved feedback about the state of the electronic device and the positioning of the audio sources.

In some embodiments, the electronic device displays (1230) a system user interface (e.g., the user interface 1006 in FIG. 10B) that includes an interface element (e.g., the volume control 1008) corresponding to an audio user interface (e.g., the user interface 1014 in FIG. 10C), and while displaying the system user interface, detects a third user input, and, in response to detecting the third user input and in accordance with a determination that the third user input is directed to the interface element (e.g., user input 1010 directed to volume control 1008, FIG. 10B), causes display of the audio user interface (e.g., 1014, FIG. 10C), where causing the display of the audio user interface comprises causing the concurrent display of the representation of the broadcast audio source and the region corresponding to the audio output device. In some embodiments, the system user interface corresponds to a control center for the electronic device. In some embodiments, the system user interface includes respective interface elements for a set of system properties. For example, the set of system properties optionally includes one or more of audio properties, display properties, privacy properties, connectivity properties, and media playback properties. In some embodiments, in response to detecting the third user input and in accordance with a determination that the third user input is not directed to the interface element, forgoing causing display of the audio user interface. Providing a means for causing display of the audio user interface via a system user interface enables the audio user interface to be displayed in an intuitive manner that may reduce the number of inputs needed and/or user interfaces navigated to display the audio user interface.

In some embodiments, the electronic device detects (1232) a fourth input, and, in response to detecting the fourth input and in accordance with a determination that the fourth input corresponds to movement of the representation of the broadcast audio source, adjusts the one or more audio properties of the audio content. For example, FIGS. 8C and 8D illustrate a spatialization of audio output being adjusted in accordance with the user input 819. In some embodiments, the one or more audio properties of the audio content are adjusted (e.g., by the electronic device) relative to one or more audio properties of second audio content. In some embodiments, the one or more properties are adjusted based on a change in distance between the representation of the broadcast audio source and a center of the region corresponding to the audio output device. In some embodiments, the one or more properties are adjusted based on a change in distance between the representation of the broadcast audio source and a representation of a second audio source. In some embodiments, in response to detecting the fourth input and in accordance with a determination that the fourth input does not correspond to movement of the representation of the broadcast audio source, the electronic device forgoes adjusting the one or more audio properties of the audio content.

In some embodiments, adjusting the one or more audio properties includes (1234): outputting audio from the broadcast audio source that is adjusted so as to simulate a first spatial location corresponding to a first display location (e.g., as illustrated in FIG. 8C) in accordance with a determination that the representation of the broadcast audio source is at the first display location in the region corresponding to the audio source, and in accordance with a determination that the representation of the broadcast audio source is at a second display location in the region corresponding to the audio source, outputting audio from the broadcast audio source that is adjusted so as to simulate a second spatial location corresponding to the second display location (e.g., as illustrated in FIG. 8D). In some embodiments, adjusting the one or more audio properties comprises adjusting a specialization of the audio content output by the audio output device. For example, spatializing audio content includes indicating (e.g., via one or more simulated spatial locations at which the audio content is output) a direction and distance between the audio output device and the broadcast audio source (and/or a real-world object corresponding to the broadcast audio source). Adjusting spatialization of output audio based on the location of the corresponding representation enables the adjustment to be performed in an intuitive manner and without displaying additional controls.

Spatializing audio feedback simulates a more realistic listening experience in which audio seems to come from sources of sound in a particular frame of reference, such as the physical environment surrounding the user. For example, the audio content is provided as spatialized audio from a simulated location corresponding to the relative location of the broadcast audio source (and/or a real-world object corresponding to the broadcast audio source) from the audio output device. As an example, when spatial audio is enabled, the audio that is output from the audio output device sounds as though the respective audio for each audio source is coming from a different, simulated spatial location (which may change over time) (in a frame of reference, such as a physical environment (e.g., a surround sound effect). The positioning (simulated spatial locations) of the real-world objects may be independent of movement of audio output device relative to the frame of reference.

As an example, the simulated spatial locations of the one or more audio sources, when fixed, are fixed relative to the frame of reference, and, when moving, move relative to the frame of reference. For example, where the frame of reference is a physical environment, the one or more real-world objects have respective simulated spatial locations in the physical environment. As the audio output device moves about the physical environment, e.g., due to movement of the user, the audio output from the audio output device is automatically adjusted so that the audio continues to sound as though it is coming from the one or more audio sources at their respective spatial locations in the physical environment. As the one or more audio sources move through a sequence of spatial locations about the physical environment, the audio output from the audio output device is adjusted so that the audio continues to sound as though it is coming from the one or more audio sources at the sequence of spatial locations in the physical environment. Such adjustment for moving sound sources also takes into account any movement of the audio output device relative to the physical environment. For example, if the audio output device moves relative to the physical environment along an analogous path as a moving audio source so as to maintain a constant spatial relationship with the audio source, the audio would be output so that the sound does not appear to move relative to the audio output device.

In some embodiments, adjusting the one or more audio properties includes (1236): outputting audio from the broadcast audio source at a first volume level corresponding to a first display location (e.g., as illustrated in FIG. 8E) in accordance with a determination that the representation of the broadcast audio source is at the first display location in the region corresponding to the audio source, and, in accordance with a determination that the representation of the broadcast audio source is at a second display location in the region corresponding to the audio source, outputting audio from the broadcast audio source at a second volume level corresponding to the second display location (e.g., as illustrated in FIG. 8F). For example, the output volume is decreased as the representation of the broadcast audio source moves toward an edge of the region and the output volume is increased as the representation of the broadcast audio source moves away from the edge of the region. In some embodiments, the output volume of the audio content is adjusted relative to output volume of second audio content output by the audio output device. Adjusting output volume of audio content based on the location of the corresponding representation enables the adjustment to be performed in an intuitive manner and without displaying additional controls.

In some embodiments, the electronic device causes (1238) concurrent display of the representation of the broadcast audio source (e.g., the representation 910 in FIG. 9A), the region corresponding to the audio output device (e.g., the region 902), and a third region corresponding to a real-time communication (e.g., the region 904). In some embodiments, audio content from audio sources positioned within (e.g., having representations positioned within) the third region is output via the audio output device and via a second audio output device involved in the real-time communication. For example, audio content from audio sources positioned within the third region is shared with other users involved in the real-time communication whereas audio content from audio sources positioned within the first region is not shared with the other users (e.g., is only output at the electronic device). In some embodiments, the third region is displayed while the real-time communication is active on the electronic device. In some embodiments, at least a portion of the third region overlaps with at least a portion of the region corresponding to the audio output device. As an example, the real-time communication may include a telephone call, a video call, an online meeting, and/or other type of real-time communication. In some embodiments, the region and the third region are visually distinguished from one another (e.g., have different visual attributes). For example, the region corresponding to the audio output device may have a first color and the third region may have a second color, different than the first. Causing concurrent display of multiple regions corresponding to audio output devices and real-time communications provides improved feedback about the state of electronic device, the audio output devices, and the real-time communications and enables audio stream operations to be performed without requiring navigation of different user interfaces (e.g., thereby reducing the number of inputs needed to perform the audio stream operations).

In some embodiments, electronic device detects (1240) a fifth user input, and, in response to detecting the fifth user input and in accordance with a determination that the fifth user input is a second type of input and is directed to the representation of the broadcast audio source, causes display of an option to output processed audio content based on audio content from the broadcast audio source. For example, FIGS. 8H and 8I illustrate the menu 852 being displayed in response to the user input 850. For example, the second type of input may be a tap input, a swipe input, a deep press input, a long press input, or other type of input. In some embodiments, the second type of input comprises activation of a button, switch, or other type of affordance. In some embodiments, the option to output processed audio content comprises an option to filter the audio content prior to the audio content being output by the audio output device. In some embodiments, the electronic device detects a sixth user input, and, in response to detecting the sixth user input, in accordance with a determination that the sixth user input is directed to the option to process the audio content, the electronic device initiates a process to edit the audio content. In some embodiments, in response to detecting the fifth user input and in accordance with a determination that the fifth user input is not a second type of input and/or is not directed to the representation of the broadcast audio source, the electronic device forgoes causing display of the option to output processed audio content based on the audio content from the broadcast audio source. Displaying options to process audio content based on particular types of inputs enables the displaying to be performed without displaying additional controls.

In some embodiments, processing the audio content comprises filtering out (e.g., removing or muting) a portion of audio content received from the broadcast audio source. For example, advertisements, music, background noise, speech, and/or other types of audio may be filtered out. In some embodiments, the processing comprises filtering out audio content determined to be irrelevant and/or of little interest to the user. In some embodiments, the processing comprises filtering out or adjusting particular frequencies of the audio content. In some embodiments, the processing is performed automatically (e.g., without further user input) in accordance with receiving the audio content. For example, the processing is performed automatically based on previously-input instructions from the user.

In some embodiments, the electronic device detects a user input; and, in response to detecting the user input and in accordance with a determination that the user input corresponds to a request to process audio content from an audio source, processes the audio content from the audio source. In some embodiments, in response to detecting the user input and in accordance with a determination that the user input does not correspond to the request to process the audio content from the audio source, electronic device forgoes processing the audio content from the audio source.

In some embodiments, outputting the processed audio content includes (1242) translating speech in the audio content (e.g., corresponding to the translation element 856). In some embodiments, translating the speech comprises translating from a first language to a second language. In some embodiments, translating the speech comprises localizing one or more audio properties of the speech. For example, the user of the electronic device may request that all speech (or conversational portions of the speech) be translated to a particular language or dialect. In some embodiments, the translation is performed automatically (e.g., without further user input) in accordance with identifying a language of the speech (e.g., based on previously-input user instructions). Translating speech from audio content improves functionality of the electronic device and causes the translation to be performed automatically without requiring manual translation by the user.

In some embodiments, outputting the processed audio content includes (1244) removing background noise from the audio content (e.g., corresponding to the filter background element 864). In some embodiments, removing the background noise comprises muting the background noises. In some embodiments, removing the background noise comprises filtering out background noises (e.g., filtering out the audio signals corresponding to the background noises). For example, the user may request that background noises, particular types of noises, and/or particular frequencies be removed (e.g., muted). In some embodiments, the background noise is removed automatically (e.g., without further user input) in accordance with receiving the audio content (e.g., based on previously-input user instructions). In some embodiments, removing the background noise comprises emphasizing speech in the audio content. In some embodiments, editing the audio content comprises emphasizing speech in the audio content (e.g., reducing a volume of non-speech sounds and/or filtering out non-speech sounds). Removing background noise from audio content improves functionality of the electronic device, e.g., providing improved audio content that is easier to listen to and understand.

In some embodiments, outputting the processed audio content includes (1246) removing speech from the audio content (e.g., corresponding to the filter speech element 860 of menu 852, FIG. 8I). In some embodiments, removing the speech comprises muting the speech. In some embodiments, removing the speech comprises filtering out speech (e.g., filtering out the audio signals corresponding to the speech). In some embodiments, removing the speech from the audio content comprises removing a particular type of speech, particular pitches and/or frequencies of speech, and/or speech from particular speakers. Removing speech from audio content improves functionality of the electronic device, e.g., by removing unwanted speech.

In some embodiments, processing the audio content includes (1248) monitoring an audio stream from the broadcast audio source (e.g., corresponding to the content-based monitoring element 854 of menu 852, FIG. 8I), the electronic forgoes outputting a portion of the audio stream in accordance with a determination that the portion of the audio stream does not meet one or more criteria, and, in accordance with a determination that the portion of the audio stream meets the one or more criteria, the electronic device outputs the portion of the audio stream. In some embodiments, the monitoring and/or processing is performed using a digital assistant. For example, a user may request that the digital assistant monitor audio content to identify content that is relevant to the user. In some embodiments, in response to detecting the occurrence of the first type of event, the electronic device outputs a portion of audio content of the audio stream that corresponds to the first type of event. In some embodiments, in response to detecting the occurrence of the first type of event, the electronic device outputs audio content of the audio stream for a preset amount of time (e.g., 10 minutes, 5 minutes, 2 minutes, or 30 seconds). In some embodiments, the first type of event comprises the audio stream outputting a particular type of audio. In some embodiments, the first type of event comprises a determination that a portion of audio content is relevant and/or of interest to the user of the electronic device. In some embodiments, outputting the audio content comprises outputting information about incoming audio content received via the audio stream (e.g., a summary of the incoming audio content, a description of the incoming audio content, details from the incoming audio content, and/or other information about the incoming audio content). As another example, the user may request that the digital assistant filter out background speech, background music, and/or other background sounds. In some embodiments, outputting the audio content of the audio stream comprises outputting a notification about incoming audio content. In some embodiments, the audio content corresponding to the audio stream is output automatically (e.g., without further user input) in response to detecting the occurrence of the first type of event. Conditionally providing audio content based on one or more criteria provides new functionality, e.g., causing the device to automatically filter, edit, and/or otherwise modify audio content without requiring the user to manually perform the filtering, editing, and/or modification.

In some embodiments, the one or more criteria include (1250) particular information indicated by a user of the electronic device. For example, a user of the electronic device may request that they receive an alert when incoming audio content includes a particular announcement (e.g., an update about a flight of the user) or particular details (e.g., weather information for the user's location). In some embodiments, selecting the content-based monitoring element 854 in FIG. 8I causes display of an interface in which the user may enter particular information (e.g., key terms, phrases, or other information) for the content-based filtering. Conditionally providing audio content based on information from the user provides new functionality and a more intuitive user experience (e.g., by not providing unwanted audio content).

In some embodiments, the outputted portion of the audio stream has (1252) one or more properties based on a type of the audio content. In some embodiments, different types of audio content have different associated urgency levels. As an example, the one or more properties may be based on an urgency level of the audio content. In some embodiments, the types of audio content include one or more of announcements, discussions, music, news, and weather. In some embodiments, the one or more properties include a volume level, a tone, a cadence, and a priority level. In some embodiments, the one or more properties of the outputted audio content are assigned automatically (e.g., without further user input) in accordance with determining the type of the audio content (e.g., based on previously-input user instructions). Providing audio content with properties based on the type of audio content provides improved feedback about the state of the electronic device and the audio content.

In some embodiments, outputting the processed audio content includes (1254) removing music from the audio content (e.g., corresponding to the filter music element 862). In some embodiments, removing the music comprises muting the music. In some embodiments, removing the music comprises filtering out music (e.g., filtering out the audio signals corresponding to the music). In some embodiments, removing the music from the audio content comprises removing a particular type of music, particular pitches and/or frequencies of music, and/or particular sources of music. In some embodiments, editing the audio content comprises modifying music in the audio content (e.g., reducing a volume of the music). Removing music from audio content improves functionality of the electronic device, e.g., by removing unwanted music.

In some embodiments, outputting the processed audio content includes (1256) removing one or more advertisements from the audio content (e.g., corresponding to the content-based monitoring element 854). In some embodiments, removing the one or more advertisements comprises muting the one or more advertisements. In some embodiments, removing the one or more advertisements comprises filtering out advertisements (e.g., filtering out the audio signals corresponding to the advertisements). In some embodiments, editing the audio content comprises modifying advertisements in the audio content (e.g., reducing a volume of the advertisements). Removing advertisements from audio content improves functionality of the electronic device, e.g., by removing unwanted ad content.

In some embodiments, outputting the processed audio content includes (1258) changing a pitch of the audio content (e.g., corresponding to the accessibility element 858). For example, a user may request that the audio content be pitch shifted to a range that is easier for the user to hear. In some embodiments, changing the pitch of the audio content comprises changing a particular range of pitches in the audio content (e.g., a particular range identified by the user). Enabling users to change the pitch of audio content provides new functionality and improves accessibility of the audio content (e.g., allowing users to better hear the content).

In some embodiments, the electronic device detects (1260) a sixth user input, and, in response to detecting the sixth user input and in accordance with a determination that the sixth user input is a third type of input and is directed to the representation of the broadcast audio source, initiates a process to share audio content from the broadcast audio source with another device. For example, the third type of input may be a tap input, a swipe input, a deep press input, a long press input, or other type of input. In some embodiments, the third type of input comprises activation of a button, switch, or other type of affordance. In some embodiments, the option to share the audio content comprises an option to share the audio content with a contact of the user of the electronic device. In some embodiments, in response to detecting the sixth user input and in accordance with a determination that the sixth user input is not a third type of input and/or is not directed to the representation of the broadcast audio source, the electronic device forgoes initiating the process to share the audio content from the broadcast audio source with the another device. In some embodiments, initiating the process to share the audio content includes displaying a selectable option to share the audio content that, when selected, causes the audio content to be shared. In some embodiments, the option to share audio content comprises an option to share the audio content via a real-time communication (e.g., via a phone call, a video call, or an online meeting). For example, dragging the representation 906 shown in FIG. 9E into the region 904 causes a process to be initiated to share audio content from the corresponding audio source with participants of the video conference. In some embodiments, initiating the process to share the audio content includes starting to share the audio content. Initiating content sharing based on particular types of inputs enables the content sharing to be performed without displaying additional controls and/or user interfaces.

In some embodiments, the electronic device detects (1262) a seventh user input, and, in response to detecting the seventh user input and in accordance with a determination that the seventh user input is a fourth type of input and is directed to the representation of the broadcast audio source, initiates a process to block the broadcast audio source (e.g., corresponding to the block element 876). For example, the fourth type of input may be a tap input, a swipe input, a deep press input, a long press input, or other type of input. In some embodiments, the fourth type of input comprises activation of a button, switch, or other type of affordance. In some embodiments, the process to block the broadcast audio source comprises displaying an option to block notifications from the broadcast audio source. In some embodiments, process to block the broadcast audio source comprises displaying an option to block communications from the broadcast audio source. In some embodiments, the electronic device detects an eighth user input, and, in response to detecting the eighth user input, in accordance with a determination that the eighth user input is directed to an option to block the broadcast audio source, the electronic device initiates a process to block the broadcast audio source. In some embodiments, blocking the broadcast audio source comprises blocking communications, notifications, and/or audio content from the broadcast audio source. In some embodiments, in response to detecting the seventh user input and in accordance with a determination that the seventh user input is not the fourth type of input and/or is not directed to the representation of the broadcast audio source, the electronic device forgoes initiating a process to block the broadcast audio source. Initiating audio source blocking based on particular types of inputs enables the blocking processes to be performed without displaying additional controls and/or user interfaces.

In the description of FIGS. 11A-11F and 12A-12E above, the numbered representations, audio sources, audio streams, and audio content are optionally the same as, or different than, the other numbered representations, audio sources, audio streams, and audio content. The numbering is provided to improve clarity of the explanation.

It should be understood that the particular order in which the operations in FIGS. 12A-12E have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 1100) are also applicable in an analogous manner to method 1200 described above with respect to FIGS. 12A-12E. For example, the audio sources, audio streams, and audio content described above with reference to method 1200 optionally have one or more of the characteristics of the audio sources, audio streams, and audio content described herein with reference to other methods described herein (e.g., method 1100). For brevity, these details are not repeated here.

The operations described above with reference to FIGS. 11A-11F and 12A-12E are, optionally, implemented by components depicted in FIGS. 1A-1B and/or FIGS. 3A-3K. For example, detection operation 1148 and detection operation 1208 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B and FIGS. 3A-3K.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method, comprising:
at an audio output device that includes one or more audio output components:
while outputting, via the one or more audio output components, first audio content corresponding to a first set of one or more audio streams, detecting an occurrence of an event involving a proximate audio source; and
in response to detecting the occurrence of the event, outputting, via the one or more audio output components, second audio content corresponding to a second set of one or more audio streams, the second set of one or more audio streams including an audio stream from the proximate audio source.

2. The method of claim 1, wherein the first set of one or more audio streams comprises one or more public audio streams.

3. The method of claim 1, the first set of one or more audio streams comprises one or more private audio streams.

4. The method of claim 3, wherein the one or more private audio streams comprise a first private stream that is visible only to contacts of an audio source of the first private stream.

5. The method of claim 3, wherein the one or more private audio streams comprise a second private stream, and the method further comprises establishing an audio path between a broadcast device of the second private stream and the audio output device, wherein establishing the audio path comprises:
sending, from the audio output device to the broadcast device, a request to establish the audio path; and
in response to sending the request, obtaining a confirmation from a user of the broadcast device to establish the audio path.

6. The method of claim 3, wherein the one or more private audio streams comprise a third private stream, and wherein a second audio path between a broadcast device of the third private stream and the audio output device is established in accordance with a determination that the audio output device has been successfully authenticated.

7. The method of claim 1, wherein the first set of one or more audio streams comprises a plurality of audio streams, and wherein the first audio content comprises concurrent audio content from the plurality of audio streams.

8. The method of claim 7, wherein a respective output volume of corresponding audio content from a first audio stream of the plurality of audio streams is based on a priority assigned to the first audio stream.

9. The method of claim 1, further comprising, while outputting audio content from a second audio stream of the first set of one or more audio streams:
in accordance with a determination that third audio content from a third audio stream of the first set of one or more audio streams meets one or more criteria, outputting the third audio content; and
in accordance with a determination that the third audio content from the third audio stream of the first set of one or more audio streams does not meet the one or more criteria, forgoing outputting the third audio content.

10. The method of claim 9, wherein the one or more criteria include a content type criterion.

11. The method of claim 1, further comprising:
while outputting audio content from a sixth audio stream of the first set of one or more audio streams, detecting an occurrence of a second event; and
in response to detecting the occurrence of the second event, outputting sixth audio content from another audio stream of the first set of one or more audio streams.

12. The method of claim 1, further comprising causing display of respective graphical representations of the first set of one or more audio streams.

13. The method of claim 1, further comprising:
while outputting audio content from an eighth audio stream of the first set of one or more audio streams, receiving indication of a user selection of a different audio stream of the first set of one or more audio streams; and
in response to receiving the indication of the user selection, outputting eighth audio content from the different audio stream of the first set of one or more audio streams.

14. The method of claim 1, further comprising:
while outputting the first audio content, receiving indication of a user adjustment of a volume level corresponding to one or more of the first set of one or more audio streams; and
in response to receiving the indication of the user adjustment, adjusting an output volume level of the first audio content.

15. The method of claim 1, further comprising:
detecting the proximate audio source; and
in response to detecting the proximate audio source, causing display of a representation of the proximate audio source in an audio user interface.

16. The method of claim 1, wherein the proximate audio source corresponds to a person.

17. The method of claim 1, wherein the proximate audio source corresponds to a geographic location.

18. The method of claim 17, further comprising, prior to detecting the occurrence of the event involving the proximate audio source:
receiving a request from a user of the audio output device to communicatively couple with the proximate audio source; and
in response to the request from the user, communicatively coupling the audio output device with the proximate audio source.

19. The method of claim 1, further comprising, while outputting the first audio content or the second audio content:
detecting a computer-readable code corresponding to an eleventh audio source; and
in response to detecting the computer-readable code, adding the eleventh audio source as an active audio source at the audio output device.

20. The method of claim 1, further comprising, while outputting the first audio content or the second audio content:
detecting a short-range wireless signal corresponding to a twelfth audio source; and
in response to detecting the short-range wireless signal, adding the twelfth audio source as an active audio source at the audio output device.

21. The method of claim 1, wherein detecting the occurrence of the event involving the proximate audio source comprises:
while within a communication range of the proximate audio source, detecting a user input corresponding to a request to output audio from the proximate audio source.

22. The method of claim 1, further comprising, while outputting the first audio content or the second audio content:
causing display of a notification indicating availability of a thirteenth audio source, wherein the notification includes a connection option;
detecting a user selection of the connection option; and
in response to detecting the user selection, adding the thirteenth audio source as an active audio source at the audio output device.

23. The method of claim 22, wherein the user selection comprises a user input detected at a companion device that is communicatively coupled to the audio output device.

24. The method of claim 1, further comprising, while outputting the first audio content or the second audio content:
detecting an occurrence of a third event involving a fourteenth audio source; and
in response to detecting the occurrence of the third event, adding the fourteenth audio source as an active audio source at the audio output device.

25. The method of claim 24, wherein the third event corresponds to an emergency broadcast from the fourteenth audio source.

26. The method of claim 1, wherein outputting the first audio content comprises:
in accordance with a determination that the proximate audio source is at a first physical location relative to the audio output device, outputting audio that is adjusted so as to simulate a first spatial location corresponding to the first physical location; and
in accordance with a determination that the proximate audio source is at a second physical location relative to the audio output device, outputting audio that is adjusted so as to simulate a second spatial location corresponding to the second physical location.

27. The method of claim 1, further comprising:
while outputting the first audio content or the second audio content, detecting an occurrence of a fourth event involving proximity to a physical location; and
in response to detecting the occurrence of the fourth event, adjusting a magnitude of ambient sound from a physical environment modified by the audio output device.

28. The method of claim 1, further comprising conditionally outputting content corresponding to the one or more audio streams of the first set of one or more audio streams, wherein the conditionally outputting comprises:
in accordance with a determination that a portion of audio content of the one or more audio streams meets one or more criteria, outputting content corresponding to the portion of the audio content; and
in accordance with a determination the portion of the audio content of the one or more audio streams does not meet the one or more criteria, forgoing outputting content corresponding to the portion of the audio content.

29. An audio output device, comprising:
one or more audio output components;
one or more processors; and
memory storing one or more programs, wherein the one or more programs are configured to be executed by the one or more processors, the one or more programs including instructions for:
while outputting, via the one or more audio output components, first audio content corresponding to a first set of one or more audio streams, detecting an occurrence of an event involving a proximate audio source; and
in response to detecting the occurrence of the event, outputting, via the one or more audio output components, second audio content corresponding to a second set of one or more audio streams, the second set of one or more audio streams including an audio stream from the proximate audio source.

30. A computer-readable storage medium storing one or more programs, the one or more programs comprising instructions that, when executed by an audio output device that includes one or more audio output components, cause the audio output device to:
while outputting, via the one or more audio output components, first audio content corresponding to a first set of one or more audio streams, detect an occurrence of an event involving a proximate audio source; and
in response to detecting the occurrence of the event, output, via the one or more audio output components, second audio content corresponding to a second set of one or more audio streams, the second set of one or more audio streams including an audio stream from the proximate audio source.
